(19) United States
(12) Patent Application Publication
(10) Pub. No.: US 2015/0355516 A1
(43) Pub. Date: Dec. 10, 2015

(54) DISPLAY COMPONENT AND DISPLAY DEVICE

(71) Applicant: SHARP KABUSHIKI KAISHA, Osaka-shi, Osaka (JP)

(72) Inventors: Akihiro IMAI, Osaka-shi (JP); Makoto KANBE, Osaka-shi (JP); Motoaki FUKAYAMA, Osaka-shi (JP); Ryoh UEDA, Osaka-shi (JP); Taichi OBATA, Osaka-shi (JP); Shigeki TANAKA, Osaka-shi (JP)

(21) Appl. No.: 14/655,810

(22) PCT Filed: Dec. 20, 2013
(86) PCT No.: PCT/JP2013/084221

§ 371 Date: Jun. 26, 2015

(30) Foreign Application Priority Data
Dec. 27, 2012 (JP) 2012-285308
Feb. 8, 2013 (JP) 2013-023519

(51) Int. Cl. G02F 1/1362; G02F 1/1333; G02F 1/1343; G02F 1/1337

(52) U.S. Cl. CPC G02F 1/136227; G02F 1/1337; G02F 1/133345; G02F 1/13439

(57) ABSTRACT

An array board 11b includes a first conductive film, a second conductive film, an insulator, and an alignment film. The second conductive film is disposed above the first conductive film and includes at least a portion that overlaps the first conductive film in a plan view. The insulator is held between the first and the second conductive films. The insulator includes a contact hole at a position overlapping the first and the second conductive films in a plan view for connecting the second conductive film to the first conductive film. The alignment film 11e is disposed above the second conductive film and includes a portion overlapping the contact hole and a portion not overlapping the contact hole in a plan view. The bending portion 43 is defined by at least a portion of an edge of the contact hole in the insulator. The bending portion bends toward an inner side of the contact hole such that an outer angle of the bending portion in a plan view is a reflex angle.

### TECHNICAL FIELD

The present invention relates to a display component and a display device.

### BACKGROUND ART

A liquid crystal panel used for a liquid crystal display device includes liquid crystals held between a pair of boards. One of the boards is an array board including TFTs that are active components for controlling the operation of pixels. The array board has a number of gate lines and source lines formed in a matrix within a display area thereof, and has the TFT disposed at each intersection of the gate line and the source line. A pixel electrode is disposed in a region surrounded by the gate lines and the source lines. The region including the pixel electrode corresponds to a unit display region, that is, a pixel. A drain electrode included in the TFT is connected to a drain line. A contact hole is formed at a position overlapping both the drain line and the pixel electrode. The contact hole runs through an insulator that insulates the drain line from the pixel electrode. The drain line is connected to the pixel electrode via the contact hole. Alignment films for controlling the alignment of liquid crystal molecules are formed on inner surfaces of the boards that are in contact with the liquid crystals.

To form the alignment film on the array board, an inkjet device may be used. An example of the device is disclosed in Patent Document 1. According to Patent Document 1, the contact holes of the pixels are in irregular arrangement within the surface of the array board. This is to reduce moire resulting from a depressed portion that may be formed in the alignment film when droplets of the solution discharged from an inkjet head for forming the alignment film enter the contact hole.

### RELATED ART DOCUMENT

### Patent Document

Patent Document 1: Japanese Unexamined Patent Application Publication No. 2010-66397

### PROBLEM TO BE SOLVED BY THE INVENTION

According to Patent Document 1, when the droplets of the solution for forming the alignment film enter the contact hole, the depressed portion may be formed in a portion of the alignment film corresponding to the contact hole and the moire may occur due to the depressed portion. However, the droplets of the solution for forming the alignment film actually do not enter the contact hole. This results in defects in the film. The moire occurs due to the defects in the film. Thus, it is difficult to reduce the moire without reducing the defects in the alignment film. In addition, even though the contact holes of the pixels are arranged irregularly as disclosed in Patent Document 1, each contact hole cannot be arranged beyond an area of the pixel that includes the contact hole. Namely, a distance between the adjacent contact holes cannot be larger than a certain distance. Accordingly, moire reducing effect is limited.

### DISCLOSURE OF THE PRESENT INVENTION

The present invention was made in view of the foregoing circumstances. An object of the present invention is to reduce or suppress moire.

### Means for Solving the Problem

A first display component according to the present invention includes a first conductive film, a second conductive film, and an alignment film. The second conductive film is disposed above the first conductive film and at least a portion of the second conductive film overlapping the first conducive film in a plan view. The insulator is held between the first conductive film and the second conductive film. The insulator includes a contact hole for connecting the second conductive film to the first conductive film. The contact hole is at a position overlapping the first conductive film and the second conductive film in a plan view. The alignment film is disposed above the second conductive film. The alignment film includes a portion overlapping the contact hole in a plan view and a portion not overlapping the contact hole in a plan view. The contact hole includes an edge, at least a portion of which defines a bending portion of the insulator which bends toward an inner side of the contact hole such that an outer angle of the bending portion is a reflex angle in a plan view.

Thus, the second conductive film formed after the formation of the first conductive film and the insulator is connected to the first conductive film on the lower side via the contact hole of the insulator. When the solution for forming the alignment film is supplied locally to the surface of the second conductive film or the like in the formation of the alignment film above the first conductive film, the solution spreads to the outside and inside of the contact hole, thereby forming the alignment film having a portion overlapping the contact hole in a plan view and a portion not overlapping the contact hole in a plan view. Here, in the case where the solution for forming the alignment film supplied to the outside of the contact hole spreads into the contact hole, when the solution reaches the bending portion that bends toward the inner side of the contact hole such that the outer angle of the bending portion is a reflex angle in a plan view, the solution is drawn into the contact hole because of the bending portion. It is considered that the solution is drawn because the reach of the solution to the bending portion with the reflex angle in a plan view produces the force to spread the solution in a wide angle. It is easier to arrange the alignment film in the contact hole and defects are less likely to be developed in the alignment film. Accordingly, the moire is properly reduced or suppressed.

Preferable embodiments may include the following configurations.

(1) In the insulator, the contact hole may include a contact hole main portion overlapping at least a portion of the first conductive film and the second conductive film in a plan view, and an expanded hole portion formed by expanding a portion of the contact hole main portion. The bending portion may be defined by edges of the contact hole main portion and the expanded hole portion that are communicated with each other, and the expanded hole portion may have a smaller opening width than the main body of the contact hole main portion. The opening widths of the expanded hole portion and the contact hole main portion are each defined by the distance between a pair of edges opposite to each other. Here, in the case where the solution for forming the alignment film reaches both the pair of edges opposite to each other at the expanded hole portion included in the contact hole in the formation of the alignment film, the solution reaching the edges is easily connected as compared to the contact hole main portion side. When the solution is connected, the solution flows to have a smaller surface area due to the surface tension, thereby making it easier for the solution to flow into the contact hole. In addition, the edge of the expanded hole portion communicated with the edge of the contact hole main portion forms the bending portion. Therefore, in combination with the easy flow of the solution for forming the alignment film into the contact hole due to the bending portion, the solution for forming the alignment film can flow into the contact hole more easily. This allows the alignment film to be formed more easily in the portion overlapping the contact hole in a plan view and the defects are less likely to be developed in the alignment film.

(2) The second conductive film may form the pixel electrode formed of a transparent electrode material, and in the insulator, the expanded hole portion may be formed by extending a portion of the contact hole main portion that is relatively far from the center of the pixel electrode in a plan view. The portion of the alignment film that overlaps the contact hole has a depressed shape relative to the non-overlapped portion. Therefore, the aligning function cannot be exhibited sufficiently in some cases and this tends to be remarkably observed in the expanded hole portion formed by extending the contact hole main portion. In this regard, the expanded hole portion is formed by extending a portion of the contact hole main portion that is relatively far from the center of the pixel electrode in a plan view. Therefore, the defective alignment that may be caused by the expanded hole portion affects the display of the pixel electrode less easily. For this reason, the deterioration in display quality due to the expanded hole portion is suppressed.

(3) In the insulator, the expanded hole portion may be formed by extending a corner of the contact hole main portion. This allows the expanded hole portion to be disposed as far from the pixel electrode as possible in the contact hole. Thus, the defective alignment caused by the expanded hole portion affects the display of the pixel electrode less easily.

(4) The second conductive film may form the pixel electrode formed of a transparent electrode material, and in the insulator, the expanded hole portion may be disposed not overlapping the pixel electrode in a plan view. The portion of the alignment film that overlaps the contact hole in a plan view has a depressed shape relative to the non-overlapped portion. Thus, the aligning function cannot be exhibited sufficiently in some cases, and in particular, this tends to be remarkably observed in the expanded hole portion formed by extending the contact hole main portion. In this regard, the expanded hole portion is disposed not overlapping the pixel electrode in a plan view. Therefore, the defective alignment that may be caused by the expanded hole portion affects the pixel electrode less easily. Thus, the deterioration in display quality due to the expanded hole portion is suppressed. When the pixel electrode is formed of a transparent electrode material, the fluidity of the solution for forming the alignment film on the pixel electrode may be low. However, when the expanded hole portion with the bending portion for enabling the easy flow of the solution for forming the contact hole into the contact hole is formed not overlapping the pixel electrode in a plan view, the fluidity of the solution toward the expanded hole portion is maintained high. This makes the solution for forming the alignment film flow to the contact hole more easily.

(5) In the insulator, the expanded hole portion may be disposed not overlapping the first conductive film in a plan view. Thus, as compared to the contact hole main portion, the opening depth, i.e., the gap from the surface of the second conductive film and the like to which the solution for forming the alignment film is supplied is large in the expanded hole portion because the expanded hole portion does not overlap the first conductive film in a plan view. Therefore, the solution for forming the alignment film flows into the expanded hole portion more easily.

(6) The display component may further include a third conductive film disposed below the first conductive film, at least a portion of the third conductive film overlapping the first conductive film in a plan view. In the insulator, at least a portion of the contact hole main portion may be disposed overlapping the third conductive film in a plan view and the expanded hole portion may be disposed not overlapping the third conductive film in a plan view. Thus, as compared to the contact hole main portion, the opening depth, i.e., the gap from the surface of the second conductive film to which the solution for forming the alignment film is supplied is large in the expanded hole portion because the expanded hole portion does not overlap the third conductive film in a plan view. Therefore, the solution for forming the alignment film flows into the expanded hole portion more easily.

(7) In contrast to the first conductive film that may form at least the source electrode and the drain electrode, the third conductive film may form a gate electrode that overlaps at least the source electrode and the drain electrode in a plan view and an auxiliary capacitor line disposed apart from the gate electrode in a plan view. In the insulator, at least a portion of the contact hole main portion may overlap the drain electrode and the gate electrode in a plan view and the expanded hole portion may be held between the gate electrode and the auxiliary capacitor line in a plan view. Since the expanded hole portion is held between the gate electrode and the auxiliary capacitor line in a plan view, the valley is formed on the surface of the second conductive film and the like to which the solution for forming the alignment film is supplied. Therefore, the solution for forming the alignment flows more easily from the portion overlapping the gate electrode and the auxiliary capacitor line in a plan view to the expanded hole portion on the surface of the second conductive film and the like.

(8) In the insulator, the expanded hole portion may have an opening width of Wmax/2 or less, where Wmax is the maximum value of the opening width of the contact hole main portion. Thus, as compared to the case in which the opening width of the expanded hole portion is set to Wmax/2 or larger the solution for forming the alignment film having reached both the pair of edges opposite to each other in the expanded hole portion can be connected more easily. This enables the solution for forming the alignment film to flow into the contact hole more easily.

(9) In the insulator, the edge that forms the expanded hole portion and that forms the bending portion may have a length of Wmax/2 or less. As compared to the case in which the edge that forms the expanded hole portion and that forms the bending portion has a length of Wmax/2 or larger the solution for forming the alignment film having reached the edges in the bending portion can be connected more easily. This enables the solution for forming the alignment film to flow into the contact hole more easily.

(10) In the insulator, each of the opening width of the expanded hole portion and the length of the edge that forms the expanded hole portion and that forms the bending portion may be 1 μm or more. As the opening width of the expanded hole portion and the length of the edge that forms the expanded hole portion and that forms the bending portion are smaller, the solution for forming the alignment film can flow into the contact hole more easily but on the contrary, it becomes more difficult to form the contact hole main portion and the expanded hole portion in the insulator. In this regard, by setting each of the opening width of the expanded hole portion and the length of the edge that forms the expanded hole portion and that forms the bending portion to 1 μm or more, the solution for forming the alignment film can easily flow into the contact hole and additionally, the contact hole main portion and the expanded hole portion can be formed in the insulator more certainly.

(11) In the insulator, the expanded hole portion may be tapered in a direction away from the contact hole main portion in a plan view. Thus, the pair of edges opposite to each other in the expanded hole portion approaches each other as away from the contact hole main portion. Therefore, when the alignment film is formed, the solution for forming the alignment film having reached both the pair of edges is connected more easily. This enables the solution for forming the alignment film to flow into the contact hole more easily.

(12) In the insulator, the contact hole main portion may have a circular or elliptical planar shape. As thus described, since the contact hole main portion whose planar shape is circular or elliptical does not have sides that intersect with each other on its edge, when the solution for forming the alignment film reaches the edge of the contact hole main portion, the solution is not connected easily and the solution flows into the contact hole less easily. In this regard, when the expanded hole portion is formed by extending a portion of the contact hole main portion, the solution for forming the alignment film can flow into the contact hole sufficiently easily.

(13) The insulator may include at least an organic insulator formed of an organic resin material. At least the bending portion of the edge of the contact hole may have the sectional shape gradually rising, and include a first inclined portion that is disposed on the relatively lower side and has a larger inclination angle, and a second inclined portion that is disposed on the relatively upper side and has a smaller inclination angle. If the bending portion is entirely formed of the first inclined portion, the inclination is sharp so that it is difficult for the solution for forming the alignment film to move toward the first inclined portion. In contrast, when the second inclined portion that is less sharp is disposed above the first inclined portion, the solution for forming the alignment film is moved smoothly. Therefore, when the solution for forming the alignment film has reached the bending portion of the edge of the contact hole in the formation of the alignment film, the solution is induced to flow into the contact hole by the second inclined portion that is disposed on the relatively upper side and has a smaller inclination angle. As a result, the solution enters the contact hole smoothly through the first inclined portion. The above case is suitable when the contact hole is small, as compared to the case where the bending portion is entirely formed of the second inclined portion and the edge of the contact hole tends to have a larger width.

(14) The display component may further include: a third conductive film provided below the first conductive film, at least a portion of the third conductive film overlapping the first conductive film in a plan view; and a semiconductor film interposed between the third conductive film and the first conductive film. The first conductive film may form at least the source electrode and the drain electrode. The third conductive film may form the gate electrode that overlaps at least the source electrode and the drain electrode in a plan view. The semiconductor film may include an oxide semiconductor and form a channel that is connected to the source electrode and the drain electrode. Thus, upon the application of voltage to the gate electrode, current flows between the source electrode and the drain electrode through the channel formed of the oxide semiconductor film. Since this oxide semiconductor film has higher electron mobility than an amorphous silicon thin film or the like, sufficient current can be supplied between the source electrode and the drain electrode even though the channel has a smaller width. If the channel has a smaller width, the source electrode, the drain electrode, and the gate electrode have smaller size, which is preferable in achieving the higher definition of the display component. When the display component has the higher definition, the number of contact holes tends to increase. According to the configuration, defects are more likely to be developed in the alignment film. In this regard, when the bending portion that is curved to form a reflex angle on the inside in a plan view at the edge of the contact hole of the insulator is included, the solution for forming the alignment film easily enters the contact hole, which is preferable because defects are less likely to be developed in the alignment film.

(15) The adjacent edges included in the contact hole in the insulator may be provided with at least two inclined portions whose sectional shapes are inclined and whose inclination angles are different from each other. In this case, if the solution for forming the alignment film supplied on the outside of the contact hole spreads into the contact hole, the solution having reached the edge of the contact hole is induced to flow into the contact hole due to the inclined portion, out of the two inclined portions whose sectional shapes are inclined and whose inclination angles are different from each other at the edge, that has the relatively smaller inclination angle and the gradient inclination. In addition, at the boundary between the inclined portions with the different inclination angles in the edge of the contact hole, the fluidity of the solution for forming the alignment film is increased because the inclination angles thereof are different from each other, whereby the solution flows into the contact hole more easily. Furthermore, at least a portion of the edge of the contact hole forms the bending portion that is curved to form the reflex angle on the inside in a plan view. Since the bending portion can assure that the solution for forming the alignment film can easily flow into the contact hole, the solution for forming the alignment film can flow into the contact hole more easily. This enables the solution for forming the alignment film to flow into the contact hole sufficiently easily even though the difference in inclination angle between the at least two inclination angles is not increased that much. Therefore, it is possible to prevent the gradient of the inclined portion with the smaller inclination angle from being too gentle and to make the extension distance be sufficiently small. As a result, the area that does not contribute to the display in the display component becomes sufficiently small to make the display performance favorable.

(16) In the insulator, the contact hole may have an opening area of 10 μm² to 150 μm². If the contact hole has an opening area of less than 10 μm², the connection area between the first conductive film and the second conductive film becomes too small, thereby deteriorating the connection reliability, in which case it may be difficult to form the contact hole. If the opening area of the contact hole is more than 150 μm², the solution for forming the alignment film, which has reached each edge of the contact hole in the formation of the alignment film, is connected to each other less easily, in which case it may be difficult for the solution for forming the alignment film to flow into the contact hole. In this regard, by setting the opening area of the contact hole in the range of 10 μm² to 150 μm², the connection area between the first conductive film and the second conductive film can be sufficiently secured and the connection reliability is secured and moreover, the contact hole can be formed easily in the insulator and the solution for forming the alignment film easily flows into the contact hole.

A second display component according to the present invention includes a first conductive film, a second conductive film, an insulator, an alignment film, and at least two inclined portions. The second conductive film is disposed above the first conductive film and includes a portion overlapping the first conductive film in a plan view. The insulator is held between the first conductive film and the second conductive film and includes a contact hole for connecting the second conductive film to the first conductive film. The contact hole is at a position overlapping the first conductive film and the second conductive film in a plan view. The alignment film is disposed above the second conductive film and includes a portion overlapping the contact hole in a plan view and a portion not overlapping the contact hole in a plan view. The inclined portions are formed at an edge of the contact hole in the insulator and have inclined shapes in a cross-sectional view with inclination angles different from each other.

According to the configuration, the second conductive film formed after the first conductive film and the insulator are formed is connected to the first conductive film in a lower layer via the contact hole in the insulator. During the formation of the alignment film in a layer above the first conductive film, a solution for forming the alignment film is fed a portion of the surface of the second conductive film. The solution spreads outside and inside of the contact hole and the alignment film is formed. The alignment film includes the portion overlapping the contact hole in a plan view and the portion not overlapping the contact hole in a plan view. When the solution for forming the alignment film fed to the outside of the contact hole spreads toward the inside of the contact hole and reaches the edge of the contact hole, flow of the solution into the contact hole is promoted by the inclined portion having a smaller inclination angle, that is, having a gentle slope, among the inclined portions having the inclination angles different from each other at the edge of the contact hole. At a portion of the edge of the contact hole at a boundary between the inclined portions having the inclination angles different from each other, flowability of the solution for forming the alignment film is improved because of the difference in inclination angle. Therefore, the solution is more likely to flow into the contact hole. Namely, it is easier to form the alignment film inside the contact hole and defects are less likely to be developed in the alignment film. According to the configuration, the moire is properly suppressed or reduced.

A display device according to the present invention includes the display component described above, an opposite board, and liquid crystals. The opposite board is disposed opposite to the display component. The liquid crystals disposed between the display component and the opposite board. In the display device, the defects are less likely to be developed in the alignment film of the display component and the moire is properly reduced or suppressed. Therefore, the alignment of liquid crystals is properly performed and high display quality is achieved.

A method of producing the first display component according to the present invention includes a first film forming process and a second film forming process. The first film forming process is for forming the first conductive film, the insulator, and the second conductive film in this sequence on a substrate. The first film forming process includes forming the contact hole at a position overlapping the first conductive film and the second conductive film in a plan view for connecting the second conductive film to the first conductive film. The first film forming process further includes forming a bending portion at a portion of an edge of the contact hole such that the bending portion bends toward the inner side of the contact hole and has a reflex outer angle in a plan view. The second film forming process is for forming the alignment film including the portion that overlaps the contact hole and the portion that does not overlap the contact hole in a plan view.

According to the method, when the second conductive film is formed after the first conductive film and the insulator are formed on the substrate in the first film forming process, the second conductive film is connected to the first conductive film in the lower layer via the contact hole formed in the insulator. In the second film forming process performed after the first film forming process, when the solution for forming the alignment film is fed to a portion of the surface of the second conductive film for forming the alignment film in a layer above the first conductive film and the solution spreads outside and inside the contact hole, the alignment film is formed. The alignment film includes the portion overlapping the contact hole and the portion not overlapping the contact hole in a plan view. When the solution for forming the alignment film fed to the outside of the contact hole spreads toward the inside of the contact hole and reaches the bending portion that bends toward the inside with the reflex angle in a plan view at the edge of the contact hole, the solution is drawn to the inside of the contact hole by the bending portion. The reason why the solution is drawn as such is that a force may be exerted on the solution by the bending portion having the reflex angle on the inside in a plan view to spread in a wide angle when the solution reaches the bending portion. According to the configuration, the alignment film is easily formed inside the contact hole. Therefore, the defects are less likely to be developed in the alignment film and the moire is properly reduced or suppressed.

Preferable embodiments of the method of producing the first display component may include the following.

(1) In the second film forming process, an inkjet device is used and the solution for forming the alignment film is discharged out of a plurality of nozzles in the inkjet device onto the second conductive film. Thus, in the second film forming process, the solution for forming the alignment film discharged out of the nozzles of the inkjet device reaches the upper side of the second conductive film and then spreads over the surface. The arrangement of the nozzles of the inkjet device may interfere with the arrangement of the contact holes, in which case the solution for forming the alignment film discharged out of the nozzles may not spread sufficiently. This may result in the moire. According the configuration described above, the bending portion is included in the edge of the contact hole. The solution for forming the alignment film is drawn to the contact holes by the bending portions. Therefore, the alignment film is easily formed in the contact hole and the moire is properly reduced or suppressed.

(2) In the second film forming process, a stencil printing device is used. While the solution for forming the alignment film is supplied onto the mesh stencil included in the stencil printing device, the squeegee is moved on the stencil. Thus, the solution for forming the alignment film is printed onto the upper side of the second conductive film through the holes of the stencil. Thus, the solution for forming the alignment film supplied onto the mesh stencil included in the stencil printing device in the second film forming process is printed onto the second conductive film through the holes of the stencil by the squeegee moving on the stencil and spreads over the surface. The stencil of the stencil printing device has the holes and has a mesh shape. An arrangement of the holes and the arrangement of the contact holes may overlap each other. If the solution for forming the alignment film does not sufficiently spread after passed through the holes, the moire may occur. In this embodiment, the bending portions are included in the edges of the respective contact holes as described above, the solution for forming the alignment film is drawn into the contact holes by the bending portions. Therefore, the alignment film is easily formed in the contact holes and the moire is properly reduced or suppressed.

(3) In the first film forming process, at least the organic insulator formed of a photosensitive organic material is provided as the insulator and the organic insulator is exposed to light using a halftone mask including a semitransmissive film or a gray tone mask including a semitransmissive area by a slit as a photomask. Thus, at least the bending portion in the edge of the contact hole is formed to have the sectional shape gradually rising and the edge has the first inclined portion disposed on the relatively lower side and having a larger inclination angle, and the second inclined portion disposed on the relatively upper side and having a smaller inclination angle. Thus, the organic insulator formed of the photosensitive organic material provided in the first film forming process is exposed to light using the halftone mask including the semitransmissive film or the gray tone mask including the semitransmissive area by the slit. Therefore, the bending portion is formed to have the sectional shape gradually rising and the bending portion has the first inclined portion disposed on the relatively lower side and having a larger inclination angle, and the second inclined portion disposed on the relatively upper side and having a smaller inclination angle. If the bending portion is formed entirely from the first inclined portion, the solution for forming the alignment film is moved toward the first inclined portion less easily because the inclination is sharp. As compared to this, the solution for forming the alignment film is moved smoothly when the second inclined portion with a less sharp inclination is disposed above the first inclined portion. Therefore, when the solution for forming the alignment film has reached the bending portion in the edge of the contact hole in the formation of the alignment film, the solution is induced to flow into the contact hole by the second inclined portion disposed on the relatively upper side and having the smaller inclination angle. Thus, the solution enters the contact hole smoothly through the first inclined portion. The above case is suitable when the contact hole is small, as compared to the case where the bending portion is entirely formed of the second inclined portion because the edge of the contact hole tends to have a larger width.

A method of producing the second display component according to the present invention includes a first film forming process and a second film forming process. The first film forming process is for forming the first conductive film, the insulator, and the second conductive film in this sequence of a substrate. The first film forming process includes forming the contact hole at a portion overlapping the first conductive film and the second conductive film in a plan view for connecting the second conductive film to the first conductive film. The first film forming process further includes forming at least two inclined portions at an edge of the contact hole such that the inclined portions have inclined shapes in a cross-sectional view and inclination angles different from each other. The second film forming process is for forming the alignment film including a portion overlapping the contact hole and a portion not overlapping the contact hole.

According to the method, when the second conductive film is formed after the first conductive film and the insulator are formed on the substrate in the first film forming process, the second conductive film is connected to the first conductive film in the lower layer via the contact hole formed in the insulator. In the second film forming process performed after the first film forming process, when the solution for forming the alignment film is fed to a portion of the surface of the second conductive film for forming the alignment film in a layer above the first conductive film and the solution spreads outside and inside the contact hole, the alignment film is formed. The alignment film includes the portion overlapping the contact hole and the portion not overlapping the contact hole in a plan view. When the solution for forming the alignment film fed to the outside of the contact hole spreads toward the inside of the contact hole and reaches the edge of the contact hole, the flow of the solution to the inside of the contact hole is promoted by the inclined portion having the smaller inclination angle and a gentle slope among the inclined portions having the different inclination angles. Furthermore, flowability of the solution for forming the alignment film is increased at a boundary between the inclined portions having different inclination angles at the edge of the contact hole and thus the solution is more likely to flow into the contact hole. According to the configuration, the alignment film is easily formed inside the contact hole. Therefore, the defects are less likely to be developed in the alignment film and the moire is properly reduced or suppressed.

Preferable embodiments of the method of producing the second display component may include the following.

(1) The first film forming process may include forming at least an organic insulator from photosensitive organic resin material as the insulator. The first film forming process may include exposing the organic insulator using a halftone mask including a semitransmissive film or a gray-tone mask including a semitransmissive area with a slit as a photomask. The first film forming process may include forming one of the inclined portions having the smaller inclination angle at the edge of the contact hole with light transmitted through the semitransmissive film of the halftone mask or the semitransmissive area of the gray-tone mask.

### Advantageous Effect of the Invention

According to the present invention, the moire is suppressed or reduced.

### BRIEF DESCRIPTION OF THE DRAWINGS

FIG. 1 is a schematic plan view of a liquid crystal panel on which a driver is mounted, a flexible printed circuit board, and a control circuit board according to a first embodiment of the present invention illustrating connection among those.

FIG. 2 is a schematic cross-sectional view of a liquid crystal display device illustrating a cross-sectional configuration along a long-side direction thereof.

FIG. 3 is a schematic cross-sectional view illustrating a cross-sectional configuration of the liquid crystal panel.

FIG. 4 is a plan view schematically illustrating a wiring configuration on an array board in the liquid crystal panel.

FIG. 5 is a plan view illustrating wiring between a row control circuit and a gate line in a non-display area on the array board.

FIG. 6 is a cross-sectional view along line vi-vi in FIG. 5.

FIG. 7 is a plan view illustrating a plane configuration of pixels in a display area on the array board.

FIG. 8 is a plan view illustrating a TFT and its vicinity in FIG. 7 in an enlarged manner.

FIG. 9 is a cross-sectional view along line ix-ix in FIG. 8.

FIG. 10 is a cross-sectional view along line x-x in FIG. 8.

FIG. 11 is a cross-sectional view along line xi-xi in FIG. 8.

FIG. 12 is a perspective view illustrating a schematic configuration of an inkjet device for applying an alignment film.

FIG. 13 is a schematic plan view representing the behavior of a solution for forming the alignment film in a bending portion.

FIG. 14 is a schematic plan view representing the behavior of a solution for forming the alignment film in an expanded hole portion.

FIG. 15 is a cross-sectional view of a TFT in a display area on an array board according to a second embodiment of the present invention, which is taken along an X-axis direction.

FIG. 16 is a cross-sectional view of the TFT in the display area on the array board, which is taken along a Y-axis direction.

FIG. 17 is a cross-sectional view illustrating a process of exposing an organic insulator to light using a gray tone mask, which is the same as FIG. 15.

FIG. 18 is a cross-sectional view illustrating the process of exposing the organic insulator to light using the gray tone mask, which is the same as FIG. 16.

FIG. 19 is a cross-sectional view illustrating a state before an alignment film is applied using a screen printing device according to a third embodiment of the present invention.

FIG. 20 is a plan view illustrating a TFT and its vicinity in a display area on an array board according to a fourth embodiment of the present invention in an enlarged manner.

FIG. 21 is a plan view illustrating a TFT and its vicinity in a display area on an array board according to a fifth embodiment of the present invention in an enlarged manner.

FIG. 22 is a plan view schematically illustrating the planar shape of a lower contact hole according to a sixth embodiment of the present invention.

FIG. 23 is a plan view schematically illustrating the planar shape of a lower contact hole according to a seventh embodiment of the present invention.

FIG. 24 is a plan view schematically illustrating the planar shape of a lower contact hole according to an eighth embodiment of the present invention.

FIG. 25 is a plan view schematically illustrating the planar shape of a lower contact hole according to a ninth embodiment of the present invention.

FIG. 26 is a plan view schematically illustrating the planar shape of a lower contact hole according to a tenth embodiment of the present invention.

FIG. 27 is a plan view schematically illustrating the planar shape of a lower contact hole according to an eleventh embodiment of the present invention.

FIG. 28 is a plan view schematically illustrating the planar shape of a lower contact hole according to a twelfth embodiment of the present invention.

FIG. 29 is a plan view schematically illustrating the planar shape of a lower contact hole according to a thirteenth embodiment of the present invention.

FIG. 30 is a plan view illustrating a TFT and its vicinity in a display area on an array board according to a fourteenth embodiment of the present invention in an enlarged manner.

FIG. 31 is a cross-sectional view along line xxxi-xxxi in FIG. 30.

FIG. 32 is a cross-sectional view along line xxxii-xxxii in FIG. 30.

FIG. 33 is a cross-sectional view illustrating a process of exposing an organic insulator to light using a gray tone mask, which is the same as FIG. 31.

FIG. 34 is a cross-sectional view illustrating the process of exposing the organic insulator to light using the gray tone mask, which is the same as FIG. 32.

FIG. 35 is a plan view schematically illustrating the planar shape of a lower contact hole according to a fifteenth embodiment of the present invention.

FIG. 36 is a plan view schematically illustrating the planar shape of a lower contact hole according to a sixteenth embodiment of the present invention.

FIG. 37 is a plan view illustrating a TFT and its vicinity in a display area on an array board according to a seventeenth embodiment of the present invention in an enlarged manner.

FIG. 38 is a cross-sectional view along line xxxviii-xxxviii in FIG. 37.

FIG. 39 is a cross-sectional view along line xxxix-xxxix in FIG. 37.

FIG. 40 is a plan view schematically illustrating the planar shape of a lower contact hole according to an eighteenth embodiment of the present invention.

FIG. 41 is a plan view schematically illustrating the planar shape of a lower contact hole according to a nineteenth embodiment of the present invention.

FIG. 42 is a plan view schematically illustrating the planar shape of a lower contact hole according to a twentieth embodiment of the present invention.

FIG. 43 is a plan view schematically illustrating the planar shape of a lower contact hole according to a twenty-first embodiment of the present invention.

FIG. 44 is a plan view schematically illustrating the planar shape of a lower contact hole according to a twenty-second embodiment of the present invention.

FIG. 45 is a plan view schematically illustrating the planar shape of a lower contact hole according to a twenty-third embodiment of the present invention.

FIG. 46 is a plan view schematically illustrating the planar shape of a lower contact hole according to a twenty-fourth embodiment of the present invention.

FIG. 47 is a plan view schematically illustrating the planar shape of a lower contact hole according to a twenty-fifth embodiment of the present invention.

FIG. 48 is a plan view schematically illustrating the planar shape of a lower contact hole according to a twenty-sixth embodiment of the present invention.

FIG. 49 is a plan view schematically illustrating the planar shape of a lower contact hole according to a twenty-seventh embodiment of the present invention.

FIG. 50 is a plan view schematically illustrating the planar shape of a lower contact hole according to a twenty-eighth embodiment of the present invention.

FIG. 51 is a plan view schematically illustrating the planar shape of a lower contact hole according to a twenty-ninth embodiment of the present invention.

FIG. 52 is a plan view schematically illustrating the planar shape of a lower contact hole according to a thirtieth embodiment of the present invention.

FIG. 53 is a plan view schematically illustrating the planar shape of a lower contact hole according to a thirty-first embodiment of the present invention.

FIG. 54 is a plan view schematically illustrating the planar shape of a lower contact hole according to a thirty-second embodiment of the present invention.

FIG. 55 is a plan view schematically illustrating the planar shape of a lower contact hole according to a thirty-third embodiment of the present invention.

### MODE FOR CARRYING OUT THE INVENTION

### First Embodiment

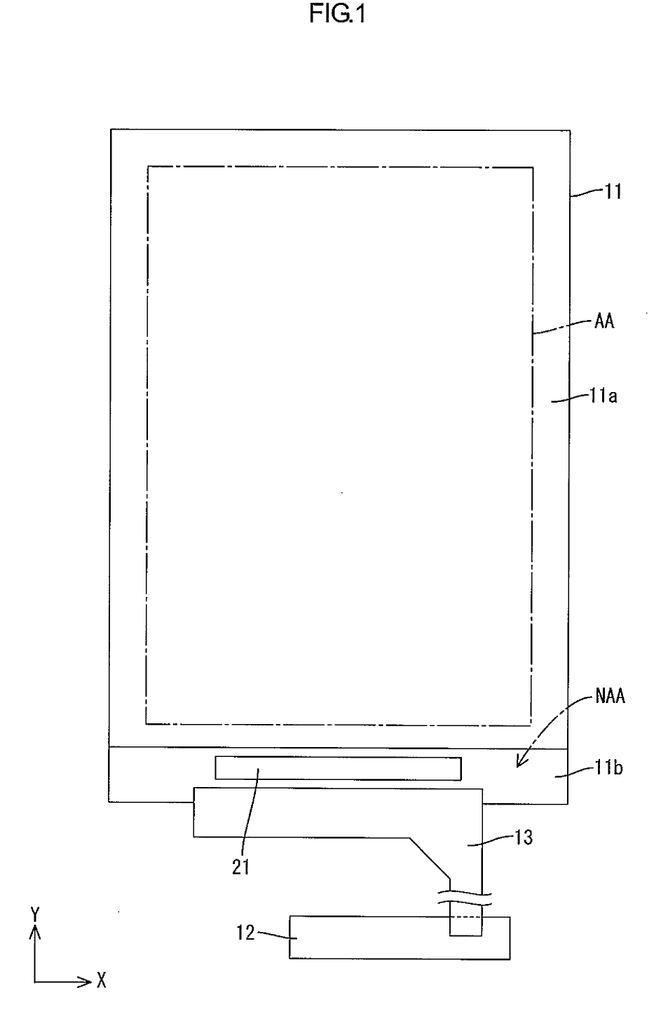

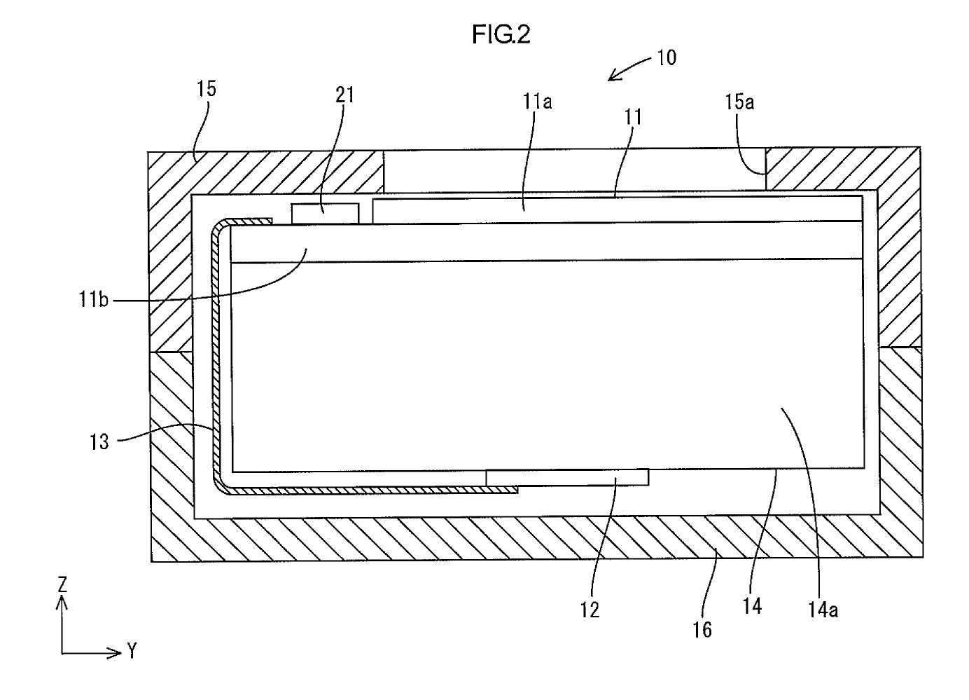

A first embodiment of the present invention will be described with reference to FIGS. 1 to 14. A liquid crystal display device 10 will be described as an example. X-axis, the Y-axis and the Z-axis may be present in the drawings. The axes in each drawing correspond to the respective axes in other drawings. The vertical direction is defined based on FIG. 2. An upper side and a lower side in FIG. 2 correspond to a front side and the back side of the liquid crystal display device 10, respectively.

As illustrated in FIGS. 1 and 2, a liquid crystal display device 10 includes a liquid crystal panel (display device) 11, a driver (panel driver) 21, a control circuit board (external signal source) 12, a flexible board (external connecting component) 13, and a backlight unit (illumination device) 14. The liquid crystal panel 11 includes a display area AA configured to display an image and a non-display area NAA outside the display area AA. The driver 21 is configured to drive the liquid crystal panel 11. The control circuit board 12 is configured to supply various input signals from the outside to the driver 21. The flexible board 13 electrically connects the liquid crystal panel 11 to the external control circuit board 12. The backlight unit 14 is an external light source configured to supply light to the liquid crystal panel 11. The liquid crystal display device 10 further includes a pair of exterior components 15 and 16 that are front and rear components used in a pair to hold the liquid crystal panel 11 and the backlight unit 14 that are attached together. The exterior component 15 on the front side has an opening 15a through which images displayed in the display area AA of the liquid crystal panel 11 are viewed from the outside. The liquid crystal display device 10 according to this embodiment may be used in various kinds of electronic devices (not illustrated) such as mobile phones (including smartphones), laptop computers (including tablet computers), handheld terminals (including electronic books and PDAs), digital photo frames, portable video game players, and electronic-ink papers. The liquid crystal panel 11 in the liquid crystal display device 10 is in a range between some inches to ten and some inches. Namely, the liquid crystal panel 11 is in a size that is classified as a small or a small-to-medium.

The backlight unit 14 will be briefly described. As illustrated in FIG. 2, the backlight unit 14 includes a chassis 14a, light sources (e.g., cold cathode fluorescent tubes, LEDs, organic ELs), and an optical member. The chassis 14a has a box-like shape with an opening on the front side (opening toward the liquid crystal panel 11). The light sources, which are not illustrated, are disposed inside the chassis 14a. The optical member, which is not illustrated, is disposed to cover the opening of the chassis 14a. The optical member has a function to convert light from the light sources into planar light.

Next, the liquid crystal panel 11 will be described. As illustrated in FIG. 1, the liquid crystal panel 11 has a vertically-long rectangular overall shape (rectangular shape). The liquid crystal panel 11 includes the display area (active area) AA that is off centered toward one of ends of a long dimension thereof (the upper side in FIG. 1). The driver 21 and the flexible board 13 are mounted to a portion of the liquid crystal panel 11 closer to the other end of the long dimension of the liquid crystal panel 11 (the lower side in FIG. 1). An area of the liquid crystal panel 11 outside the display area AA is a non-display area (non-active area) NAA in which images are not displayed. The non-display area NAA includes a frame-shaped area around the display area AA (a frame portion of a CF board 11a, which will be described later) and an area provided at the other end of the long dimension (an exposed area of an array board 11b which does not overlap the CF board 11a and exposed, which will be described later). The area provided at the other end of the long dimension of the liquid crystal panel 11 includes a mounting area (an attachment area) to which the driver 21 and the flexible printed circuit board 13 are mounted. The short dimension of the liquid crystal panel 11 coincides with the X-axis direction of each drawing and the long dimension thereof coincides with the Y-axis direction of each drawing. In FIG. 1, a chain line box slightly smaller than the CF board 11a indicates a boundary of the display area AA. An area outside the solid line is the non-display area NAA.

Next, the components connected to the liquid crystal panel 11 will be described. As illustrated in FIGS. 1 and 2, the control circuit board 12 is mounted to the back surface of the chassis 14a (an outer surface on a side opposite from the liquid crystal panel 11) of the backlight unit 14 with screws. The control circuit board 12 includes a substrate and electronic components. The substrate is made of paper phenol or glass epoxy resin. The electronic components are mounted on the substrate and configured to supply various input signals to the driver 21. Traces (electrically conductive paths) which are not illustrated are formed in predetermined patterns. An end (end side) of the flexible printed circuit board 13 is electrically and mechanically connected to the control circuit board 12 via an anisotropic conductive film (ACF), which is not illustrated.

The flexible board (FPC board) 13 includes a base member made of synthetic resin having insulating property and flexibility (e.g., polyimide resin) as illustrated in FIG. 2. A number of traces are formed on the base member (not illustrated). The end of the long dimension of the flexible board 13 is connected to the control circuit board 12 disposed on the back surface of the chassis 14a as described above, while the other end of the long dimension of the flexible board 13 is connected to the array board 11b in the liquid crystal panel 11. The flexible printed circuit board 13 is therefore bent or folded back inside the liquid crystal display device 10 such that a cross-sectional shape thereof forms a U-like shape. At the ends of the long dimension of the flexible board 13, the wiring patterns are exposed to the outside and configured as terminals (not illustrated). The terminals are electrically connected to the control circuit board 12 and the liquid crystal panel 11. With this configuration, input signals supplied by the control circuit board 12 are transmitted to the liquid crystal panel 11.

As illustrated in FIG. 1, the driver 21 is provided by an LSI chip including drive circuits. The driver 21 is configured to operate according to signals supplied by the control circuit board 12 serving as a signal source, to process the input signal supplied by the control circuit board 12 to generate output signals, and to output the output signals to the display area AA in the liquid crystal panel 11. The driver 21 has a horizontally-long rectangular shape (an elongated shape that extends along the short side of the liquid crystal panel 11) in a plan view. The driver 21 is directly mounted to the non-display area NAA of the liquid crystal panel 11 (or the array board 11b, which will be described later), that is, mounted by the chip-on-glass (COG) mounting method. The long dimension and the short dimension of the driver 21 correspond to the X-axis direction (the short dimension of the liquid crystal panel 11) and the Y-axis direction (the long dimension of the liquid crystal panel 11), respectively.

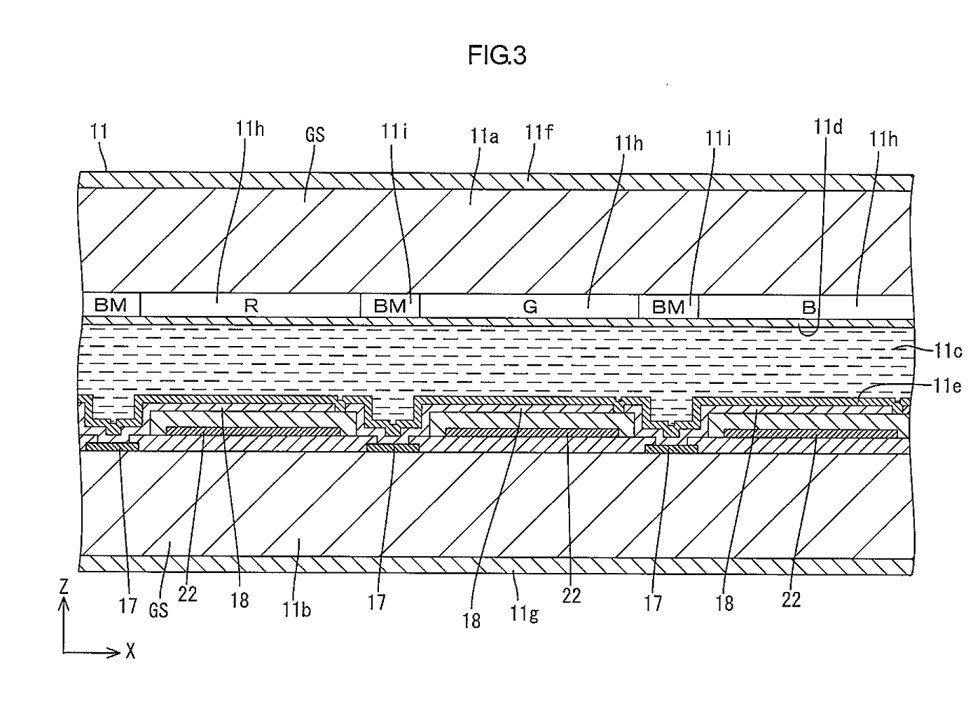

The liquid crystal panel 11 will be described in more detail. As illustrated in FIG. 3, the liquid crystal panel 11 includes a pair of substrates 11a and 11b, and a liquid crystal layer (liquid crystal) 11c. The liquid crystal layer 11c is interposed between the substrates 11a and 11b, and includes liquid crystal molecules having optical characteristics that change according to application of the electric field. The substrates 11a and 11b are bonded by a sealing agent (not illustrated) while a gap corresponding to the thickness of the liquid crystal layer 11c is maintained. The liquid crystal panel 11 according to this embodiment operates in a fringe field switching (FFS) mode that is a mode improved from an in-plane switching (IPS) mode. Of the pair of substrates 11a and 11b, the array board 11b is provided with pixel electrodes (second transparent electrodes) 18 and common electrodes (first transparent electrodes) 22, which will be described later. The electrodes 18 and the common electrodes 22 are provided in the different layers. Of the pair of substrates 11a and 11b, the substrate on the front side is the CF board (opposite substrate) 11a and the substrate on the back side (rear side) is the array board (display component) 11b. The CF board 11a and the array board 11b each include a glass substrate GS that is substantially transparent (i.e., having high light transmissivity). Various films are formed in layers on each glass substrate GS. As illustrated in FIGS. 1 and 2, the CF board 11a has a short dimension substantially equal to that of the array board 11b and a long dimension smaller than that of the array board 11b. The CF board 11a is bonded to the array board 11b with one of ends of the long dimension (the upper end in FIG. 1) aligned with a corresponding edge of the array board 11b. A predetermined area of the other end of the long dimension of the array board 11b (the lower end in FIG. 1) does not overlap the CF board 11a and front and back plate surfaces of the area are exposed to the outside. The mounting area in which the driver 21 and the flexible printed circuit board 13 are mounted is provided in this area. Alignment films 11d and 11e are formed on inner surfaces of the substrates 11a and 11b, respectively, for alignment of the liquid crystal molecules included in the liquid crystal layer 11c. The alignment films 11d and 11e are formed of, for example, polyimide, and are in solid patterns formed in a substantially whole area along the plate surfaces of the substrates 11a and 11b. The alignment films 11d and 11e are configured to align, by irradiation with light having a particular wavelength (for example, ultraviolet ray), the liquid crystal molecules in the irradiation direction of the light. Polarizing plates 11f and 11g are attached to the outer surfaces of the substrates 11a and 11b.

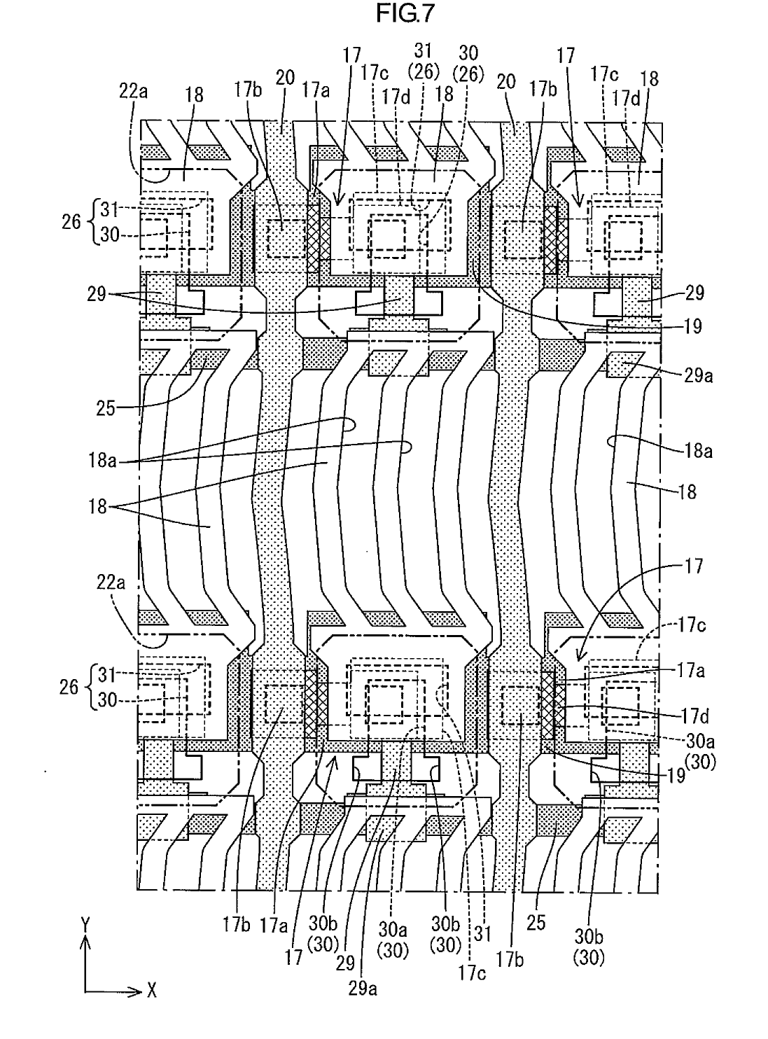

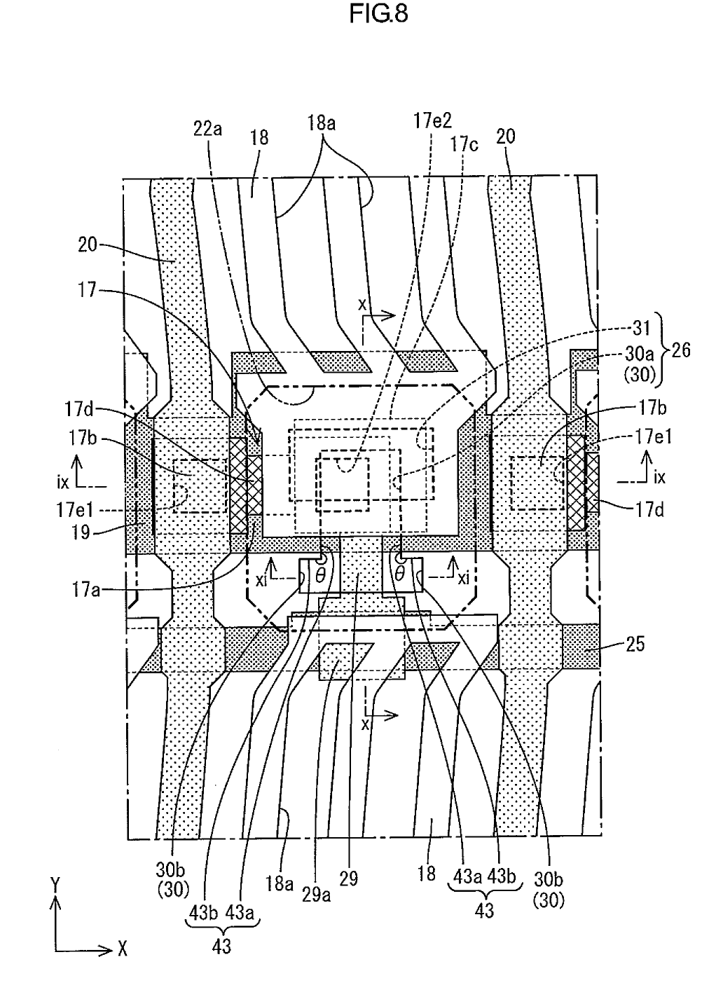

The films formed in layers on the inner surface of the array board 11b (on the liquid crystal layer 11c side, a surface opposite to the CF board 11a) by a known photolithography method will be described. As illustrated in FIG. 7, on the array board 11b, the following films are formed in the following sequence from the lowest layer (the grass substrate GS): a first metal film (first conductive film, gate metal film) 34, a gate insulator (insulator, first insulator) 35, a semiconductor film 36, a protection film (insulator, etching stopper film) 37, a second metal film (first conductive film, source metal film) 38, a first interlayer insulator (insulator, second insulator) 39, an organic insulator (insulator) 40, a first transparent electrode film 23, a second interlayer insulator (third insulator) 41, and a second transparent electrode film (second conductive film) 24. In FIGS. 7 and 8, the first metal film 34, the semiconductor film 36, and the second metal film 38 are hatched.

The first metal film 34 is a multilayer film of titanium (Ti) and copper (Cu). The gate insulator 35 is formed at least above the first metal film 34 and is made of, for example, silicon oxide (SiO₂). The semiconductor film 36 is formed of an oxide thin film containing indium (In), gallium (Ga), and zinc (Zn), which are a kind of oxide semiconductors. The oxide semiconductor film that contains indium (In), gallium (Ga), and zinc (Zn), that is, the oxide semiconductor film 36 is amorphous or crystalline. The protection film 37 is made of silicon oxide (SiO₂). The second metal film 38 is a multilayer film that includes titanium (Ti) and copper (Cu). The first interlayer insulator 39 is made of silicon oxide (SiO₂). The organic insulator 40 is made of acrylic resin (e.g., polymethyl methacrylate (PMMA)), which is an organic material, and functions as a planarization film. The first transparent electrode film 23 and the second transparent electrode film 24 are made of a transparent electrode material such as indium tin oxide (ITO) or zinc oxide (ZnO). The second interlayer insulator 41 is made of silicon nitride (SiNₓ). The first transparent electrode film 23 and the second transparent electrode film 24 among these films are formed only in the display area AA of the array board 11b, and are not formed in the non-display area NAA. The insulators made of the insulating materials, such as the gate insulator 35, the protection film 37, the first interlayer insulator 39, the organic insulator 40, and the second interlayer insulator 41, are formed in solid patterns disposed in a substantially whole area of the surface of the array board 11b (although holes are formed in some areas). The first metal film 34, the oxide semiconductor film 36, and the second metal film 38 are formed in predetermined patterns in the display area AA and the non-display area NAA of the array board 11b.

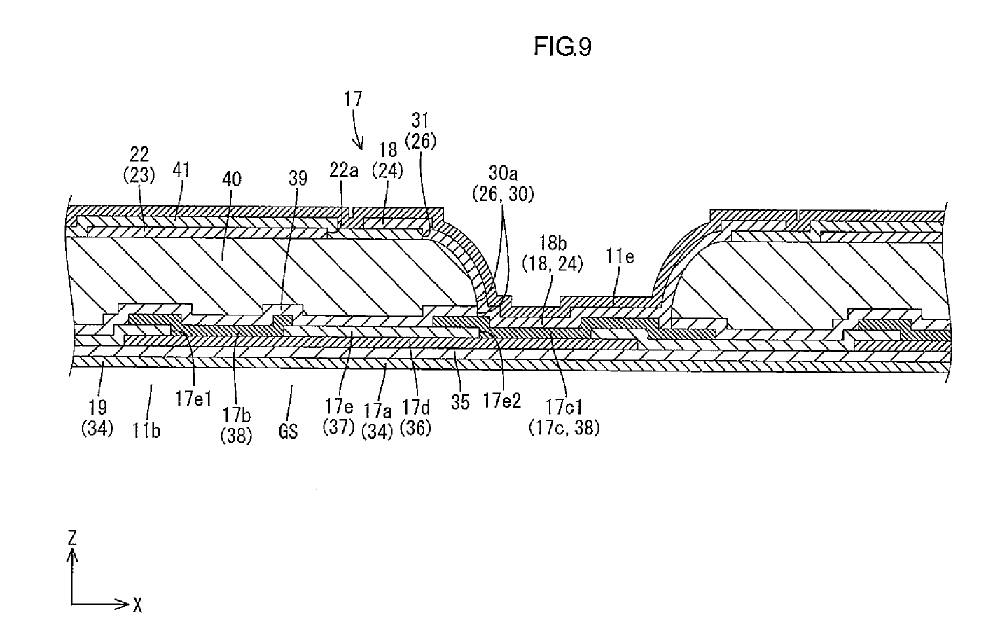

Next, configurations of components in the display area AA of the array board 11b will be described in sequence. As illustrated in FIGS. 7 and 8, in the display area AA of the array board 11b, a number of TFTs (transistors) 17, which are switching components, and a number of pixel electrodes 18 are disposed in a matrix. Gate lines (scanning lines, row control lines) 19 and source lines (column control lines, data lines) 20 are routed in a matrix such that each pair of display area TFT 17 and the pixel electrode 18 is in a cell defined by the gate lines 19 and the source lines 20. Namely, the TFTs 17 and the pixel electrodes 18 are disposed in parallel to be arranged in a matrix at respective corners defined by the gate lines 19 and the source lines 20 that are formed in a matrix. The gate lines 19 are formed from the first metal film 34 and the source lines 20 are formed from the second metal film 38. The gate insulator 35 and the protection film 37 are interposed between the gate line 19 and the source line 20 at an intersection thereof. The gate lines 19 and the source lines 20 are connected to gate electrodes 17a and source electrodes 17b of the TFTs 17, respectively. The pixel electrodes 18 are connected to drain electrodes 17c of TFTs 17 (FIG. 9). The gate line 19 is disposed overlapping one end (the lower end in FIG. 7) of the pixel electrode 18 in a plan view (viewed from the normal line direction relative to the plate surface of the array board 11b). In addition, the array board 11b is provided with an auxiliary capacitor line (storage capacitor line, Cs line) 25 that is in parallel to the gate line 19 and overlaps a portion of the pixel electrode 18 in a plan view. The auxiliary capacitor line 25 is made of the same metal film 34 as the gate line 19, and is provided overlapping the other end (the upper end in FIG. 7) in the pixel electrode 18 in a plan view, i.e., on the opposite side with the center of the pixel electrode 18 interposed between the auxiliary capacitor line 25 and the gate line 19 in the Y-axis direction. In other words, the auxiliary capacitor line 25 is provided adjacent to the gate line 19 while a predetermined gap is maintained therebetween in the Y-axis direction. The gate line 19 is connected to the pixel electrode 18 adjacent to the pixel electrode 18 on the upper side overlapping the auxiliary capacitor line 25 via the TFT 17 as illustrated in FIG. 7. The auxiliary capacitor lines 25 and the gate lines 19 are alternately disposed in the Y-axis direction.

As illustrated in FIG. 8, the TFT 17 is mounted on the gate line 19, i.e., disposed entirely overlapping the gate line 19 in a plan view. A portion of the gate line 19 constitutes the gate electrode 17a of the TFT 17, and the portion of the source line 20 that overlaps the gate line 19 in a plan view constitutes the source electrode 17b of the TFT 17. The TFT 17 includes the drain electrode 17c, which has an island shape by being disposed opposite to the source electrode 17b with a predetermined gap therebetween in the X-axis direction. The drain electrode 17c is formed from the second metal film 38, which is the same as the source electrode 17b (source line 20), and is disposed overlapping one end of the pixel electrode 18 (portion where a later-described slit 18a is not formed) in a plan view. The drain electrode 17c has a drain line 29 formed from the same second metal film 38 connected thereto. The drain line 29 is extended from the connected drain electrode 17c in the Y-axis direction toward the lower side in FIG. 8, i.e., toward the auxiliary capacitor line 25, and an extension end thereof is provided with a capacitance formation portion 29a forming capacitance by overlapping the auxiliary capacitor line 25 and the next pixel electrode 18 (specifically, the pixel electrode 18 adjacent to and below the pixel electrode 18 connected to the drain electrode 17c in FIG. 8) in a plan view. The portion of the gate line 19 not overlapping the source line 20 in a plan view is formed to have a larger line width than the portion overlapping the source line 20 in a plan view, while the portion of the source line 20 overlapping the gate line 19 and the auxiliary capacitor line 25 in a plan view is formed to have a larger line width than the portion not overlapping the gate line 19 and the auxiliary capacitor line 25 in a plan view.

As illustrated in FIG. 9, the TFT 17 includes the gate electrode 17a formed from the first metal film 34, a channel 17d formed from the semiconductor film 36 and disposed so as to overlap the gate electrode 17a in a plan view, a protection portion 17e formed from the protection film 37 and including two openings 17e1 and 17e2 that penetrate at positions overlapping the channel 17d in a plan view, the source electrode 17b formed from the second metal film 38 and connected to the channel 17d via one of the openings 17e1 and 17e2, specifically the opening 17e1, and the drain electrode 17c formed from the second metal film 38 and connected to the channel 17d via the other one of the openings 17e1 and 17e2, specifically the opening 17e2. The gate electrode 17a includes a portion of the gate line 19 overlapping at least the source electrode 17b, the drain electrode 17c, and the channel 17d in a plan view. The channel 17d extends along the X-axis direction and bridges between the source electrode 17b and the drain electrode 17c to allow a flow of electrons between the electrodes 17b and 17c. The semiconductor film 36 that forms the channel 17d is an oxide thin film containing indium (In), gallium (Ga), and zinc (Zn). The oxide thin film containing indium (In), gallium (Ga), and zinc (Zn) has electron mobility higher than that of an amorphous silicon thin film, for example, 20 to 50 times higher. Therefore, the TFTs 17 can be easily downsized and the amount of transmitted light through each pixel electrode 18 can be increased to the maximum level. This configuration is preferable for enhancement of image resolution and reduction of power consumption. Each TFT 17 including the oxide thin film containing indium (In), gallium (Ga), and zinc (Zn) is an inverted-staggered type having a configuration in which the gate electrode 17a is disposed at the bottom and the channel 17d is disposed thereon with the gate insulator 35 interposed therebetween. A stacking structure of the TFT 17 is similar to that of a commonly-used TFT including an amorphous silicon thin film.

Each pixel electrode 18 is formed from the second transparent electrode film 24 as illustrated in FIGS. 8 and 9. The pixel electrode 18 has a vertically-long rectangular overall shape (approximately rectangular shape) in a plan view and disposed in an area defined by the gate lines 19 and the source lines 20. One end of the pixel electrode 18 overlaps the gate line 19 in a plan view and the portion excluding the overlapping portion does not overlap the gate line 19 in a plan view. The non-overlapping portion includes a plurality of longitudinal slits 18a (two in FIG. 8), with which a comb-shaped portion is formed. This slit 18a extends to the portion of the pixel electrode 18 that overlaps the gate line 19 in a plan view. The lower end of the pixel electrode 18 in FIG. 8 is positioned between the lowest end position of the gate line 19 and the lowest end position of the drain electrode 17c, specifically closer to the lower end position of the drain electrode 17c. The pixel electrode 18 is formed on the second interlayer insulator 41 and the second interlayer insulator 41 exists between the pixel electrode 18 and the common electrode 22, which will be described below. Under the pixel electrode 18, the first interlayer insulator 39, the organic insulator 40, and the second interlayer insulator 41 are disposed. Portions of them overlapping the drain electrode 17c and the pixel electrode 18 in a plan view include display area side contact holes (contact holes, first contact holes) 26 that penetrate from the top to the bottom. The pixel electrode 18 is connected to the drain electrode 17c via the display area side contact holes 26. Thus, when current is supplied to the gate electrode 17a of the TFT 17, current flows between the source electrode 17b and the drain electrode 17c through the channel 17d and a predetermined potential is applied to the pixel electrode 18. The display area side contact hole 26 includes a lower contact hole 30 formed penetrating the first interlayer insulator 39 and the organic insulator 40, and an upper contact hole 31 formed penetrating the second interlayer insulator 41 and overlapping partially the lower contact hole 30 in a plan view. As described below in detail, the contact holes 30 and 31 have different planar shapes. A portion of the pixel electrode 18 that is formed inside the lower contact hole 30 and the upper contact hole 31 serves as a pixel electrode side connector 18b to be connected to the drain electrode 17c. On the other hand, a portion of the drain electrode 17c that faces the front side through the lower contact hole 30 and the upper contact hole 31 serves as a drain electrode side connector 17c1 to be connected to the pixel electrode side connector 18b of the pixel electrode 18.

The common electrode 22 is formed from the first transparent electrode film 23 as illustrated in FIGS. 8 and 9. The common electrode 22 is a solid electrode disposed in a substantially whole area of the display area AA of the array board 11b. The common electrode 22 is sandwiched between the organic insulator 40 and the second interlayer insulator 41. A common potential (a reference potential) is applied to the common electrode 22 through a common line, which is not illustrated. By controlling the potential to be applied to the pixel electrode 18 by the TFT 17 as described above, a predetermined potential difference is generated between the electrodes 18 and 22. When the potential difference is generated between the electrodes 18 and 22, a fringe field (an oblique field) including a component in a direction normal to a plate surface of the array board 11b is applied to the liquid crystal layer 11c in addition to a component in a direction along the plate surface of the array board 11b because of the slit 18a of the pixel electrode 18. Therefore, not only alignment of the liquid crystal molecules in the slit 18a in the liquid crystal layer 11c but also alignment of the liquid crystal molecules on the pixel electrode 18 is properly switchable. With this configuration, the aperture ratio of the liquid crystal panel 11 increases and a sufficient amount of transmitted light is obtained. Furthermore, high view-angle performance is achieved. The common electrode 22 is provided with an opening 22a in a portion overlapping with a portion of the TFT 17 in a plan view (specifically, in the range of an approximately rectangular shape surrounded by a two-dot chain line in FIG. 8).

Next, configurations of components in the display area AA of the CF board 11a will be described in detail. As illustrated in FIG. 3, the CF board 11a includes a color filter 11h including red (R), green (G), and blue (B) color portions arranged in a matrix so as to overlap the pixel electrodes 18 on the array board 11b side in a plan view. A light blocking layer (a black matrix) 11i is formed in a grid for preventing colors from mixing. Each line of the grid is located between the adjacent color portions of the color filters 11h. The light blocking layer 11i is disposed to overlap the gate lines 19 and the source lines 20 in a plan view. An alignment film 11d is formed on the surfaces of the color filters 11h and the light blocking layer 11i. Each display pixel of the liquid crystal panel 11, which constitutes a display unit, includes a set of three color portions, that is, R (red), G (green) and B (blue) color portions and three pixel electrodes 18 opposite to the color portions. The display pixel includes a red pixel including the R color portion, a green pixel including the G color portion, and a blue pixel including the B color portion. The pixels are arranged on the plate surface of the liquid crystal panel 11 in repeated sequence along the row direction (the X-axis direction) and form groups of pixels. The groups of pixels are arranged in the column direction (the Y-axis direction).

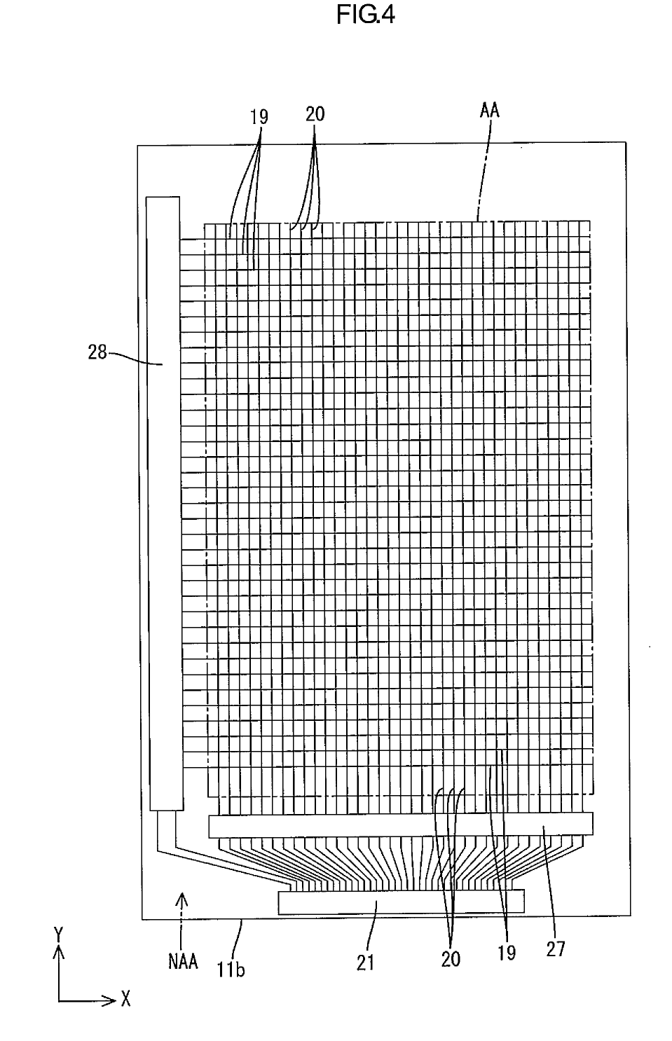

Next, configurations of components in the non-display area NAA of the array board 11b will be described in detail. As illustrated in FIG. 4, a column control circuit 27 is disposed in a portion of the non-display area NAA of the array board 11b adjacent to the short edge of the display area AA. A row control circuit 28 is disposed in a portion of the non-display area NAA adjacent to the long edge of the display area AA. The column control circuit 27 and the row control circuit 28 are configured to perform control for supplying output signals from the driver 21 to the TFTs 17. The column control circuit 27 and the row control circuit 28 are monolithically fabricated on the array board 11b with the oxide thin film (semiconductor film 36) containing indium (In), gallium (Ga), and zinc (Zn) as a base, which is similar to the TFT 17. The column control circuit 27 and the row control circuit 28 include control circuits configured to perform control for supplying the output signals to the TFTs 17. The column control circuit 27 and the row control circuit 28 are formed on the array board 11b by patterning using a known photolithography method during patterning of the TFTs 17 in the fabrication process of the array board 11b.

As illustrated in FIG. 4, the column control circuit 27 is disposed adjacent to the short edge of the display area AA located at the lower side in FIG. 4. Namely, the column control circuit 27 is disposed in a horizontally-long rectangular area along the X-axis direction (direction where the source lines 20 are arranged) between the display area AA and the driver 21 with respect to the Y-axis direction. The column control circuit 27 is connected to the source lines 20 in the display area AA. The column control circuit 27 includes a switching circuit (RGB switching circuit) configured to sort image signals in the output signals from the driver 21 to the respective source lines 20. The source lines 20 are disposed in the display area AA of the array board 11b along the X-axis direction and parallel to each other. The source lines 20 are connected to the TFTs 17 that form R (red), G (green) and B (blue) pixels. The column control circuit 27 sorts the image signals from the driver 21 using the switching circuit and supplies the sorted signals to the respective R, G, B source lines 20. The column control circuit 27 may include ancillary circuits such as a level-shifter circuit and ESD protection circuit.

As illustrated in FIG. 4, the row control circuit 28 is disposed adjacent to the long edge of the display area AA on the left in FIG. 4 within a vertically-long area that extends in the Y-axis direction (direction where the gate lines 19 are arranged). The row control circuit 28 is connected to the gate lines 19 in the display area AA. The row control circuit 28 includes a scanning circuit configured to supply scan signals included in the output signals from the driver 21 to the gate lines 19 at the predetermined timing to scan the gate lines 19 in sequence. The gate lines 19 are disposed in the display area AA of the array board 11b along the Y-axis direction and parallel to each other. The row control circuit 28 supplies control signals (scan signals) from the driver 21 using the scanning circuit to the gate lines 19 in sequence from the one at the top in FIG. 4 to the one at the bottom to scan the gate lines 19. The scanning circuit included in the row control circuit 28 includes a buffer circuit for amplifying the scan signal. The row control circuit 28 may include ancillary circuits such as a level-shifter circuit and an ESD protection circuit. The column control circuit 27 and the row control circuit 28 are connected to the driver 21 via connection lines formed on the array board 11b.

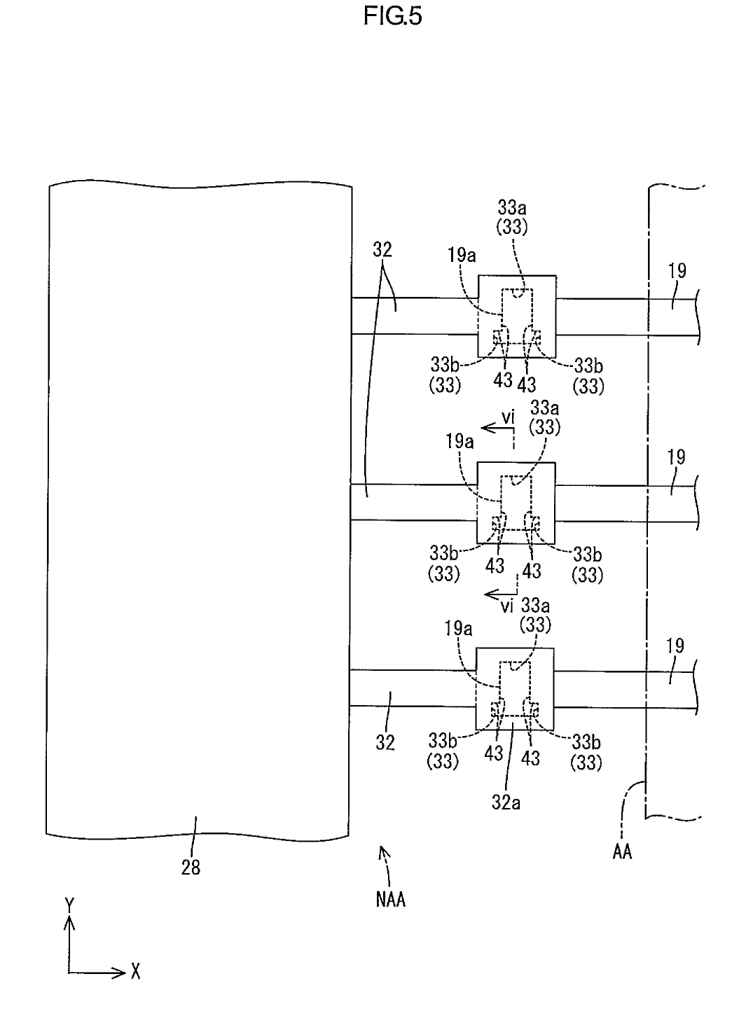

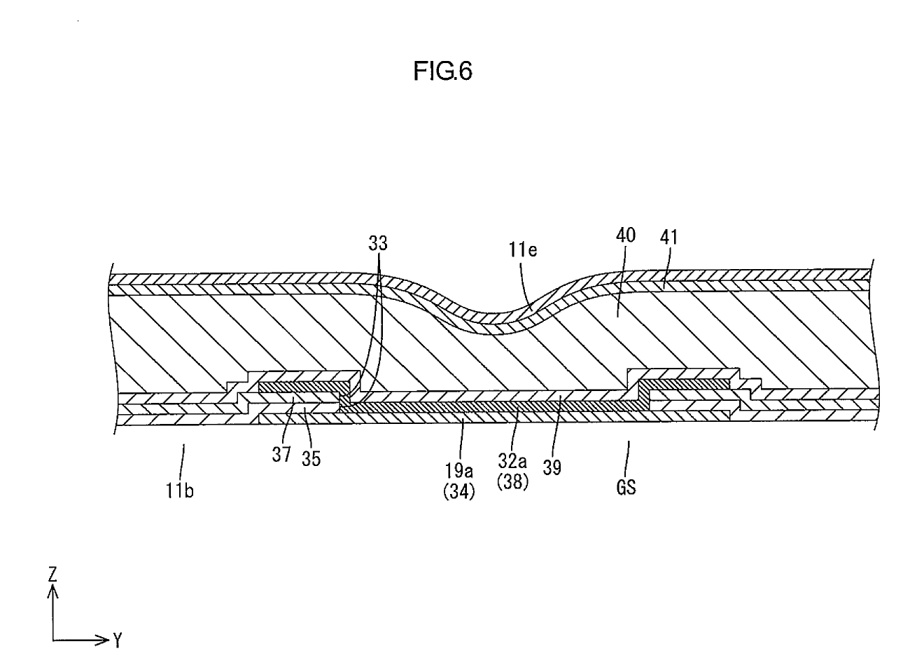

As illustrated in FIG. 5, connection lines 32 to be connected to the gate lines 19 are led out to the display area AA from the row control circuit 28. The connection lines 32 are made of the same second metal film 38 as the source lines 20. The connection lines 32 extend from the row control circuit 28 toward the display area AA along the X-axis direction (direction where the gate lines 19 extend), and have their extension ends serving as connection line side connectors 32a to be connected to the gate lines 19 in the non-display area NAA. The gate line 19 is led out from the display area AA to the non-display area NAA, and an end thereof overlaps the connection line side connector 32a in a plan view and serves as a gate line side connector 19a to be connected to the connection line side connector 32a. As illustrated in FIGS. 5 and 6, at a position where the gate insulator 35 and the protection film 37 disposed below the connection line 32 overlap the connection line side connector 32a and the gate line side connector 19a in a plan view, a non-display area side contact hole (contact hole, second contact hole) 33 is formed penetrating vertically, and through the non-display area side contact hole 33, the connection line side connector 32a is connected to the gate line side connector 19a. The non-display area side contact hole 33 is positioned between the display area AA and the row control circuit 28 in the X-axis direction in the non-display area NAA. A number of (the same number of gate lines 19 arranged in parallel) contact holes 33 are intermittently arranged in parallel along the Y-axis direction, i.e., the direction where the row control circuit 28 extends.

Each of the insulators 35, 37, 39, 40, and 41 provided for the array board 11b as above has the display area side contact hole 26 (lower contact hole 30) and the non-display area side contact hole 33. Therefore, at the portion where the contact holes 26 and 33 are formed, the alignment film 11e disposed at the uppermost layer position is formed to have a depressed shape as illustrated in FIGS. 6 and 9. The alignment film 11e is formed in a manner that the solution for forming the alignment film 11e is applied locally to the inner surface of the array board 11b using, for example, a later-described inkjet device 42, and the applied solution spreads along the surface of the array board 11b, thereby forming the alignment film 11e in the solid pattern. In this film forming process, it is difficult for the solution for forming the alignment film 11e to enter the portion where each of the contact holes 26 and 33 is formed to have the depressed shape in the array board 11b, resulting in that the film-deficient portion is easily formed in the alignment film 11e. The planar arrangement of the film-deficient portion substantially coincides with the contact holes 26 and 33 and has regularity. Accordingly, moire may be caused. In particular, the liquid crystal panel 11 with the definition enhanced by the use of the oxide semiconductor as the semiconductor film 36 of the TFT 17 may have a larger number of contact holes, and additionally, the space between the adjacent contact holes may be smaller because one pixel has a smaller area. Accordingly, the moire is more likely to occur. In conventional configuration, the contact holes are arranged irregularly. In this configuration, each contact hole cannot be arranged beyond an area of the pixel that includes the contact hole. Namely, a distance between the adjacent contact holes cannot be larger than a certain distance. Accordingly, moire reducing effect is limited.

In this embodiment, at least a portion of the edge of each of the contact holes 26 and 33 of the insulators 35, 37, 39, 40, and 41 includes a bending portion 43 that toward an inner side of the contact hole 26 or 33 such that an outer angle of the bending portion 43 is a reflex angle in a plan view as illustrated in FIGS. 5 and 8. The “reflex angle” herein refers to an angle in the range from 180° to 360°. Because the edge of each of the contact holes 26 and 33 includes the bending portion 43, when the solution for forming the alignment film 11e supplied to the outside of the contact holes 26 and 33 spreads into the contact holes 26 and 33 and reaches the bending portion 43, the solution is drawn into the contact holes 26 and 33 by the bending portion 43. The reason why the solution is drawn to the contact holes 26 and 33 may be that a force may be exerted on the solution to spread in a wide angle toward the inside of the contact holes 26 and 33 due to the bending portion 43 that has the reflected outer angle when the solution reaches the bending portion 43. According to the configuration, it is easier to arrange the alignment film 11e inside the contact holes 26 and 33 and defects are less likely to be developed in the alignment film 11e. Accordingly, effect to reduce or suppress the moire is obtained. A shape of the contact holes 26 and 33 in a plan view will be described in detail.

The lower contact hole 30 included in the display area side contact hole 26 includes, as illustrated in FIG. 8, a contact hole main portion 30a overlapping at least a portion of the drain electrode 17c formed from the second metal film 38 and the pixel electrode 18 formed from the second transparent electrode film 24 in a plan view, and an expanded hole portion 30b formed by extending a portion of the contact hole main portion 30a. The contact hole main portion 30a and the expanded hole portion 30b of the lower contact hole 30 have a vertically-long rectangular shape (rectangular shape) in a plan view, and a length direction (long dimension) coincides with the Y-axis direction and a width direction (short dimension) coincides with the X-axis direction. Of the contact hole main portion 30a, a little more than a half of the upper side in FIG. 8 (opposite to the auxiliary capacitor line 25 side overlapping the capacitance formation portion 29a of the drain line 29 in a plan view) overlaps the drain electrode 17c and the pixel electrode 18 in a plan view and a little less than a half of the lower side in the drawing (the auxiliary capacitor line 25 side overlapping the capacitance formation portion 29a of the drain line 29 in a plan view) does not overlap the drain electrode 17c and the pixel electrode 18 in a plan view. Therefore, a little more than a half portion on the upper side in FIG. 8 of the contact hole main portion 30a can contribute to the connection between the drain electrode 17c and the pixel electrode 18. Furthermore, the lower end in FIG. 8 of the contact hole main portion 30a does not overlap the gate line 19 in a plan view. The width of the contact hole main portion 30a is set to be larger than the line width of the drain line 29. In the lower end of the contact hole main portion 30a in FIG. 8, the central portion in the width direction (X-axis direction) overlaps the drain line 29 in a plan view but both side portions in the width direction (including both corners) do not overlap the drain line 29 in a plan view.

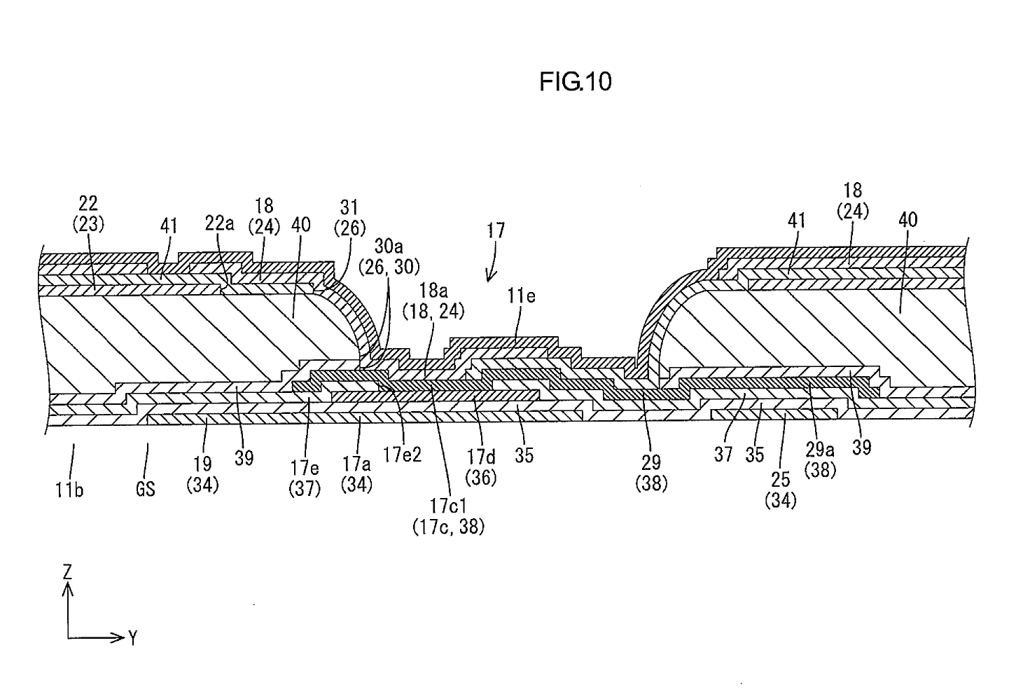

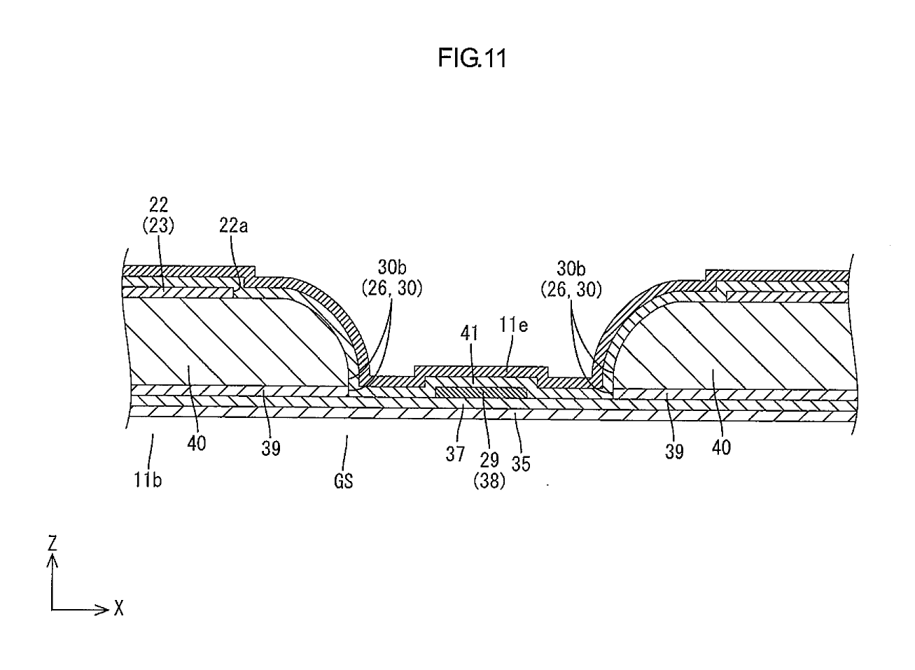

On the other hand, the expanded hole portion 30b is formed by extending a portion of the contact hole main portion 30a that is relatively far from the center of the pixel electrode 18 as illustrated in FIG. 7, more specifically extending a corner of the contact hole main portion 30a that does not overlap the pixel electrode 18 in a plan view. A pair of expanded hole portions 30b is formed at the symmetric position as illustrated in FIG. 8 by extending a pair of corners of the contact hole main portion 30a that does not overlap the pixel electrode 18 in a plan view. The expanded hole portion 30b does not overlap the pixel electrode 18 in a plan view and does not overlap the drain electrode 17c and the drain line 29 in a plan view. In addition, the expanded hole portion 30b does not overlap the gate electrode 17a, the gate line 19, and the auxiliary capacitor line 25 formed from the first metal film 34 in a plan view. Therefore, as illustrated in FIGS. 10 and 11, the bottom of the expanded hole portion 30b is lower than the portion of the contact hole main portion 30a that overlaps the drain line 29 in a plan view by the film thickness of the drain line 29b, and moreover, the bottom of the expanded hole portion 30b is lower than the portion of the contact hole main portion 30a that overlaps the drain electrode 17c in a plan view by the total film thickness of the gate electrode 17a, the drain electrode 17c, and the pixel electrode 18. Moreover, the expanded hole portion 30b is located between the gate line 19 and the auxiliary capacitor line 25 in a plan view as illustrated in FIG. 8, thereby forming a valley.

Moreover, as illustrated in FIG. 8, edges 43a and 43b communicating with each other at the contact hole main portion 30a and the expanded hole portion 30b constituting the lower contact hole 30 form the bending portions 43 as described above. Specifically, a first edge 43a of the edges of the contact hole main portion 30a, which extends along the length direction (Y-axis direction), and a second opening edge 43b of the edges of the expanded hole portion 30b, which extends along the width direction (X-axis direction) and which is adjacent to the first edge 43a, communicate with each other. The angle 8 formed therebetween at their apex (intersection) on the inside of the lower contact hole 30 in a plan view is approximately 270°, a reflex angle, and these first edge 43a and second edge 43b constitute the bending portion 43. In other words, the first edge 43a forming the bending portion 43 intersects with the second edge 43b so as to forma reflex angle on the inside, namely, form a minor angle (approximately 90°) on the outside with the second edge 43b. Additionally, the expanded hole portion 30b is formed to have a smaller opening width than the contact hole main portion 30a. Specifically, the maximum value (length) of the opening width of the expanded hole portion 30b is smaller than the minimum value (width) of the opening width of the contact hole main portion 30a. Note that the opening width of each of the contact hole main portion 30a and the expanded hole portion 30b is defined by the distance between a pair of opposite edges.

As illustrated in FIG. 8, the upper contact hole 31 of the display area side contact hole 26 has a horizontally-long rectangular shape in a plan view, and the length direction (long dimension) coincides with the X-axis direction and the width direction (short dimension) coincides with the Y-axis direction. The upper contact hole 31 is disposed partially overlapping the contact hole main portion 30a of the lower contact hole 30, specifically overlapping an upper end of the contact hole main portion 30a in FIG. 8, i.e., the end opposite to the expanded hole portion 30b in a plan view. Therefore, the upper contact hole 31 is disposed not overlapping the expanded hole portion 30b of the lower contact hole 30 in a plan view. The pixel electrode 18 is connected to the drain electrode 17c through the portion where the upper contact hole 31 overlaps the lower contact hole 30 (contact hole main portion 30a). In other words, the portions of the upper contact hole 31 and the lower contact hole 30 that do not overlap each other do not contribute to the connection between the pixel electrode 18 and the drain electrode 17c.

Next, the planar shape of the non-display area side contact hole 33 will be described. The non-display area side contact hole 33 includes, as illustrated in FIG. 5, a contact hole main portion 33a overlapping the gate line side connector 19a of the gate line 19 formed from the first metal film 34 and the connection line side connector 32a of the connection line 32 formed from the second metal film 38 in a plan view, and an expanded hole portion 33b formed by extending a portion of the contact hole main portion 33a. The contact hole main portion 33a and the expanded hole portion 33b of the non-display area side contact hole 33 have a vertically-long rectangular shape (rectangular shape) in a plan view, and the length direction (long dimension) coincides with the Y-axis direction and the width direction (short dimension) coincides with the X-axis direction. These contact hole main portion 33a and expanded hole portions 33b entirely overlap the gate line side connector 19a and the connection line side connector 32a in a plan view. The expanded hole portions 33b are formed at the symmetrical position by extending a pair of lower corners of the contact hole main portion 33a in FIG. 5. The bending portion 43 is formed by the communicating edges of the contact hole main portion 33a and the expanded hole portion 33b of the non-display area side contact hole 33. Since the configuration of the bending portion 43 formed at the edge of the non-display area side contact hole 33 is similar to that of the bending portion 43 formed at the edge of the lower contact hole 30, the description is not repeated.

This embodiment has the above configuration, and next the operation thereof will be described. The procedure of producing components on the array board 11b of the liquid crystal panel 11 will be described in detail.

Components are sequentially formed on the array board 11b by a known photolithography method. Specifically, first, the first metal film 34 is formed on the surface of the array board 11b and patterned, thereby forming the gate electrode 17a, the gate line 19, the auxiliary capacitor line 25, and the like as illustrated in FIG. 8. After that, the gate insulator 35 is formed and patterned, thereby forming the lower part of the non-display area side contact hole 33 (see FIG. 5). Next, the semiconductor film 36 is formed and patterned to form the channel 17d and the like and then, the protection film 37 is formed and patterned, so that the protection portion 17e having openings 17e1 and 17e2 is formed and the upper part of the non-display area side contact hole 33 is formed. In the process of forming the gate insulator 35 and the protection film 37 (first film forming process), along with the formation of the non-display area side contact hole 33, the bending portion 43 corresponding to a portion of the edges is also formed.

After that, the second metal film 38 is formed and patterned, thereby forming the source electrode 17b, the drain electrode 17c, the source line 20, the drain line 29, the connection line 32, and the like. Of the connection line 32 formed at this time, the connection line side connector 32a is connected to the gate line side connector 19a of the gate line 19 on the lower side through the non-display area side contact hole 33 provided for the gate insulator 35 and the protection film 37 (see FIG. 6). After that, the first interlayer insulator 39 and the organic insulator 40 are formed and patterned, thereby forming the lower contact hole 30 that forms the display area side contact hole 26. In the process of forming the first interlayer insulator 39 and the organic insulator 40 (first film forming process), along with the formation of the lower contact hole 30, the bending portion 43 corresponding to a portion of the edges thereof is also formed. When the organic insulator 40 is formed in the process of forming the first interlayer insulator 39 and the organic insulator 40, the opening is patterned in the organic insulator 40 using a mask and the organic insulator 40 having the opening is used as a resist to etch the first interlayer insulator 39 on the lower side. Thus, the first interlayer insulator 39 having the opening communicating to the opening of the organic insulator 40 can be formed and therefore the lower contact hole 30 is formed.

Then, the first transparent electrode film 23 is formed and patterned, thereby forming the common electrode 22 with the opening 22a. After that, the second interlayer insulator 41 is formed and patterned, thereby forming the upper contact hole 31 forming the display area side contact hole 26 so as to communicate to a portion of the lower contact hole 30. Next, the second transparent electrode film 24 is formed and patterned, thereby forming the pixel electrode 18 with the slit 18a. Of the pixel electrode 18 formed at this time, the pixel electrode side connector 18b is connected to the drain electrode side connector 17c1 of the drain electrode 17c on the lower side through the display area side contact hole 26 (see FIGS. 9 and 10). After that, the alignment film 11e is formed (see FIG. 9 to FIG. 11). In the process of forming the alignment film 11e (second film forming process), the inkjet device 42 as below is used.

The inkjet device 42 used in the formation of the alignment film 11e includes, as illustrated in FIG. 12, at least a base stand 42a, a stage 42b which is disposed on the base stand 42a and on which the array board 11b is mounted, and a nozzle head 42c disposed on the base stand 42a and disposed opposite to the stage 42b with the array board 11b interposed between the stage 42b and the nozzle head 42c. The solution for forming the alignment film 11e is supplied to the nozzle head 42c from a supply tank, which is not illustrated, and the nozzle head 42c is provided with a number of nozzles (discharge ports) 42d configured to discharge droplets LD of the solution arranged in parallel intermittently at substantially equal intervals along the X-axis direction. The stage 42b is configured to move in the X-axis direction and the Y-axis direction relative to the nozzle head 42c on the base stand 42a. The nozzle head 42c is configured to move in the Z-axis direction relative to the stage 42b on the base stand 42a.

In the process of forming the alignment film 11e (second film forming process), as illustrated in FIG. 12, the array board 11b is mounted on the stage 42b in the inkjet device 42 with the above configuration, and the array board 11b is aligned relative to the nozzle head 42c by moving the stage 42b in the X-axis direction and the Y-axis direction and the nozzle head 42c is moved in the Z-axis direction to be disposed close to the array board 11b with a predetermined space from the array board 11b. Then, the droplets LD of the solution for forming the alignment film 11e are intermittently discharged from the nozzles 42d of the nozzle head 42c while the stage 42b is moved in the Y-axis direction so that the array board 11b crosses the nozzle head 42c. After the droplet LD of the solution discharged out of the nozzle 42d reaches a predetermined position on an inner surface of the array board 11b, the droplet LD spreads on the plate surface and connects to the adjacent droplet LD. Thus, the solution for forming the alignment film 11e is applied without unevenness to the entire region of the array board 11b (the portion overlapping the contact holes 30 and 33 in a plan view and the portion not overlapping the contact holes 30 and 33 in a plan view). After that, the applied solution for forming the alignment film 11e is dried and subjected to an optical alignment process (alignment process), thereby forming the alignment film 11e.

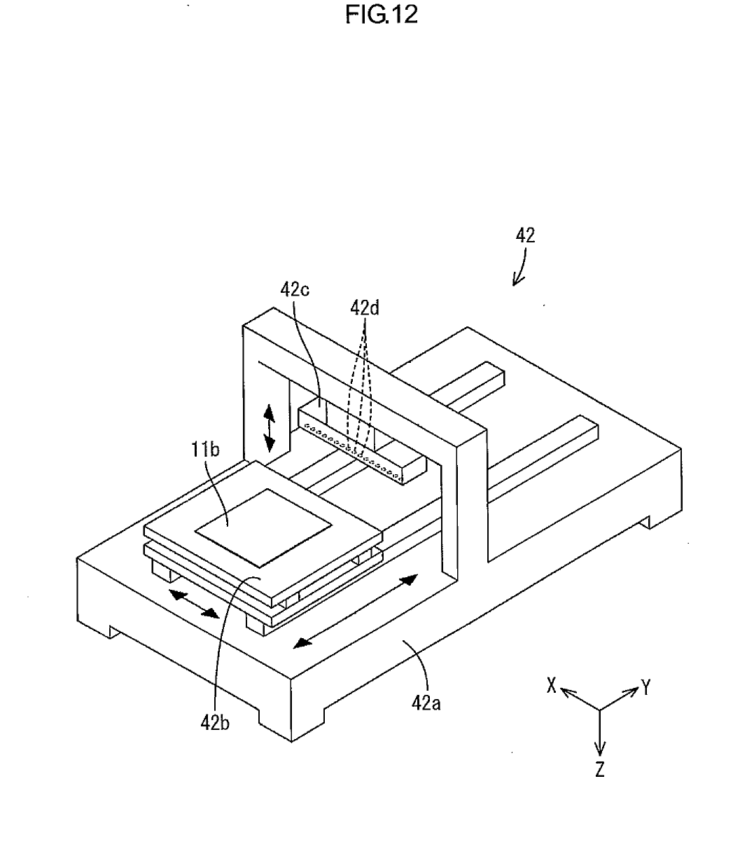

Here, the droplets LD of the solution for forming the alignment film 11e having reached the portion of the surface of the array board 11b which corresponds to the portion not overlapping the contact holes 30 and 33 with the bending portions 43 in a plan view spread to the inside of the contact holes 30 and 33 with the bending portions 43. In this case, upon the reach of the droplets LD at the bending portions 43 in the edges of the contact holes 30 and 33, the droplets LD are drawn into the contact holes 30 and 33 by the bending portions 43 as illustrated in FIG. 13 and moved in, for example, a direction indicated by an arrow in the drawing. Note that the droplet LD is illustrated by a two-dot chain line in FIG. 13. The reason why the droplet LD is drawn into the contact holes 30 and 33 is as follows: for example, upon the reach of the droplet LD at the bending portion 43, a force operates to cause the bending portion 43 forming the reflex angle on the inside in a plan view to spread the droplet LD in a wide angle toward the contact hole main portions 30a and 33a side and the expanded hole portions 30b and 33b side, thereby decreasing the surface tension of the droplet LD. This is considered reasonable because if the droplet LD has reached the corner with a right angle, i.e., a minor angle on the inside in a plan view at the edges of the contact holes 30 and 33, the force operates to cause the droplet LD to fall within the space held between the pair of edges constituting the corner, so that the surface tension of the droplet LD becomes relatively larger than in the above case; therefore, it is difficult for the droplet LD to enter the contact holes 30 and 33. According to the configuration, the alignment film 11e is easily formed also in the portion of the array board 11b that overlaps the contact holes 30 and 33 in a plan view. Therefore, the defects are less likely to be developed in the alignment film 11e and the moire is properly reduced or suppressed.

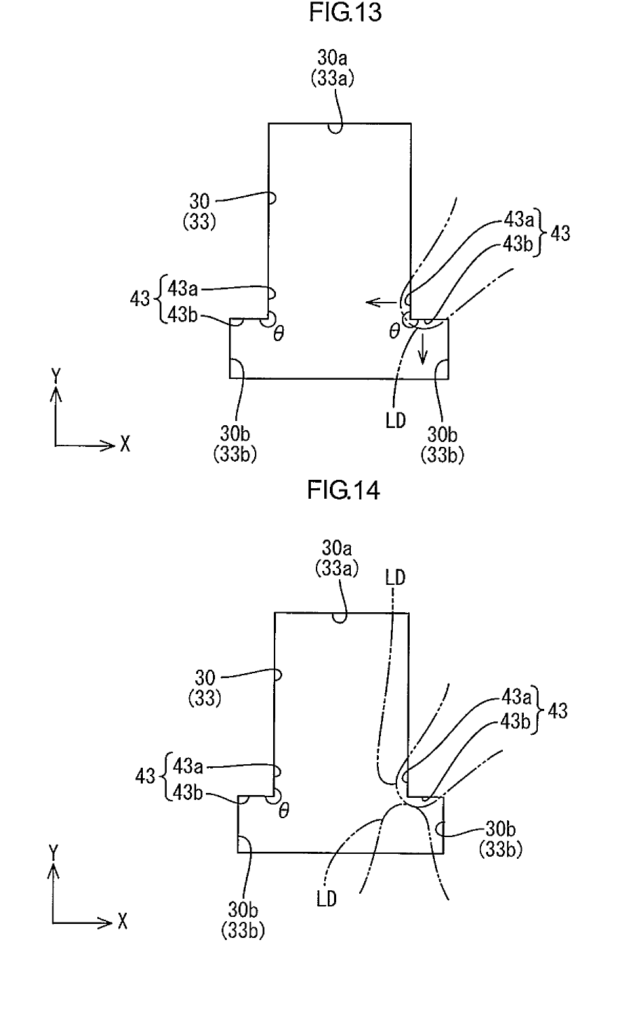

In addition, the contact holes 30 and 33 with the bending portions 43 have the expanded hole portions 30b and 33b formed by extending a portion of the contact hole main portions 30a and 33a. The bending portions 43 are formed by the communicating edges 43a and 43b at the contact hole main portions 30a and 33a and the expanded hole portions 30b and 33b, and the opening width of the expanded hole portions 30b and 33b is smaller than that of the contact hole main portions 30a and 33a, whereby the operation and effect as below can be obtained. Namely, when the droplets LD of the solution for forming the alignment film 11e have reached both the pair of opposite edges at the expanded hole portions 30b and 33b of the contact holes 30 and 33 as illustrated in FIG. 14 in the formation of the alignment film 11e, the droplets LD having reached the both edges are connected more easily than on the contact hole main portions 30a and 33a side. In this case, the connected droplets LD flow to make the surface area small due to the surface tension, enabling the droplets LD to flow into the contact holes 30 and 33 easily. Note that the droplet LD is illustrated by a two-dot chain line in FIG. 14. The second edge 43b of the expanded hole portions 30b and 33b connected to the first edge 43a of the contact hole main portions 30a and 33a forms the bending portion 43. Therefore, in combination with the easy flow of the droplet LD that forms the alignment film 11e into the contact holes 30 and 33 due to the bending portion 43, the droplet LD that forms the alignment film 11e can flow into the contact holes 30 and 33 more easily. According to the configuration, the alignment film 11e is more easily arranged in the portion overlapping the contact holes 30 and 33 in a plan view. Therefore, the defects are less likely to be developed in the alignment film 11e.

In consideration of the fact that the use of the transparent electrode material as the pixel electrode 18 reduces the fluidity of the droplet LD that forms the alignment film 11e on the pixel electrode 18, the expanded hole portion 30b of the lower contact hole 30 is disposed not overlapping the pixel electrode 18 in a plan view as illustrated in FIG. 8, so that the droplet LD easily flows into the expanded hole portion 30b. In combination with the easy flow of the solution for forming the alignment film 11e into the contact hole 30 because of the bending portion 43, the solution for forming the alignment film 11e can flow into the contact hole 30 more easily. Therefore, the defects are less likely to occur in the alignment film 11e and the moire is more effectively suppressed.

As illustrated in FIG. 8, the expanded hole portion 30b of the lower contact hole 30 is disposed not overlapping the drain electrode 17c formed from the second metal film 38, and the gate electrode 17a, the gate line 19, and the auxiliary capacitor line 25 formed from the first metal film 34 in a plan view. Therefore, as compared to the contact hole main portion 30a overlapping the drain electrode 17c, the gate electrode 17a, and the gate line 19 in a plan view, the opening depth, i.e., the gap from the surface of the pixel electrode 18 and the like to which the droplet LD that forms the alignment film 11e is supplied is larger by the total film thicknesses of the first metal film 34 and the second metal film 38. According to the configuration, the droplet LD for forming the alignment film 11e flow into the expanded hole portion 30b more easily. Therefore, the defects are less likely to be developed in the alignment film 11e and the moire is suppressed more effectively.

In this manner, the alignment film 11e is formed to the solid trace in the plate surface of the array board 11b in and out of the contact holes 30 and 33. The expanded hole portion 30b of the lower contact hole 30 is formed by extending the portion of the contact hole main portion 30a that is relatively far from the center of the pixel electrode 18 in a plan view, specifically the corner at the farthest position from the pixel electrode 18 as illustrated in FIG. 8. Therefore, even though the aligning function cannot be sufficiently exhibited because the portion of the alignment film 11e disposed inside the lower contact hole 30, particularly the expanded hole portion 30b forms the depressed shape relative to the surrounding, it is difficult for the defective alignment that may be caused by the expanded hole portion 30b to affect the display of the pixel electrode 18. As a result, the deterioration in display quality that may be caused by the expanded hole portion 30b is suppressed. The expanded hole portion 30b in the lower contact hole 30 is disposed not overlapping the pixel electrode 18 in a plan view. Therefore, even though the aligning function cannot be sufficiently exhibited because the portion of the alignment film 11e that is disposed inside the lower contact hole 30, particularly the expanded hole portion 30b forms the depressed shape relative to the surrounding, it is difficult for the defective alignment that may be caused by the expanded hole portion 30b to affect the display of the pixel electrode 18. As a result, the deterioration in display quality that may be caused by the expanded hole portion 30b is suppressed.

As described above, the array board (display component) 11b according to this embodiment includes: the second metal film 38 or the first metal film 34 as the first conductive film; the second transparent electrode film 24 or the second metal film 38 as the second conductive film, which is disposed above the second metal film 38 or the first metal film 34 as the first conductive film and which has at least a part thereof overlapping in a plan view the second metal film 38 or the first metal film 34 as the first conductive film; the first interlayer insulator 39 and the organic insulator 40 or the gate insulator 35 and the protection film 37, which correspond to the insulator disposed between the first conductive film (second metal film 38 or first metal film 34) and the second conductive film (second transparent electrode film 24 or second metal film 38) and has the lower contact hole 30 or the non-display area side contact hole 33 opened at the position overlapping the first conductive film (second metal film 38 or first metal film 34) and the second conductive film (second transparent electrode film 24 or second metal film 38) in a plan view for connecting the second conductive film (second transparent electrode film 24 or second metal film 38) to the first conductive film (second metal film 38 or first metal film 34); the alignment film 11e disposed above the second conductive film (second transparent electrode film 24 or second metal film 38) and having the portion overlapping the contact hole (lower contact hole 30 or non-display area side contact hole 33) in a plan view and the portion not overlapping the contact hole (lower contact hole 30 or non-display area side contact hole 33) in a plan view; and the bending portion 43 which is curved to form a reflex angle on the inside in a plan view and which is configured by at least a portion of the edges of the contact hole (lower contact hole 30 or non-display area side contact hole 33) in the insulator (first interlayer insulator 39 and organic insulator 40, or gate insulator 35 and protection film 37).

Thus, the second conductive film (second transparent electrode film 24 or second metal film 38) formed after the first conductive film (second metal film 38 or first metal film 34) and the insulator (first interlayer insulator 39 and organic insulator 40, or gate insulator 35 and protection film 37) is connected to the first conductive film (second metal film 38 or first metal film 34) on the lower side through the contact hole (lower contact hole 30 or non-display area side contact hole 33) in the insulator (first interlayer insulator 39 and organic insulator 40, or gate insulator 35 and protection film 37). In the formation of the alignment film 11e above the first conductive film (second metal film 38 or first metal film 34), when the solution for forming the alignment film 11e is locally supplied to the surface of the second conductive film (second transparent electrode film 24 or second metal film 38) and the like, the solution spreads to the outside of the contact hole (lower contact hole 30 or non-display area side contact hole 33) and to the inside of the contact hole (lower contact hole 30 or non-display area side contact hole 33). Thus, the alignment film 11e having the portion overlapping the contact hole (lower contact hole 30 or non-display area side contact hole 33) and the portion not overlapping the contact hole (lower contact hole 30 or non-display area side contact hole 33) is formed. Here, in the case where the solution for forming the alignment film 11e supplied to the outside of the contact hole (lower contact hole 30 or non-display area side contact hole 33) spreads to the inside of the contact hole (lower contact hole 30 or non-display area side contact hole 33), when the solution reaches the bending portion 43 curved to form the reflex angle on the inside in a plan view at the edges of the contact hole (lower contact hole 30 or non-display area side contact hole 33), the solution is moved to be drawn to the inside of the contact hole (lower contact hole 30 or non-display area side contact hole 33) by the bending portion 43. It is supposed that the solution is drawn because, for example, if the solution has reached the bending portion 43, the bending portion 43 forming the reflex angle on the inside in a plan view produces a force that causes the solution to spread in a wide angle. According to the configuration, the alignment film 11e is easily arranged inside the contact hole (lower contact hole 30 or non-display area side contact hole 33). Therefore, the defects are less likely to be developed in the alignment film 11e and the moire is properly reduced or suppressed.

The insulator (first interlayer insulator 39 and organic insulator 40, or gate insulator 35 and protection film 37) is formed such that the contact hole (lower contact hole 30 or non-display area side contact hole 33) includes the contact hole main portions 30a and 33a, which overlap at least a portion of the first conductive film (second metal film 38 or first metal film 34) and the second conductive film (second transparent electrode film 24 or second metal film 38) in a plan view and the expanded hole portions 30b and 33b formed by extending a portion of the contact hole main portions 30a and 33a. The bending portions 43 are formed by the communicating edges 43a and 43b at the contact hole main portions 30a and 33a and the expanded hole portions 30b and 33b. The expanded hole portions 30b and 33b have a smaller opening width than the contact hole main portions 30a and 33a. First, the opening width of the expanded hole portions 30b and 33b and the opening width of the contact hole main portions 30a and 33a are defined by the distance between the pair of edges opposite to each other. In the formation of the alignment film 11e, when the solution for forming the alignment film 11e has reached both the pair of edges opposite to each other at the expanded hole portions 30b and 33b in the contact hole main portions 30a and 33a, the solution having reached the edges is easily connected as compared to the contact hole main portions 30a and 33a side. When the solution is connected, the solution flows to have the smaller surface area due to the surface tension, thereby enabling the solution to flow into the contact hole (lower contact hole 30 or non-display area side contact hole 33) easily. Moreover, the bending portion 43 is formed by the second edge 43b of the expanded hole portions 30b and 33b communicating to the first edge 43a of the contact hole main portions 30a and 33a. Therefore, in combination with the easy flow of the solution for forming the alignment film 11e into the contact hole (lower contact hole 30 or non-display area side contact hole 33) due to the bending portion 43, the solution for forming the alignment film 11e can flow into the contact hole (lower contact hole 30 or non-display area side contact hole 33) more easily. According to the configuration, the alignment film 11e is more easily disposed in the portion overlapping the contact hole (lower contact hole 30 or non-display area side contact hole 33) in a plan view. Therefore, the defects are less likely to be developed in the alignment film 11e.

The second transparent electrode film 24 as the second conductive film forms the pixel electrode 18 made of the transparent electrode material. In the first interlayer insulator 39 and the organic insulator 40 as the insulator, the expanded hole portion 30b is formed by extending a portion of the contact hole main portion 30a that is relatively far from the center of the pixel electrode 18 in a plan view. The portion of the alignment film 11e that overlaps the contact hole main portion 30a in a plan view is formed to have a depressed shape relative to the non-overlapping portion. Therefore, the aligning function cannot be sufficiently exhibited in some cases, and this tendency is remarkable in the expanded hole portion 30b formed by extending the contact hole main portion 30a. In this regard, the expanded hole portion 30b is formed by extending a portion of the contact hole main portion 30a that is relatively far from the center of the pixel electrode 18 in a plan view; therefore, it is difficult for the defective alignment that may be caused by the expanded hole portion 30b to affect the display of the pixel electrode 18. As a result, the deterioration in display quality caused by the expanded hole portion 30b is suppressed.

In the first interlayer insulator 39 and the organic insulator 40 as the insulator, the expanded hole portion 30b is formed by extending a corner of the contact hole main portion 30a. Thus, the expanded hole portion 30b is formed as far from the pixel electrode 18 as possible in the contact hole main portion 30a; therefore, it is difficult for the defective alignment that may be caused by the expanded hole portion 30b to affect the display of the pixel electrode 18.

The second transparent electrode film 24 as the second conductive film forms the pixel electrode 18 made of the transparent electrode material. In the first interlayer insulator 39 and the organic insulator 40 as the insulator, the expanded hole portion 30b is disposed not overlapping the pixel electrode 18 in a plan view. The portion of the alignment film 11e that overlaps the lower contact hole 30 as the contact hole in a plan view is formed to have a depressed shape relative to the non-overlapped portion. Therefore, the aligning function cannot be sufficiently exhibited in some cases, and this tendency is remarkable in the expanded hole portion 30b formed by extending the contact hole main portion 30a. In this regard, the expanded hole portion 30b is formed not overlapping the pixel electrode 18 in a plan view; therefore, it is difficult for the defective alignment that may be caused by the expanded hole portion 30b to affect the display of the pixel electrode 18. As a result, the deterioration in display quality that may be caused by the expanded hole portion 30b is suppressed. When the transparent electrode material is employed as the material of the pixel electrode 18, the fluidity of the solution for forming the alignment film 11e on the pixel electrode 18 may become lower. However, the fluidity of the solution toward the expanded hole portion 30b can be maintained high by having the expanded hole portion 30b, which has the bending portion 43 for enabling the solution for forming the alignment film 11e to flow into the lower contact hole 30 easily, not overlap the pixel electrode 18 in a plan view. This enables the solution for forming the alignment film 11e to flow into the lower contact hole 30 more easily.

In the first interlayer insulator 39 and the organic insulator 40 as the insulator, the expanded hole portion 30b is disposed not overlapping the second metal film 38 as the first conductive film in a plan view. Thus, since the expanded hole portion 30b does not overlap the second metal film 38 as the first conductive film in a plan view, the opening depth, i.e., the gap from the surface of the second transparent electrode film 24 as the second conductive film to which the solution for forming the alignment film 11e is supplied can be set larger as compared to the contact hole main portion 30a. Therefore, the solution for forming the alignment film 11e flows into the expanded hole portion 30b more easily.

The first metal film 34 as the third conductive film, which is disposed below the second metal film 38 as the first conductive film and at least a portion of which overlaps the second metal film 38 as the first conductive film is provided. In the first interlayer insulator 39 and the organic insulator 40 as the insulator, at least a portion of the contact hole main portion 30a overlaps the first metal film 34 as the third conductive film in a plan view and the expanded hole portion 30b is provided not overlapping the first metal film 34 as the third conductive film in a plan view. Thus, since the expanded hole portion 30b does not overlap the first metal film 34 as the third conductive film in a plan view, the opening depth, i.e., the gap from the surface of the second transparent electrode film 24 as the second conductive film to which the solution for forming the alignment film 11e is supplied can be set larger as compared to the contact hole main portion 30a. Therefore, the solution for forming the alignment film 11e flows into the expanded hole portion 30b more easily.

The second metal film 38 as the first conductive film forms at least the source electrode 17b and the drain electrode 17c. On the other hand, the first metal film 34 as the third conductive film forms at least the gate electrode 17a, which overlaps the source electrode 17b and the drain electrode 17c in a plan view, and the auxiliary capacitor line 25, which is disposed apart from the gate electrode 17a in a plan view. In the first interlayer insulator 39 and the organic insulator 40 as the insulator, at least a portion of the contact hole main portion 30a is disposed overlapping the drain electrode 17c and the gate electrode 17a in a plan view and the expanded hole portion 30b is held between the gate electrode 17a and the auxiliary capacitor line 25 in a plan view. Thus, the expanded hole portion 30b is held between the gate electrode 17a and the auxiliary capacitor line 25 in a plan view, so that the valley is formed on the surface of the second transparent electrode film 24 as the second conductive film and the like to which the solution for forming the alignment film 11e is supplied. Therefore, on the surface of the second transparent electrode film 24 as the second conductive film and the like, the solution for forming the alignment film 11e flows more easily into the expanded hole portion 30b from the portion overlapping the gate electrode 17a and the auxiliary capacitor line 25 in a plan view.

Moreover provided are the first metal film 34 as the third conductive film, which is disposed below the second metal film 38 as the first conductive film and at least a portion of which overlaps the second metal film 38 as the first conductive film in a plan view, and the semiconductor film 36 held between the first metal film 34 as the third conductive film and the second metal film 38 as the first conductive film. The second metal film 38 as the first conductive film forms at least the source electrode 17b and the drain electrode 17c. The first metal film 34 as the third conductive film forms at least the gate electrode 17a that overlaps the source electrode 17b and the drain electrode 17c in a plan view. The semiconductor film 36 is made of the oxide semiconductor and forms the channel 17d to be connected to the source electrode 17b and the drain electrode 17c. Upon the application of the voltage to the gate electrode 17a, current flows between the source electrode 17b and the drain electrode 17c through the channel 17d formed from the oxide semiconductor film. The oxide semiconductor film has higher electron mobility than the amorphous silicon thin film or the like, and therefore sufficient current can be supplied between the source electrode 17b and the drain electrode 17c even though the channel 17d has a smaller width. Because the width of the channel 17d is reduced, sizes of the source electrode 17b, the drain electrode 17c, and the gate electrode 17a can be reduced. The reduction in sizes of the electrodes 17a, 17b, and 17c is preferable for configuring the array board 11b to improve the definition. The array board 11b configured to improve the definition may have the higher number of the contact holes (the lower contact holes 30 and the non-display area side contact holes 33). Therefore, defects are more likely to be developed in the alignment film 11e. Each of the contact holes (the lower contact holes 30 and the non-display area side contact holes 33) in the insulators (the first interlayer insulator 39, the organic insulator 40, the gate insulator 35, and the protection film 37) includes the bending portion 43 that bends toward the inner side of the contact hole and has the reflex outer angle in a plan view at the edge of the contact hole. According to the configuration, the solution for forming the alignment film 11e more easily enters the contact holes (the lower contact holes 30 and the non-display area side contact holes 33). Therefore, the defects are less likely to be developed in the alignment film 11e.

The liquid crystal panel (display device) 11 according to this embodiment includes the aforementioned array board 11b, the CF board (opposite substrate) 11a disposed opposite to the array board 11b, and the liquid crystal layer (liquid crystal) 11c disposed between the array board 11b and the CF board 11a. In the liquid crystal panel 11, the defects are less likely to be developed in the alignment film 11e of the array board 11b and the moire is properly reduced or suppressed. As a result, the alignment of the liquid crystal layer 11c is properly performed and high display quality is achieved.

A method of producing the array board 11b according to this embodiment includes a first film forming process and a second film forming process. The first film forming process is for forming the first conductive film (second metal film 38 or first metal film 34), the insulator (first interlayer insulator 39 and organic insulator 40 or gate insulator 35 and protection film 37), and the second conductive film (second transparent electrode film 24 or second metal film 38) in this sequence on the glass substrate (substrate) GS. Furthermore, the first film forming process is for forming the contact holes (lower contact holes 30 and non-display area side contact holes 33) in the insulators (the first interlayer insulator 39, the organic insulator 40, the gate insulator 35, and the protection film 37) at the positions overlapping the first conductive films (the second metal film 38 and the first metal film 34) and the second conductive films (the second transparent electrode film 24 an the second metal film 38) in a plan view. The contact holes are for connecting the second conductive films (the second transparent electrode film 24 and the second metal film 38) to the first conductive films (the second metal film 38 and the first metal film 34). Furthermore, the first film-forming process is for forming the bending portions 43 at the portions of the edges of the respective contact holes (the lower contact holes 30 and the non-display area side contact holes 33) so as to bend toward the inner side of the respective contact holes and have the reflex outer angles. The second film forming process is for forming the alignment film 11e having the portions overlapping the contact holes (the lower contact holes 30 and the non-display area side contact holes 33) and the portions not overlapping the contact holes (the lower contact holes 30 and the non-display area side contact holes 33) in a plan view above the second conductive films (the second transparent electrode film 24 and the second metal film 38).

In the first film forming process, the first conductive films (the second metal film 38 and the first metal film 34) and the insulators (the first interlayer insulator 39, the organic insulator 40, the gate insulator 35, and the protection film 37) are formed on the glass substrate GS, and then, the second conductive films (the second transparent electrode film 24 and the second metal film 38) are formed on the glass substrate GS. The second conductive films (the second transparent electrode film 24 and the second metal film 38) are connected to the first conductive films (the second metal film 38 and the first metal film 34) on the lower side via the contact holes (the lower contact holes 30 and the non-display area side contact holes 33) formed in the insulators (the first interlayer insulator 39, the organic insulator 40, the gate insulator 35, and the protection film 37). In the second film forming process performed after the first film forming process, the solution for forming the alignment film 11e is locally supplied to the surfaces of the second conductive films (the second transparent electrode film 24 and the second metal film 38) for forming the alignment film 11e above the first conductive films (the second metal film 38 and the first metal film 34). The solution spreads to the areas outside and inside the contact holes (the lower contact holes 30 and the non-display area side contact holes 33). As a result, the alignment film 11e is formed. The alignment film 11e includes the portions overlapping the contact holes (the lower contact holes 30 and the non-display area side contact holes 33) and the portions not overlapping the contact holes (the lower contact holes 30 and the non-display area side contact holes 33) in a plan view. When the solution for forming the alignment film 11e supplied to the areas outside of the contact holes (the lower contact holes 30 and the non-display area side contact holes 33) spreads to the areas inside the contact holes (the lower contact holes 30 and the non-display area side contact holes 33), the solution may reach the bending portions 43 each of which bends toward the inner side of the corresponding contact hole and has the reflex outer angle in a plan view the edges of the respective contact holes (the lower contact hole 30 and the non-display area side contact holes 33). When reaches any of the pending portions 43, the solution is drawn to the inner side of each contact hole (the lower contact hole 30 or the non-display area side contact hole 33) by the bending portion 43. that the reason why the solution is drawn as described above may be that a force to spread the solution in a wide angle is exerted on the solution by the bending portions 43 each of which bends toward the inner side of the corresponding contact hole and has the reflex outer angle. According to the configuration, the alignment film 11e is easily arranged inside the contact holes (the lower contact holes 30 and the non-display area side contact holes 33). Therefore, defects are less likely to be developed in the alignment film 11e and the moire is properly reduced or suppressed.

In the second film forming process, the inkjet device 42 is used. The solution for forming the alignment film 11e is discharged from the nozzles 42d of the inkjet device 42 onto the second conductive films (the second transparent electrode film 24 and the second metal film 38). The solution discharged from the nozzles 42d of the inkjet device 42 and landed on the second conductive films (the second transparent electrode film 24 and the second metal film 38) in the second film forming process spreads over the surfaces. The arrangement of the nozzles 42d of the inkjet device 42 and the arrangement of the contact holes (the lower contact holes 30 or the non-display area side contact holes 33) may overlap each other. If the solution for forming the alignment film 11e, which has been discharged from the plurality of nozzles 42d, does not sufficiently spread, the moire may occur. In this embodiment, the edges of the contact holes (the lower contact holes 30 and the non-display area side contact holes 33) include the bending portions 43, respectively. According to the configuration, the solution for forming the alignment film 11e is drawn into the contact holes (the lower contact holes 30 and the non-display area side contact holes 33) by the bending portions 43. Therefore, the alignment film 11e is easily formed in the contact holes (the lower contact holes 30 and the non-display area side contact holes 33) and the moire is properly reduced or suppressed.

### Second Embodiment

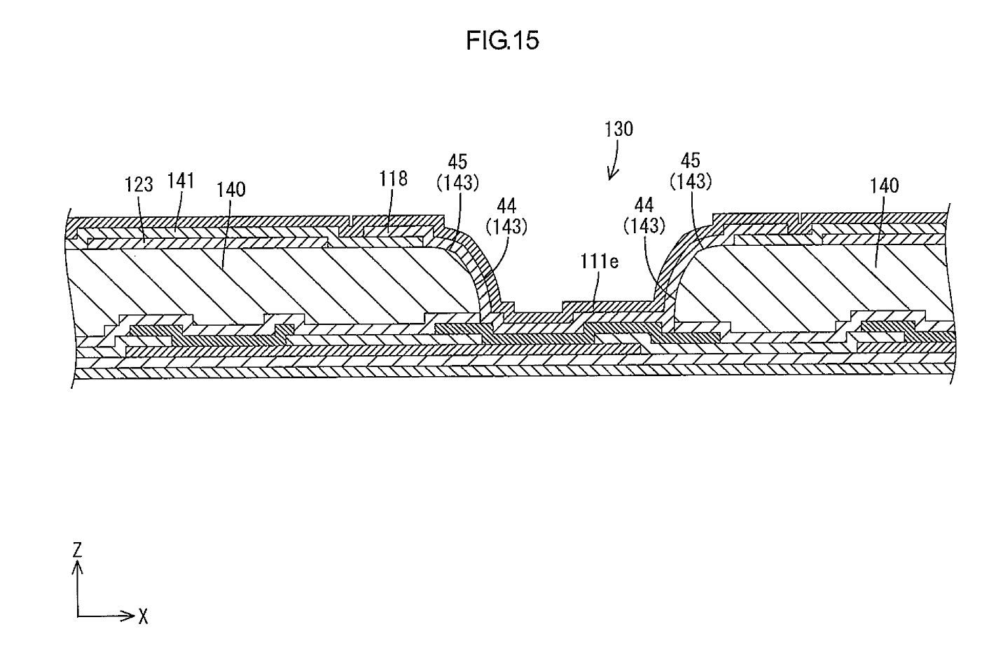

A second embodiment of the present invention will be described with reference to FIGS. 15 to 18. The second embodiment includes an organic insulator 140 that includes lower contact holes 130. Each of the contact holes 130 has an edge having a cross-sectional shape different from the first embodiment. Structures, functions, and effects similar to those of the first embodiment will not be described.

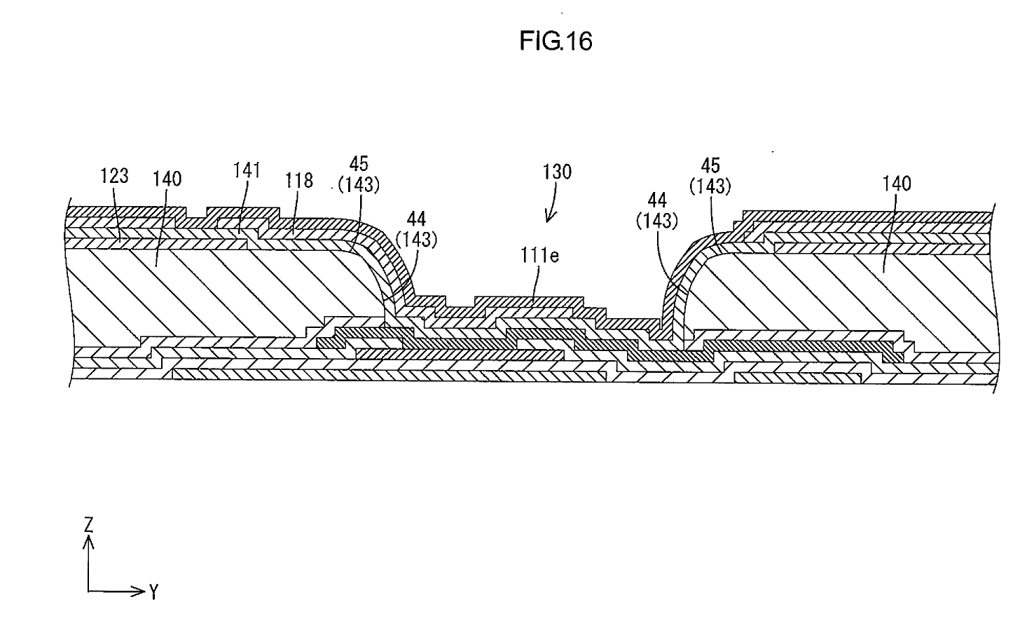

The edge of the lower contact hole 130 in the organic insulator 140 has the cross-sectional shape gradually rising as illustrated in FIGS. 15 and 16. Specifically, the edge of the lower contact hole 130 in the organic insulator 140 has a first inclined portion 44 which is disposed on the relatively lower side and whose inclination angle is relatively large to have a sharp slope, and a second inclined portion 45 which is disposed on the relatively upper side and whose inclination angle is relatively small to have a gentle slope. The first inclined portion 44 and second inclined portion 45 are formed along the entire circumference of the edge of the lower contact hole 130 in the organic insulator 140, and are also provided for a bending portion 143 included in the same edge.

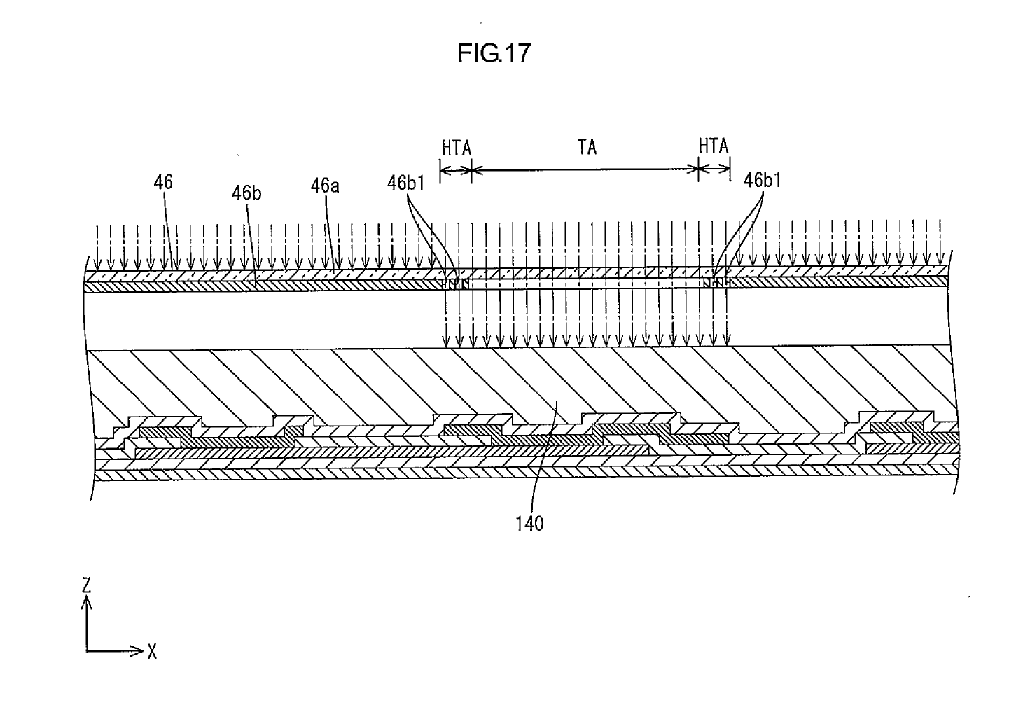

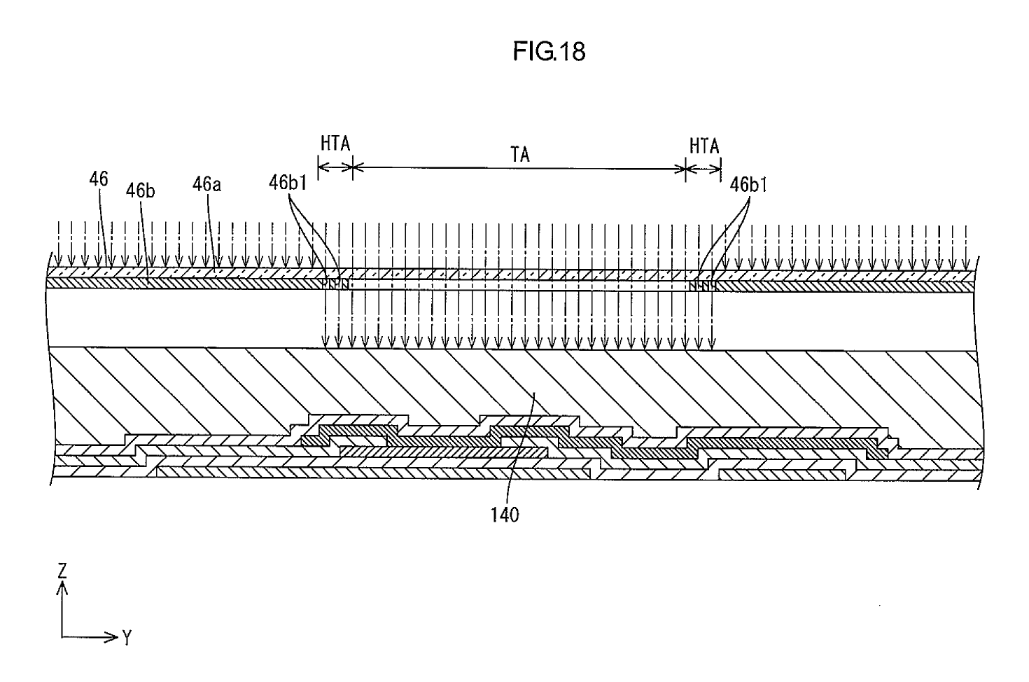

For forming the organic insulator 140 with such a sectional shape, a gray tone mask 46 is used as a photomask in patterning the organic insulator 140 in this embodiment. The gray tone mask 46 includes a transparent glass base member 46a and a light blocking film 46b that is formed on a plate surface of the glass base member 46a to block the exposing light from a light source as illustrated in FIGS. 17 and 18. The gray tone mask 46 includes a semitransmissive area HTA whose transmissivity of the exposing light is, for example, 10% to 70% by providing a portion of the light blocking film 46b with a slit 46b1 less than or equal to the resolution of the exposure device. A portion of the light blocking film 46b includes a hole equal to the resolution of the exposure device or larger. The gray tone mask 46 includes a transmissive area TA having about 100% of transmissivity for transmitting rays of exposing light from the light source. When the organic insulator 140 is subjected to the exposing light from the light source through the gray tone mask 46 with such a structure, the lower contact hole 130 and the first inclined portion 44 are formed in the portion of the organic insulator 140 overlapping the transmissive area TA in a plan view. The first inclined portion 44 is formed at the edge of the lower contact hole 130. Furthermore, the second inclined portion 45 is formed in the portion thereof overlapping the semitransmissive area HTA in a plan view. The second inclined portion 45 is formed at the edge of the lower contact hole 130.

After the first inclined portion 44 and the second inclined portion 45 are formed at the edges of the lower contact hole 130 in the organic insulator 140, a common electrode 123, a second interlayer insulator 141, a pixel electrode 118, and an alignment film 111e are formed sequentially as illustrated in FIGS. 15 and 16. In the formation of the alignment film 111e, when the droplets of the solution for forming the alignment film 111e having reached out of the lower contact hole 130 spreads into the lower contact hole 130, first, the droplet passes the second inclined portion 45 with the gentle slope in the edge (including the bending portion 143) of the lower contact hole 130, thereby smoothly flowing into the lower contact hole 130. Thus, the droplets of the solution for forming the alignment film 111e whose fluidity has increased by the second inclined portion 45 flow into the lower contact hole 130 subsequently through the first inclined portion 44. Thus, the defects are less likely to be developed in the alignment film 111e.

As described above, in the array board according to this embodiment, the insulator includes at least the organic insulator 140 formed of the organic resin material, and at least the bending portion 143 of the edge of the lower contact hole 130 has a sectional shape gradually rising. The edge includes the first inclined portion 44 which is disposed on the relatively lower side and whose inclination angle is relatively large, and the second inclined portion 45 which is disposed on the relatively upper side and whose inclination angle is relatively small. If the bending portion is entirely formed of the first inclined portion, it is difficult for the solution for forming the alignment film 111e to move toward the first inclined portion side because the inclination is sharp. As compared to this case, when the second inclined portion 45 with the gentle slope is disposed above the first inclined portion 44, the solution for forming the alignment film 111e can be moved smoothly. Therefore, in the formation of the alignment film 111e, when the solution for forming the alignment film 111e has reached the bending portion 143 of the edge of the lower contact hole 130, the solution is induced to flow into the lower contact hole 130 by the second inclined portion 45 disposed relatively higher and having the smaller inclination angle. As a result, the solution enters the lower contact hole 130 smoothly through the first inclined portion 44. On the other hand, this is suitable when the lower contact hole 130 is small as compared to the case in which the bending portion is entirely formed of the second inclined portion because the edge of the lower contact hole 130 tends to have a larger width.

In the method of producing the array board according to this embodiment, in the first film forming process, at least the organic insulator 140 including a photosensitive organic resin material is formed as the insulator and the organic insulator 140 is exposed to light using the gray tone mask 46 including the semitransmissive area HTA by the slit 46b1 as the photomask. Thus, at least the bending portion 143 of the edge of the lower contact hole 130 is formed to have a sectional shape gradually rising and the edge includes at least the first inclined portion 44 which is disposed on the relatively lower side and whose inclination angle is relatively large, and the second inclined portion 45 which is disposed on the relatively upper side and whose inclination angle is relatively small. Thus, the organic insulator 140 formed of the photosensitive organic resin material in the first film forming process is exposed to light using the gray tone mask 46 including the semitransmissive area HTA by the slit 46b1, so that the bending portion 143 is formed to have a sectional shape gradually rising and moreover to have at least the first inclined portion 44 which is disposed on the relatively lower side and whose inclination angle is relatively large and the second inclined portion 45 which is disposed on the relatively upper side and whose inclination angle is relatively small. If the bending portion is entirely formed of the first inclined portion, it is difficult for the solution for forming the alignment film 111e to move toward the first inclined portion side because the inclination is sharp. As compared to this case, when the second inclined portion 45 with the gentle slope is disposed above the first inclined portion 44, the solution for forming the alignment film 111e can be moved smoothly. Therefore, in the formation of the alignment film 111e, when the solution for forming the alignment film 111e has reached the bending portion 143 of the edge of the lower contact hole 130, the solution is induced to flow into the lower contact hole 130 by the second inclined portion 45 disposed relatively higher and having the smaller inclination angle, so that the solution enters the lower contact hole 30 smoothly through the first inclined portion 44. On the other hand, this is suitable when the lower contact hole 130 is small, as compared to the case in which the bending portion is entirely formed of the second inclined portion because the edge of the lower contact hole 130 tends to have a larger width.

### Third Embodiment

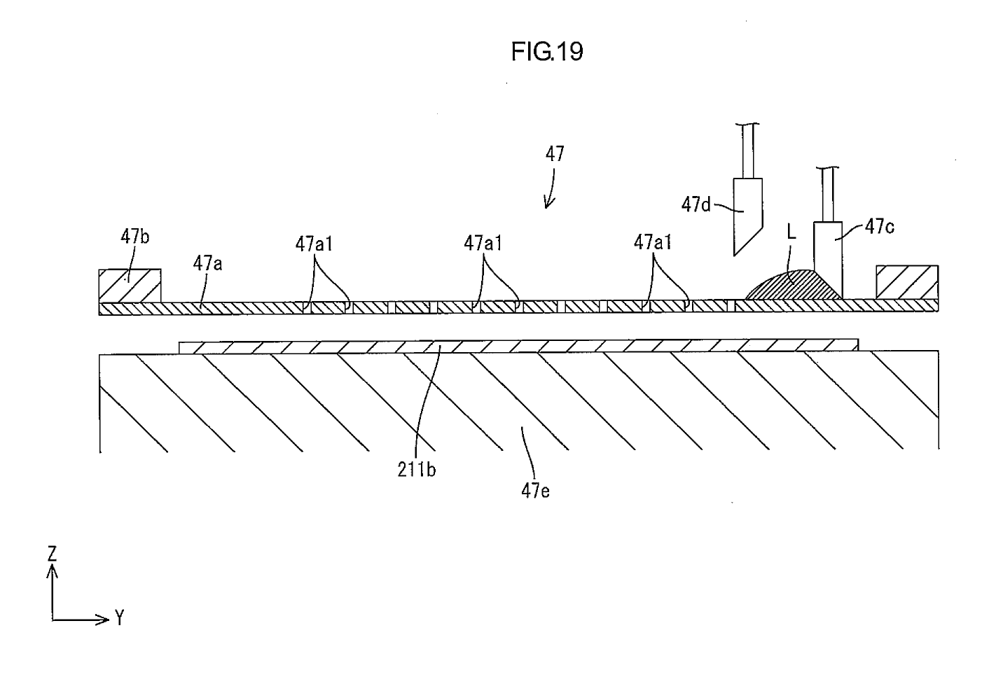

A third embodiment of the present invention will be described with reference to FIG. 19. In the third embodiment, a screen printing device 47 is used for forming the alignment film. Structures, functions, and effects similar to those of the first embodiment will not be described.

The screen printing device (stencil printing device) 47 according to this embodiment includes, as illustrated in FIG. 19, a mesh screen (stencil) 47a disposed opposite to, and with a space from the array board 211b, a frame 47b to be attached to an outer periphery of the screen 47a, a pair of squeegees 47c and 47d configured to horizontally reciprocate on the screen 47a along the surface thereof, and a stage 47e on which an array board 211b is mounted. On the screen 47a, a number of holes 47a1 are intermittently disposed in parallel to each other having a predetermined regularity along the surface thereof. In the screen 47a, the center is elastically deformed in the Z-axis direction by being pressed by each of the squeegees 47c and 47d as compared to the outer periphery supported by the frame 47b. A first squeegee 47c of the pair of squeegees 47c and 47d is moved to the left in FIG. 19 on the screen 47a to spread the supplied solution L that forms the alignment film, thereby filling the holes 47a1. A second squeegee 47d is moved to the right in FIG. 19 while pressing the screen 47a against the array board 211b, so that the solution L filled in the holes 47a1 can be transcribed to the array board 211b side. Even when the alignment film is formed on the array board 211b using the screen printing device 47, the operation and effect similar to those described in the first embodiment can be obtained.

In the second film forming process in the method of producing the array board 211b according to this embodiment, as described above, the screen printing device (stencil printing device) 47 is used. While the solution L that forms the alignment film is supplied onto the mesh screen (stencil) 47a of the screen printing device 47, the squeegees 47c and 47d are moved on the screen 47a, so that the solution L that forms the alignment film is printed onto the second conductive film (second transparent electrode film or second metal film) through the holes 47a1 of the screen 47a. Thus, the solution L that forms the alignment film, which has been supplied onto the mesh screen 47a in the screen printing device 47 in the second film forming process, is printed onto the second conductive film (second transparent electrode film or second metal film) through the holes 47a1 of the screen 47a by the squeegees 47c and 47d moving on the screen 47a, and then spreads over the surface. Since the screen 47a of the screen printing device 47 has the holes 47a1 and has the mesh shape, the arrangement of the holes 47a may interfere with the arrangement of the contact holes (lower contact holes or non-display area side contact hole). In this case, if the solution L that forms the alignment film through the holes 47a1 does not spread sufficiently, the moire may be caused. In this regard, since the bending portion is included in the edge of the contact hole (lower contact hole or non-display area side contact hole), the solution L that forms the alignment film is drawn into the contact hole (lower contact hole or non-display area side contact hole) by the bending portion. Therefore, the alignment film is easily formed in the contact hole (lower contact hole or non-display area side contact hole) and this can suppress or prevent the occurrence of moire.

### Fourth Embodiment

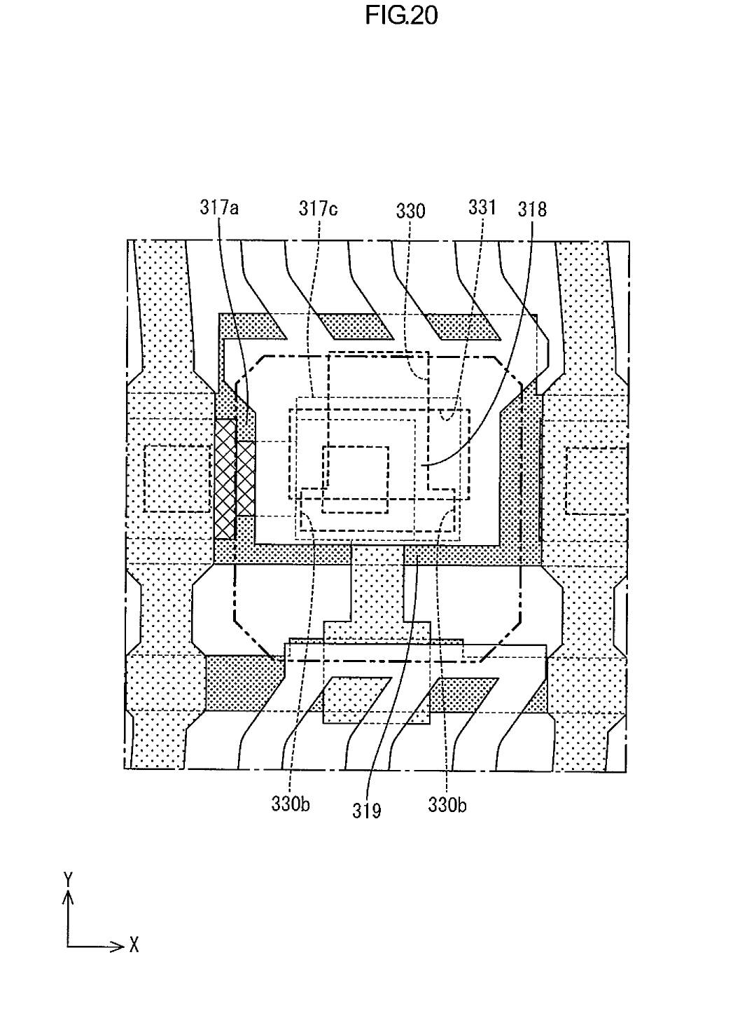

A fourth embodiment of the present invention will be described with reference to FIG. 20. In the fourth embodiment, lower contact holes 330 are arranged differently from the first embodiment in a plan view. Structures, functions, and effects similar to those of the first embodiment will not be described.

The lower contact hole 330 according to this embodiment is disposed such that expanded hole portions 330b entirely overlap a pixel electrode 318, a gate line 319 (gate electrode 317a), and a drain electrode 317c in a plan view as illustrated in FIG. 20. Moreover, the lower contact hole 330 is disposed such that a portion of the expanded hole portions 330b overlaps an upper contact hole 331.

### Fifth Embodiment

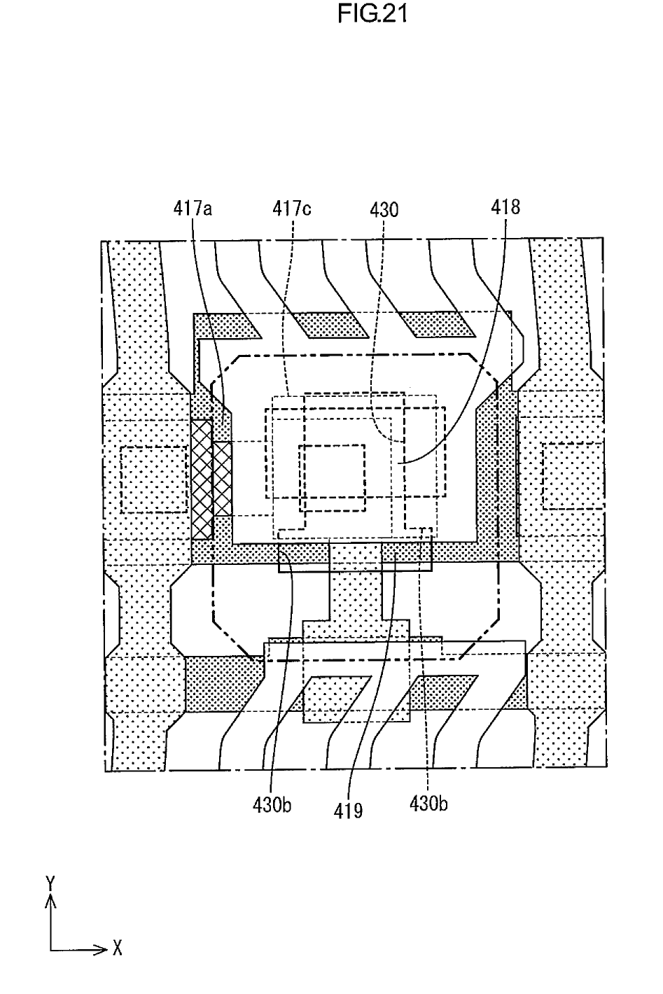

A fifth embodiment of the present invention will be described with reference to FIG. 21. In the fifth embodiment, lower contact holes 430 are arranged differently from the first embodiment in a plan view. Structures, functions, and effects similar to those of the first embodiment will not be described.

The lower contact hole 430 according to this embodiment is disposed such that a portion of expanded hole portions 430b overlaps a pixel electrode 418, agate line 419 (gate electrode 417a), and a drain electrode 417c in a plan view as illustrated in FIG. 21. The area of the expanded hole portion 430b overlapping the pixel electrode 418, the gate line 419, and the drain electrode 417c are different: the area of the expanded hole portion 430b overlapping the gate line 419 in the maximum and the area of the expanded hole portion 430b overlapping the drain electrode 417c is the minimum.

### Sixth Embodiment

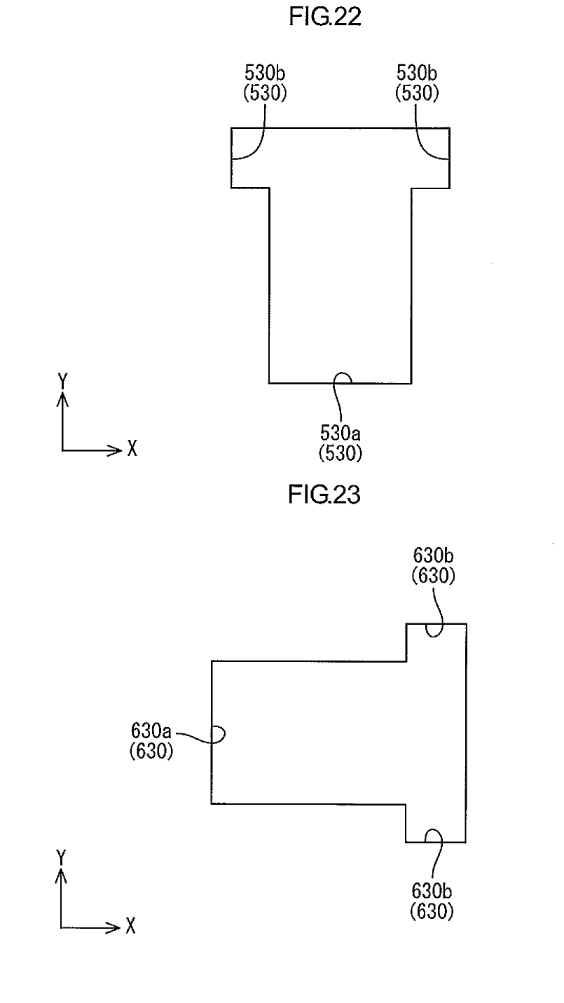

A sixth embodiment of the present invention will be described with reference to FIG. 22. In the sixth embodiment, each of lower contact holes 530 has a shape different from the first embodiment in a plan view. Structures, functions, and effects similar to those of the first embodiment described will not be described.

The lower contact hole 530 according to this embodiment is configured in a manner that a pair of expanded hole portions 530b is formed by extending upper corners of a contact hole main portion 530a as illustrated in FIG. 22. In other words, of the lower contact hole 530, the expanded hole portions 530b are formed by extending the corners of the contact hole main portion 530a closer to the center of the pixel electrode, which is not illustrated.

### Seventh Embodiment

A seventh embodiment of the present invention will be described with reference to FIG. 23. In the seventh embodiment, each of lower contact holes 630 has a shape different from the first embodiment in a plan view. Structure, functions, and effects similar to those of the first embodiment will not be described.

The lower contact hole 630 according to this embodiment is disposed in the posture with the length direction and the width direction thereof coinciding with the X-axis direction and the Y-axis direction, respectively as illustrated in FIG. 23. A pair of expanded hole portions 630b is formed by extending right corners of a contact hole main portion 630a as illustrated in FIG. 23. In other words, the lower contact hole 630 has the structure obtained by rotating the upper contact hole described in the first embodiment by 90° rightward in a plan view.

### Eighth Embodiment

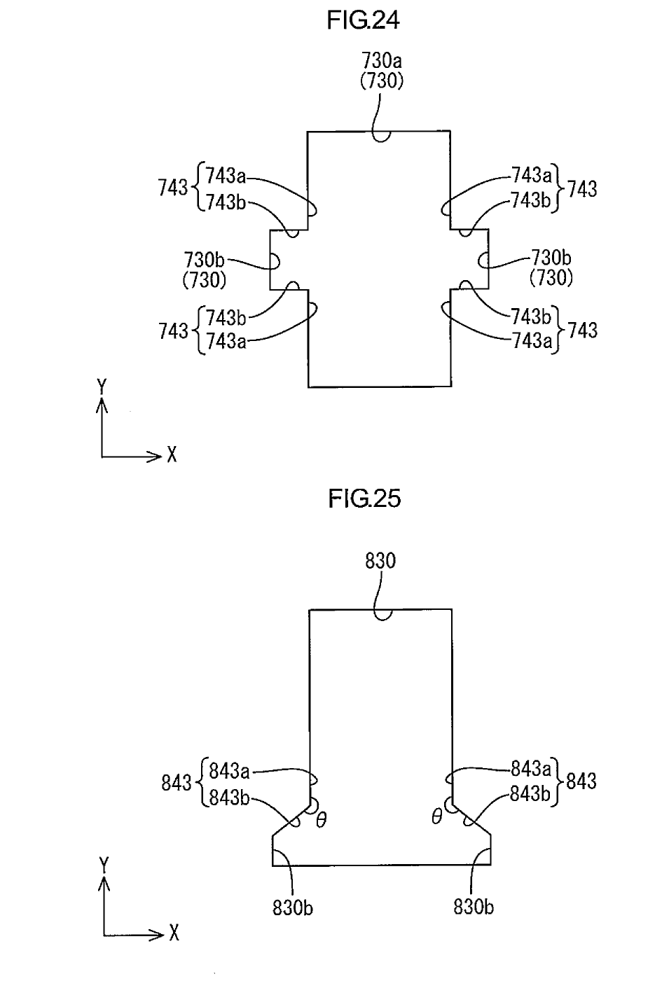

An eighth embodiment of the present invention will be described with reference to FIG. 24. In the eighth embodiment, each of lower contact holes 730 has a shape different form the first embodiment in a plan view. Structures, functions, and effects similar to those of the first embodiment will not be described.

Of the lower contact hole 730 according to this embodiment, a pair of expanded hole portions 730b is formed by extending a center portion (non-corner portion) of a contact hole main portion 730a in the length direction of the contact hole main portion 730a as illustrated in FIG. 24. In this configuration, first edges 743a along the length direction out of the edges of the contact hole main portion 730a are disconnected by the pair of expanded hole portions 730b. Therefore, the pair of first edges 743a communicates with a pair of second edges 743b along the width direction out of the edges of the expanded hole portions 730b. A bending portion 743 is formed by the communicating first edges 743a and second edges 743b. In other words, in this embodiment, the two bending portions 743 are formed by one expanded hole portion 730b. This enables the droplet of the solution for forming the alignment film to be drawn into the lower contact hole 730 more easily in the formation of the alignment film.

### Ninth Embodiment

A ninth embodiment of the present invention will be described with reference to FIG. 25. In the ninth embodiment, each of lower contact holes 830 has a different planar shape. Structures, functions, and effects similar to those of the first embodiment will not be described.

Of edges of a pair of expanded hole portions 830b of the lower contact hole 830 according to this embodiment, second edges 843b of bending portions 843 are formed to be inclined in a plan view as illustrated in FIG. 25. The second edge 843b is formed inclined in a plan view such that the angle 8 on the inside relative to a first edge 843a is a reflex angle ranging from 180° to 270°. In other words, the second edge 843b is inclined in a plan view such that the angle on the outside relative to the first edge 843a is in the range of 90° to 180°, i.e., an obtuse angle.

### Tenth Embodiment

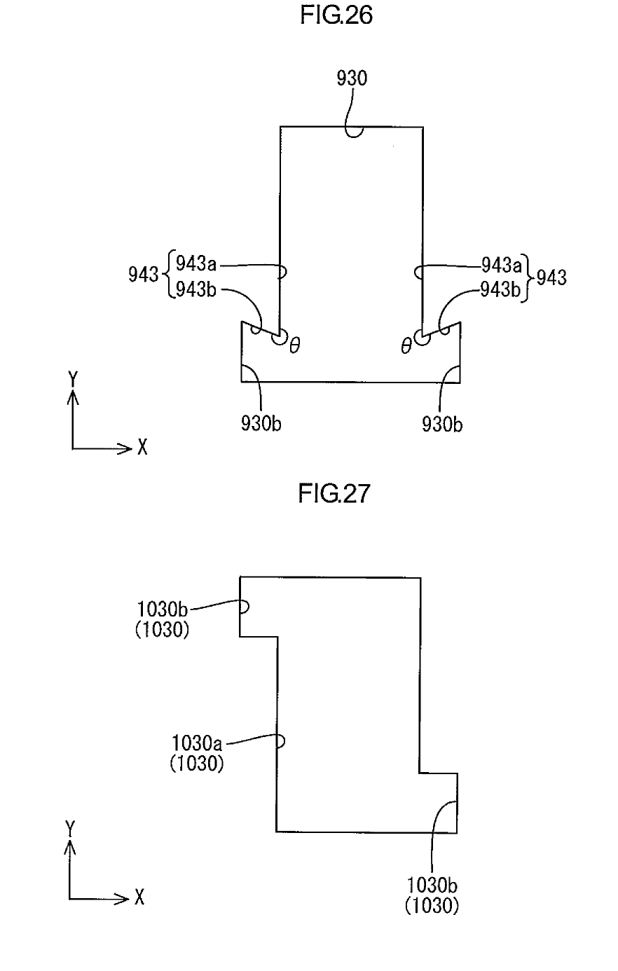

A tenth embodiment of the present invention will be described with reference to FIG. 26. In the tenth embodiment, each of lower contact holes 930 has a shape different from the first embodiment in a plan view. Structures, functions, and effects similar to those of the first embodiment will not be described.

Of edges of a pair of expanded hole portions 930b of the lower contact hole 930 according to this embodiment, second edges 943b of bending portions 943 are formed to be inclined in a plan view as illustrated in FIG. 26. The second edge 943b is formed inclined in a plan view such that the angle 8 on the inside relative to a first edge 943a is a reflex angle ranging from 270° to 360°. In other words, the second edge 943b is inclined in a plan view such that the angle on the outside relative to the first edge 943a is in the range of 0° to 90°, i.e., an acute angle.

### Eleventh Embodiment

An eleventh embodiment of the present invention will be described with reference to FIG. 27. In the eleventh embodiment, each of lower contact holes 1030 has a shape different from the first embodiment in a plan view. Structures, functions, and effects similar to those of the first embodiment will not be described.

In the lower contact hole 1030 according to this embodiment, a pair of expanded hole portions 1030b is formed by extending diagonal corners of a contact hole main portion 1030a as illustrated in FIG. 27.

### Twelfth Embodiment

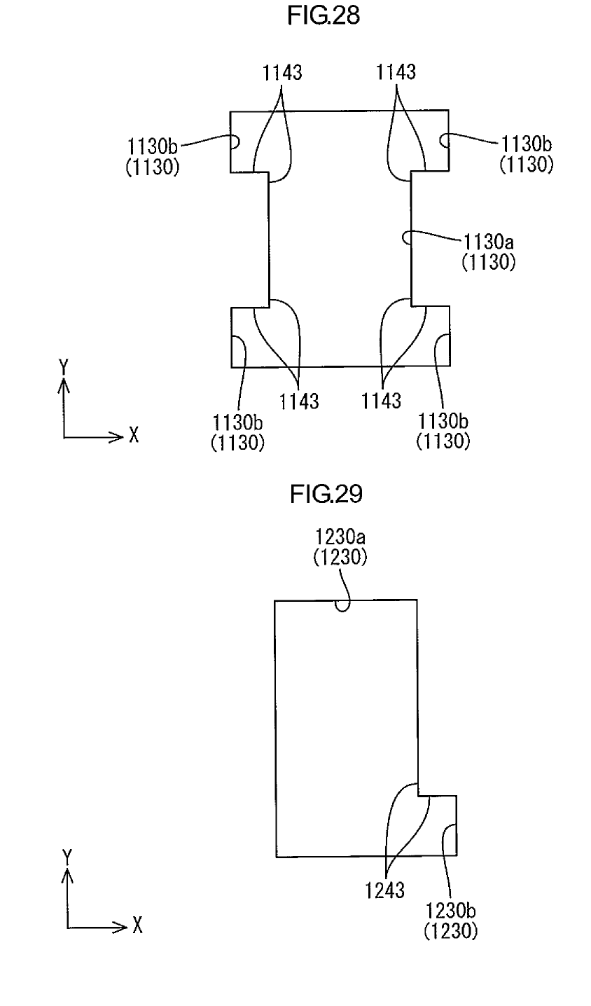

A twelfth embodiment of the present invention will be described with reference to FIG. 28. In the twelfth embodiment, each of lower contact holes 1130 has a shape different from the first embodiment in a plan view. Structures, functions, and effects similar to those of the first embodiment will not be described.

In the lower contact hole 1130 according to this embodiment, four expanded hole portions 1130b are formed by extending four corners of a contact hole main portion 1130a as illustrated in FIG. 28. Four bending portions 1143 are formed over the contact hole main portion 1130a and the expanded hole portions 1130b. In other words, the lower contact hole 1130 has a shape obtained by narrowing the center portion excluding the opposite ends in the length direction (portion where the expanded hole portions 1130b are formed), and the four bending portions 1143 are formed at the edges over the opposite ends and the center portion.

### Thirteenth Embodiment

A thirteenth embodiment of the present invention will be described with reference to FIG. 29. In the thirteenth embodiment, each of lower contact holes 1230 has a shape different from the first embodiment in a plan view. Structures, functions, and effects similar to those of the first embodiment will not be described.

In the lower contact hole 1230 according to this embodiment, one expanded hole portion 1230b is formed by extending one corner of a contact hole main portion 1230a as illustrated in FIG. 29. Just one bending portion 1243 is formed over the contact hole main portion 1230a and the expanded hole portion 1230b.

### Fourteenth Embodiment

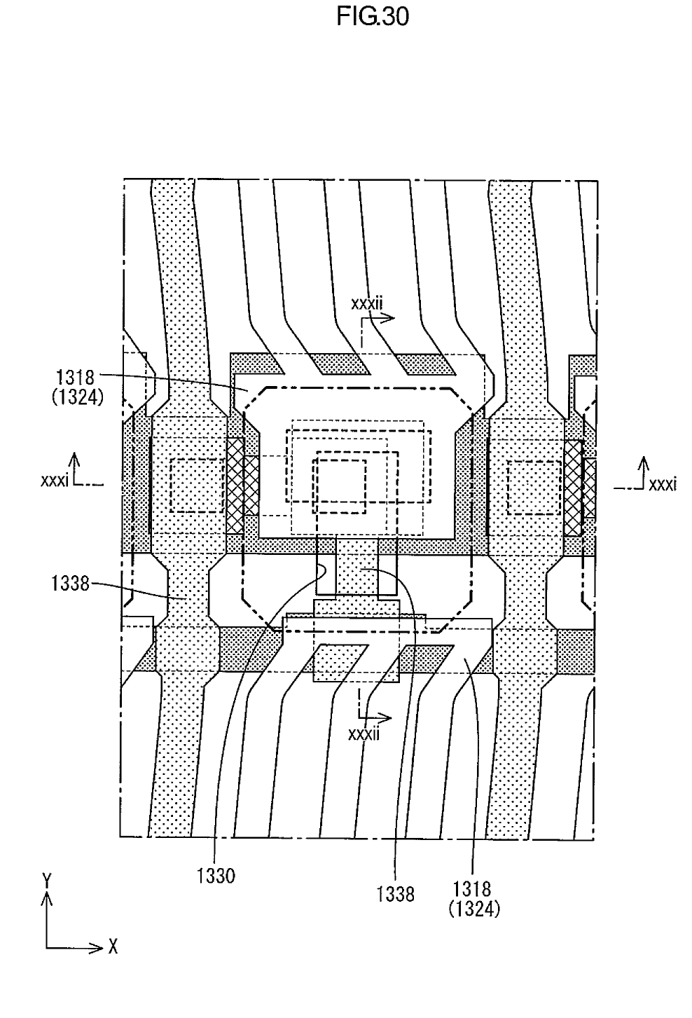

A fourteenth embodiment of the present invention will be described with reference to FIGS. 30 to 34. In the fourteenth embodiment, each of lower contact holes 1330 has a shape different from the first embodiment in a plan view and an edge has a shape different from the first embodiment in a cross-sectional view. Structures, functions, and effects similar to those of the first embodiment will not be described.

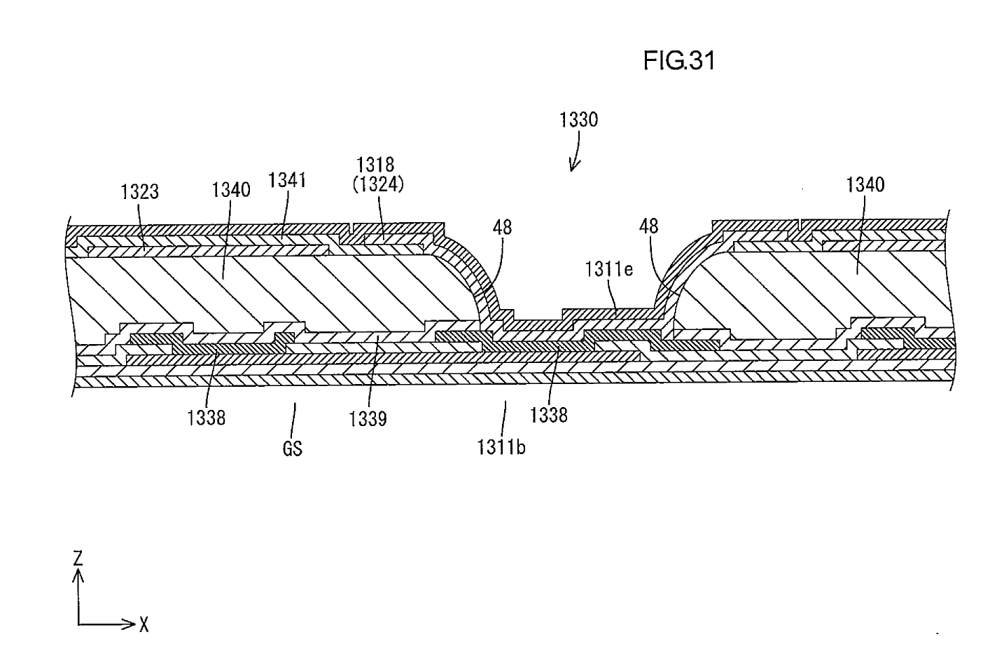

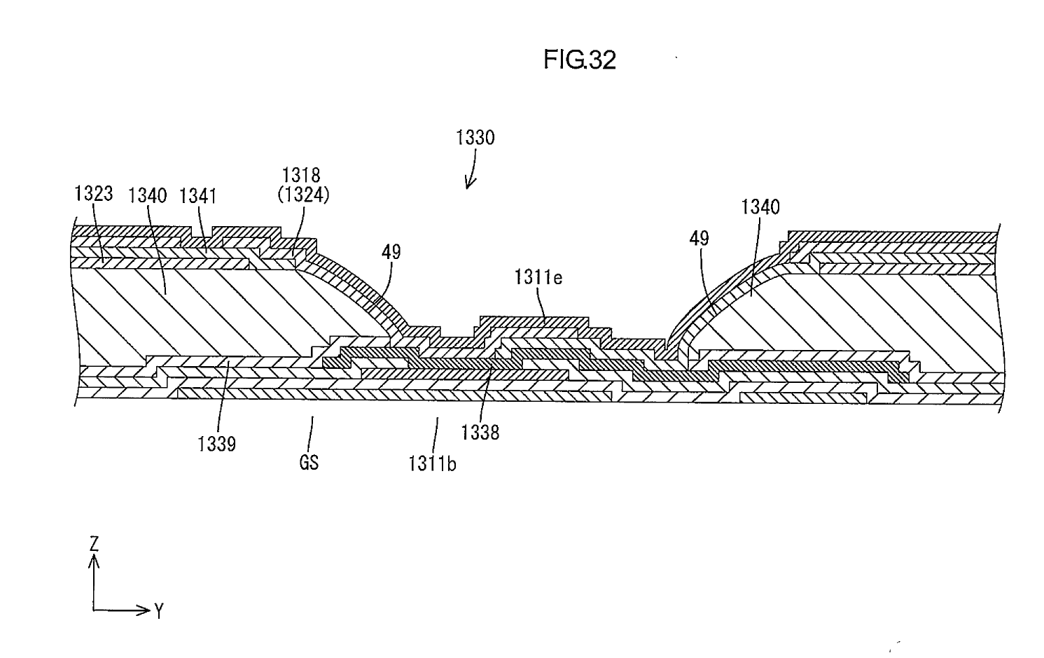

In an organic insulator 1340 according to this embodiment, the edge of the lower contact hole 1330 has a vertically-long rectangular shape in a plan view as illustrated in FIG. 30. In other words, the edges of the lower contact hole 1330 do not have the bending portions described in the first to thirteenth embodiments. In other words, it can be said that the lower contact hole 1330 includes only the contact hole main portion and is formed by omitting the expanded hole portion from the lower contact hole described in the first to thirteenth embodiments. As illustrated in FIGS. 31 and 32, the edges of the lower contact hole 1330 include a first inclined portion 48 whose sectional shape is inclined and whose inclination angle is relatively large, and a second inclined portion 49 whose sectional shape is inclined and whose inclination angle is relatively small.

As illustrated in FIGS. 30 and 31, the first inclined portion 48 is provided for each of a pair of edges opposite each other among four edges (opening periphery) of the lower contact hole 1330 with a rectangular shape in a plan view in the organic insulator 1340, specifically, a pair of right and left edges extending along the Y-axis direction and illustrated in FIG. 30. The first inclined portion 48 has its sectional shape with an approximately bow-like shape (approximately arc-like shape) and has its tangential line inclined relatively sharply to both the X-axis direction and the Z-axis direction. On the other hand, as illustrated in FIGS. 30 and 32, the second inclined portion 49 is provided for each of edges constituting a pair of sides opposite to each other and adjacent to each of the first inclined portions 48 among four edges of the lower contact hole 1330 with a rectangular shape in a plan view in the organic insulator 1340, specifically, a pair of upper and lower edges extending along the X-axis direction and illustrated in FIG. 30. The second inclined portion 49 has its sectional shape with an approximately bow-like shape (approximately arc-like shape) and has its tangential line inclined relatively gently to both the Y-axis direction and the Z-axis direction.

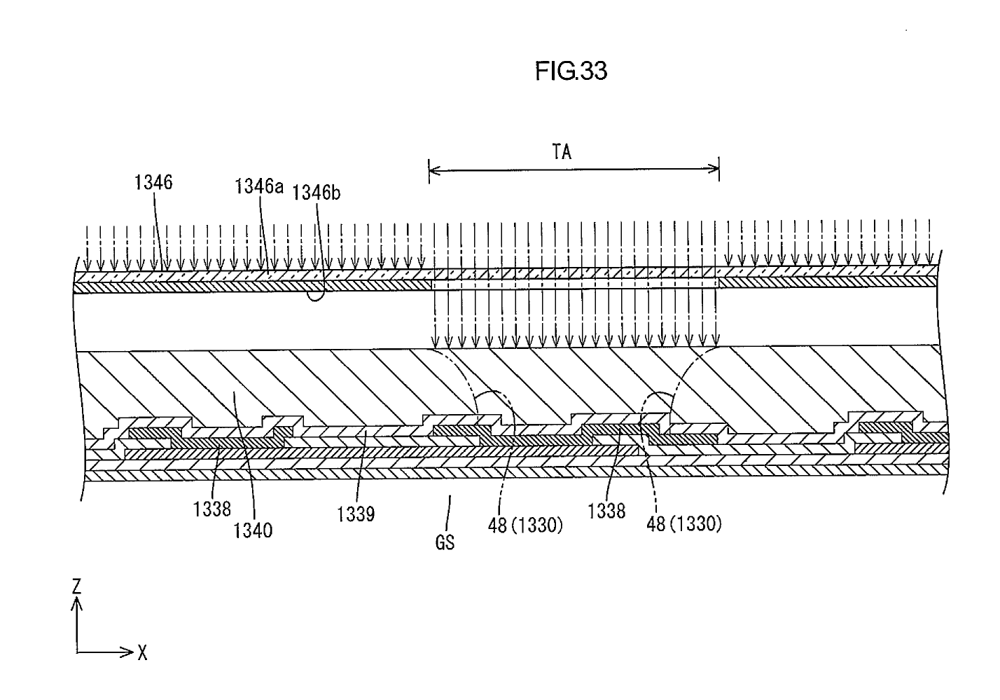

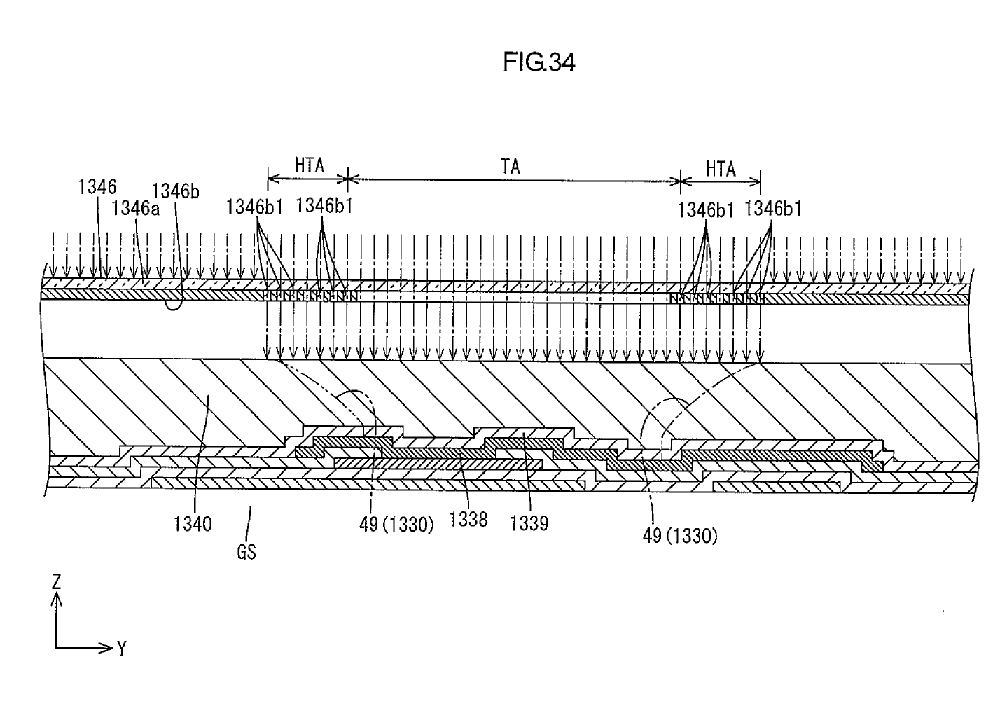

For forming the organic insulator 1340 with such a sectional shape, in this embodiment, a gray tone mask 1346 is used as a photomask in patterning the organic insulator 1340 in this embodiment. This gray tone mask 1346 has a fundamental structure similar to that described in the second embodiment. As illustrated in FIGS. 33 and 34, the gray tone mask 1346 is formed of a transparent glass base member 1346a and a light blocking film 1346b formed on a plate surface of the glass base member 1346a to block exposing light from a light source. The gray tone mask 46 includes a semitransmissive area TA by providing a portion of the light blocking film 1346b with an opening more than or equal to the resolution of the exposure device, and a semitransmissive area HTA by providing a portion of the light blocking film 1346b with a slit 1346b1 less than or equal to the resolution of the exposure device. In the gray tone mask 1346 according to this embodiment, the semitransmissive area TA is formed in a portion overlapping the opening of the lower contact hole 1330 and the first inclined portion 48 in a plan view and the semitransmissive area HTA (slit 1346b1) is formed in a portion overlapping the second inclined portion 49 in a plan view. Upon the irradiation of the organic insulator 140 with the exposing light from the light source through the gray tone mask 1346 with such a structure, the opening of the lower contact hole 1330 and the first inclined portion 48 forming the edge and having the larger inclination angle are formed in the portion of the organic insulator 1340 overlapping the semitransmissive area TA in a plan view and the second inclined portion 49 forming the edge of the lower contact hole 1330 and having the smaller inclination angle is formed in the portion thereof overlapping the semitransmissive area HTA in a plan view. The procedure of producing an array board 1311b according to this embodiment is similar to that of the first and second embodiments.

After the first inclined portion 48 and the second inclined portion 49, which are adjacent to each other in a plan view, are formed at the edge of the lower contact hole 1330 in the organic insulator 1340, a common electrode 1323, a second interlayer insulator 1341, a pixel electrode 1318, and an alignment film 1311e are formed sequentially as illustrated in FIGS. 31 and 32. In the formation of the alignment film 1311e, when the droplet of the solution for forming the alignment film 1311e having reached out of the lower contact hole 130 spreads into the lower contact hole 1330, the droplet flows easily into the second inclined portion 49 with the slope less sharp than the first inclined portion 48, whereby the flow (introduction) of the droplets into the lower contact hole 1330 is promoted. In addition, at the boundary between the first inclined portion 48 and the second inclined portion 49 with the different inclination angle in the edge of the lower contact hole 1330, i.e., at the corner, the inclination angle is different, so that the fluidity of the droplet of the solution for forming the alignment film 1311e is increased. As a result, the droplets can flow into the lower contact hole 1330 more easily. Therefore, defects are less likely to be developed in the alignment film 1311e and the moire is reduced or suppressed. The function and the effect achieved by the configuration of this embodiment (the first inclined portions 48 and the second inclined portions 48) are substantially the same as those of the first embodiment achieved by the configuration of the first embodiment (the bending portions). Furthermore, the problem (moire due to the defects in the alignment film) can be solved by any of the first and the second embodiments.

As described above, the array board 1311b according to this embodiment includes: a second metal film 1338 as a first conductive film; a second transparent electrode film 1324 as a second conductive film disposed above the second metal film 1338 as the first conductive film and having at least a part thereof overlapping the second metal film 1338 as the first conductive film in a plan view; a first interlayer insulator 1339 and the organic insulator 1340, which are interposed between the second metal film 1338 as the first conductive film and the second transparent electrode film 1324 as the second conductive film and have the lower contact hole 1330 opened at the position overlapping the second metal film 1338 as the first conductive film and the second transparent electrode film 1324 as the second conductive film in a plan view for connecting the second metal film 1338 as the first conductive film to the second transparent electrode film 1324 as the second conductive film; the alignment film 1311e disposed above the second transparent electrode film 1324 as the second conductive film and having a portion overlapping the lower contact hole 1330 in a plan view and a portion not overlapping the lower contact hole 1330 in a plan view; and the two inclined portions 48 and 49 formed at the edge of the lower contact hole 1330 in the first interlayer insulator 1339 as the insulator and having the sectional shape inclined with the different inclination angles.

Thus, the second transparent electrode film 1324 as the second conductive film formed after the formation of the second metal film 1338 as the first conductive film and the first interlayer insulator 1339 and the organic insulator 1340 as the insulator is connected to the first conductive film on the lower side through the lower contact hole 1330 of the first interlayer insulator 1339 and the organic insulator 1340 as the insulator. In the film-formation of the alignment film 1311e above the second metal film 1338 as the first conductive film, when the solution for forming the alignment film 1311e is locally supplied to the surface of the second transparent electrode film 1324 as the second conductive film, the solution spreads to the outside of the lower contact hole 1330 and to the inside of the lower contact hole 1330. Thus, the alignment film 1311e having the portion overlapping the lower contact hole 1330 in a plan view and the portion not overlapping the lower contact hole 1330 in a plan view is formed. In the case where the solution for forming the alignment film 1311e supplied on the outside of the lower contact hole 1330 spreads to the inside the lower contact hole 1330, when the solution has reached the edge of the lower contact hole 1330, the solution is induced to flow into the lower contact hole 1330 by the second inclined portion 49 with the less sharp slope and with the smaller inclination angle out of the two inclined portions 48 and 49 whose sectional shapes are inclined at the edge and whose inclination angles are different from each other. In addition, at the boundary between the inclined portions 48 and 49 with the different inclination angle in the edge of the lower contact hole 1330, the fluidity of the solution for forming the alignment film 1311e is increased because the inclination angle is different. As a result, the solution can flow into the lower contact hole 1330 more easily. According to the configuration, the alignment film 1311e is easily arranged in the lower contact hole 1330. Therefore, the defects are less likely to be developed in the alignment film 1311e and the moire is properly reduced or suppressed.

A method of producing the array board 1311b according to this embodiment includes a first film forming process and a second film forming process. In the first film forming process, the second metal film 1338 as the first conductive film, the first interlayer insulator 1339 and the organic insulator 1340 as the insulator, and the second transparent electrode film 1324 as the second conductive film are formed in this order on the glass substrate GS, the lower contact hole 1330 is opened at the position of the first interlayer insulator 1339 and the organic insulator 1340 as the insulator overlapping the second metal film 1338 as the first conductive film and the second transparent electrode film 1324 as the second conductive film in a plan view for connecting the second transparent electrode film 1324 as the second conductive film to the second metal film 1338 as the first conductive film, and the two inclined portions 48 and 49 whose sectional shapes are inclined and whose inclination angles are different are formed at the edge of the lower contact hole 1330. In the second film forming process, the alignment film 1311e having the portion overlapping the lower contact hole 1330 and the portion not overlapping the lower contact hole 1330 in a plan view is formed above the second transparent electrode film 1324 as the second conductive film.

Thus, when the second transparent electrode film 1324 as the second conductive film is formed after the formation of the second metal film 1338 as the first conductive film and the first interlayer insulator 1339 and the organic insulator 1340 as the insulator on the glass substrate GS in the first film forming process, the second transparent electrode film 1324 as the second conductive film is connected to the second metal film 1338 as the first conductive film on the lower side through the lower contact hole 1330 formed in the first interlayer insulator 1339 and the organic insulator 1340 as the insulator. In the subsequent second film forming process, when the solution for forming the alignment film 1311e is locally supplied to the surface of the second transparent electrode film 1324 as the second conductive film or the like for forming the alignment film 1311e above the second metal film 1338 as the first conductive film, the solution spreads to the outside of the lower contact hole 1330 and to the inside of the lower contact hole 1330. Thus, the alignment film 1311e is formed which has the portion overlapping the lower contact hole 1330 and the portion not overlapping the lower contact hole 1330 in a plan view. Here, in the case where the solution for forming the alignment film 1311e supplied on the outside of the lower contact hole 1330 spreads to the inside the lower contact hole 1330, when the solution has reached the edge of the lower contact hole 1330, the solution is induced to flow into the lower contact hole 1330 by the second inclined portion 49 with the less sharp slope and with the smaller inclination angle out of the two inclined portions 48 and 49 whose sectional shapes are inclined at the edge and whose inclination angles are different from each other. In addition, at the boundary between the inclined portions 48 and 49 with the different inclination angle in the edge of the lower contact hole 1330, the fluidity of the solution for forming the alignment film 1311e is increased because the inclination angle is different. As a result, the solution can flow into the lower contact hole 1330 more easily. According to the configuration, the alignment film 1311e is easily arranged in the lower contact hole 1330. Therefore, defects are less likely to be developed in the alignment film 1311e and the moire is properly reduced or suppressed.

In the first film forming process of the method of producing the array board 1311b, at least the organic insulator 1340 including a photosensitive organic resin material is formed as the insulator and the organic insulator 1340 is exposed to light using the gray tone mask 1346 including the semitransmissive area HTA by the slit 1346b1 as the photomask. Thus, with the light transmitted through the semitransmissive area HTA of the gray tone mask 1346, at least the second inclined portion 49 with the relatively smaller inclination angle among the two inclined portions 48 and 49 is formed at the edge of the lower contact hole 1330. Thus, the organic insulator 1340 formed of the photosensitive organic resin material in the first film forming process is exposed to light using the gray tone mask 1346 including the semitransmissive area HTA by the slit 1346b1, so that the lower contact hole 1330 is formed. At the edge of the lower contact hole 1330, at least the second inclined portion 49 with the relatively smaller inclination angle among the two inclined portions 48 and 49 is formed due to the light transmitted through the semitransmissive area HTA of the gray tone mask 1346.

### Fifteenth Embodiment

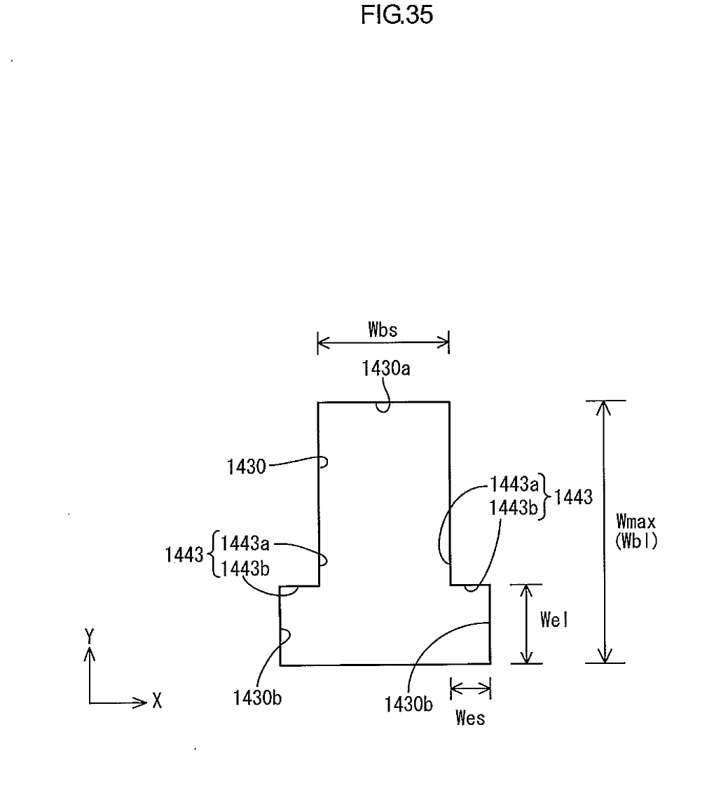

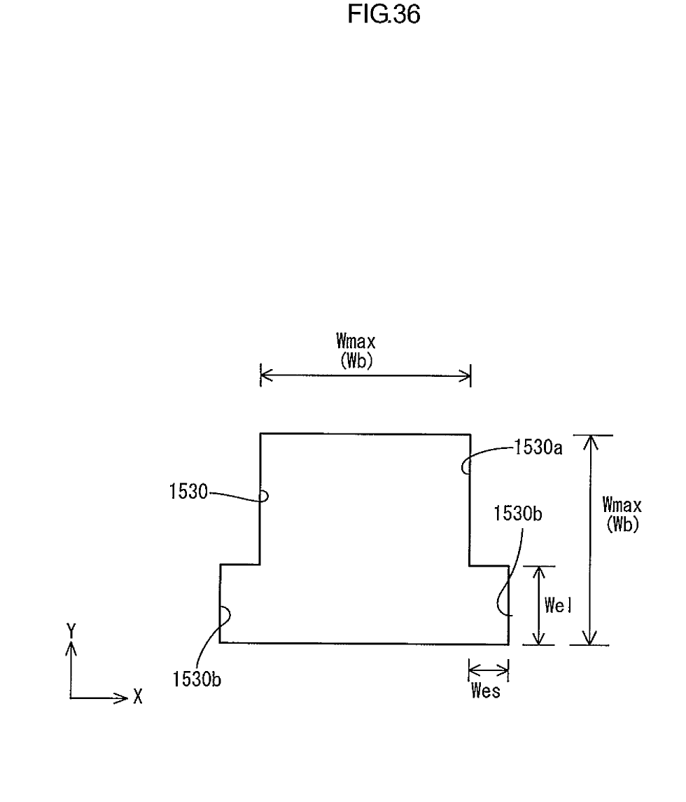

A fifteenth embodiment of the present invention will be described with reference to FIG. 35. In the fifteenth embodiment, each of lower contact holes 1430 has a size different from the first embodiment. In the following description, specific sizes will be present. Structures, functions, and effects similar to those of the first embodiment will not be described.

As illustrated in FIG. 35, the lower contact hole 1430 according to this embodiment is formed such that the opening width of an expanded hole portion 1430b is less than or equal to a half of the maximum value Wmax of the opening width of a contact hole main portion 1430a. Specifically, the contact hole main portion 1430a has a vertically-long rectangular shape in a plan view, and a short dimension Wbs is approximately 5 μm and a long dimension Wbl is approximately 10 μm. On the other hand, the expanded hole portion 1430b has a vertically-long rectangular shape in a plan view, and a short dimension Wes is approximately 1.5 μm and a long dimension Wel is approximately 3 μm. A pair of expanded hole portions 1430b is formed by extending ends constituting corners at a pair of long sides out of four sides constituting the contact hole main portion 1430a. One long side among four sides of the expanded hole portion 1430b overlaps the long side of the contact hole main portion 1430a (specifically, end constituting a corner), thereby enabling the expanded hole portion 1430b to connect to the contact hole main portion 1430a.

The opening width of the portion of the expanded hole portion 1430b that is connected to the contact hole main portion 1430a is equal to the long dimension Wel (for example, approximately 3 μm) of the expanded hole portion 1430b and is less than or equal to a half of, more specifically ⅓ or less of, the long dimension Wbl (for example, approximately 10 μm) corresponding to the maximum value Wmax of the opening width of the contact hole main portion 1430a. By setting the opening width of the expanded hole portion 1430b as above, the droplets of the solution for forming the alignment film having reached both the pair of edges opposite to each other in the expanded hole portion 1430b in the formation of the alignment film easily connect to each other, thereby enabling the droplets of the solution for forming the alignment film to flow into the lower contact hole 1430 more easily. The length of a second edge 1443b included in the expanded hole portion 1430b and a bending portion 1443 is equal to the short dimension Wes (for example, approximately 1.5 μm) of the expanded hole portion 1430b and is less than or equal to a half of, more specifically ⅕ or less of, the long dimension Wbl (for example, approximately 10 μm) corresponding to the maximum value Wmax of the opening width of the contact hole main portion 1430a. By setting the length of the second edge 1443b as above, the droplets of the solution for forming the alignment film having reached both the first edge 1443a and the second edge 1443 included in the bending portion 1443 easily connect to each other in the formation of the alignment film, thereby enabling the droplets of the solution for forming the alignment film to flow into the lower contact hole 1430 more easily. In addition, the dimension of the opening width of the expanded hole portion 1430b (long dimension Wel) and the length of the second edge 1443b included in the bending portion 1443 in the expanded hole portion 1430b (short dimension Wes) are 1 μm or more. This enables the droplets of the solution for forming the alignment film to flow into the lower contact hole 1430 easily in the formation of the alignment film, and additionally facilitates the formation of the contact hole main portion 1430a and the expanded hole portion 1430b. The long dimension Wel of the expanded hole portion 1430b is approximately twice as large as the short dimension Wes thereof. The long dimension Wbl of the contact hole main portion 1430a is approximately twice as large as the short dimension Wbs thereof. In other words, the contact hole main portion 1430a and the expanded hole portion 1430b have the almost equal ratio between their long dimensions Wbl and Wel and short dimensions Wbs and Wes.

Moreover, the lower contact hole 1430 has the entire opening area of approximately 59 μm², which is in the range of 10 μm² to 150 μm². Specifically, the contact hole main portion 1430a has an opening area of approximately 50 μm² and each expanded hole portion 1430b has an opening area of 4.5 μm². By setting the opening area of the lower contact hole 1430 in the range of 10 μm² to 150 μm², the connection area between the second metal film and the second transparent electrode film to be connected can be sufficiently secured and high connection reliability is obtained. Moreover, the contact hole main portion 1430a and the expanded hole portion 1430b can be formed in the first interlayer insulator and the organic insulator easily by a photolithography method and in the formation of the alignment film, the droplets can easily flow into the lower contact hole 1430.

In the first interlayer insulator and the organic insulator provided with the lower contact hole 1430 according to this embodiment, the opening width of the expanded hole portion 1430b is less than or equal to Wmax/2, where Wmax represents the maximum value of the opening width of the contact hole main portion 1430a. Thus, as compared to the case in which the opening width of the expanded hole portion is set to Wmax/2 or more, the solution for forming the alignment film having reached both the pair of edges opposite to each other in the expanded hole portion 1430b is connected more easily. This enables the solution for forming the alignment film to flow into the lower contact hole 1430.

In the first interlayer insulator and the organic insulator provided with the lower contact hole 1430, the second edge (edge) 1443b included in the expanded hole portion 1430b and the bending portion 1443 has a length of Wmax/2 or less. Thus, as compared to the case in which the length of the edge included in the expanded hole portion and the bending portion is set to Wmax/2 or more, the solution for forming the alignment film having reached the edges 1443a and 1443b included in the bending portion 1443 is connected to each other more easily. This enables the solution for forming the alignment film to flow into the lower contact hole 1430 more easily.

The first interlayer insulator and the organic insulator provided with the lower contact hole 1430 are formed such that each of the opening width of the expanded hole portion 1430b and the length of the second edge 1443b included in the expanded hole portion 1430b and the bending portion 1443 is 1 μm or more. As the opening width of expanded hole portion 1430b and the length of the second edge 1443b included in the expanded hole portion 1430b and the bending portion 1443 are smaller, the solution for forming the alignment film flows into the lower contact hole 1430 more easily but on the contrary, it may be more difficult to form the contact hole main portion 1430a and the expanded hole portion 1430b in the first interlayer insulator and the organic insulator. In this regard, by setting each of the opening width of the expanded hole portion 1430b and the length of the second edge 1443b included in the expanded hole portion 1430b and the bending portion 1443 to 1 μm or more, the solution for forming the alignment film can easily flow into the lower contact hole 1430 and the contact hole main portion 1430a and the expanded hole portion 1430b can be formed in the first interlayer insulator and the organic insulator more certainly.

The first interlayer insulator and the organic insulator provided with the lower contact hole 1430 are formed such that the lower contact hole 1430 has an opening area ranging from 10 μm² to 150 μm². If the opening area of the lower contact hole is smaller than 10 μm², the connection area between the second metal film and the second transparent electrode film to be connected becomes too small, thereby deteriorating the connection reliability and making it difficult to form the lower contact hole. On the contrary, if the opening area of the lower contact hole is larger than 150 μm², the solution for forming the alignment film having reached each edge of the lower contact hole connects to each other less easily, thereby making it difficult for the solution for forming the alignment film to flow into the lower contact hole. In this regard, by setting the opening area of the lower contact hole 1430 in the range of 10 μm² to 150 μm², the connection area between the second metal film and the second transparent electrode film is sufficiently secured and the connection reliability is assured. In addition, the lower contact hole 1430 can be formed easily in the first interlayer insulator and the organic insulator and moreover the solution for forming the alignment film can flow into the lower contact hole 1430 easily.

### Sixteenth Embodiment

A sixteenth embodiment of the present invention will be described with reference to FIG. 36. In the sixteenth embodiment, each of lower contact holes 1530 has a shape different from the fifteenth embodiment in a plan view and a size different from the fifteenth embodiment. In the following description, specific sizes will be present. Structures, functions, and effects similar to those of the fifteenth embodiment will not be described.

In the lower contact hole 1530 according to this embodiment, as illustrated in FIG. 36, a contact hole main portion 1530a has a square shape in a plan view. Specifically, each of four sides of the contact hole main portion 1530a with a square shape in a plan view has a dimension Wb of approximately 8 μm. On the other hand, the long dimension Wel and the short dimension Wes of an expanded hole portion 1530b are the same as those of the fifteenth embodiment, and are each set to be less than or equal to a half of the dimension Wb corresponding to the maximum value Wmax of the opening width of the contact hole main portion 1530a. The contact hole main portion 1530a has an opening area of approximately 64 μm²; therefore, the lower contact hole 1530 has an entire opening area of approximately 73 μm², which is in the range of 10 μm² to 150 μm² in a manner similar to the fifteenth embodiment. Even in this configuration, the solution for forming the alignment film can flow into the lower contact hole 1530 sufficiently easily, which is similar to the fifteenth embodiment.

### Seventeenth Embodiment

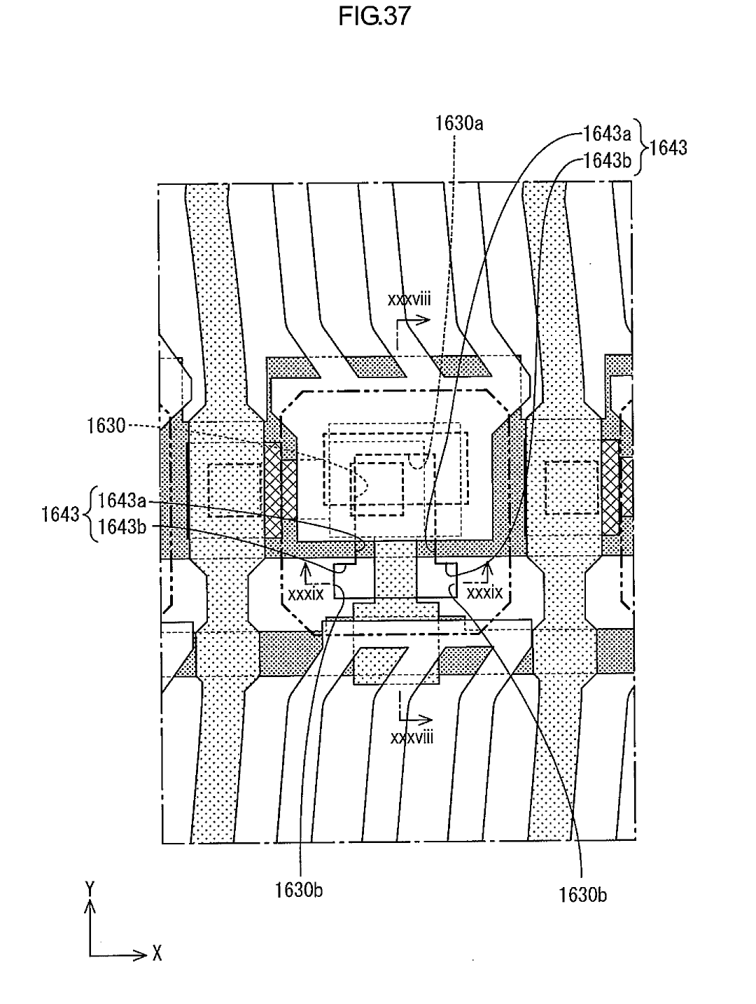

A seventeenth embodiment will be described with reference to FIGS. 37 to 39. In the seventeenth embodiment, each of lower contact holes 1630 includes an edge having a shape different from the fifteenth embodiment in a cross-sectional view. Structures, functions, and effects similar to those of the fifteenth embodiment will not be described.

The edge of the lower contact hole 1630 in an organic insulator 1640 according to this embodiment includes, as illustrated in FIGS. 37 to 39, a first inclined portion 1648 whose sectional shape is inclined and whose inclination angle is relatively large and a second inclined portion 1649 whose sectional shape is inclined and whose inclination angle is relatively small. The sectional shape of the first inclined portion 1648 and the second inclined portion 1649 and the method of forming those portions in the organic insulator 1640 are similar to those of the first inclined portion 48 and the second inclined portion 49 described in the fourteenth embodiment. Therefore, the redundant description will be omitted.

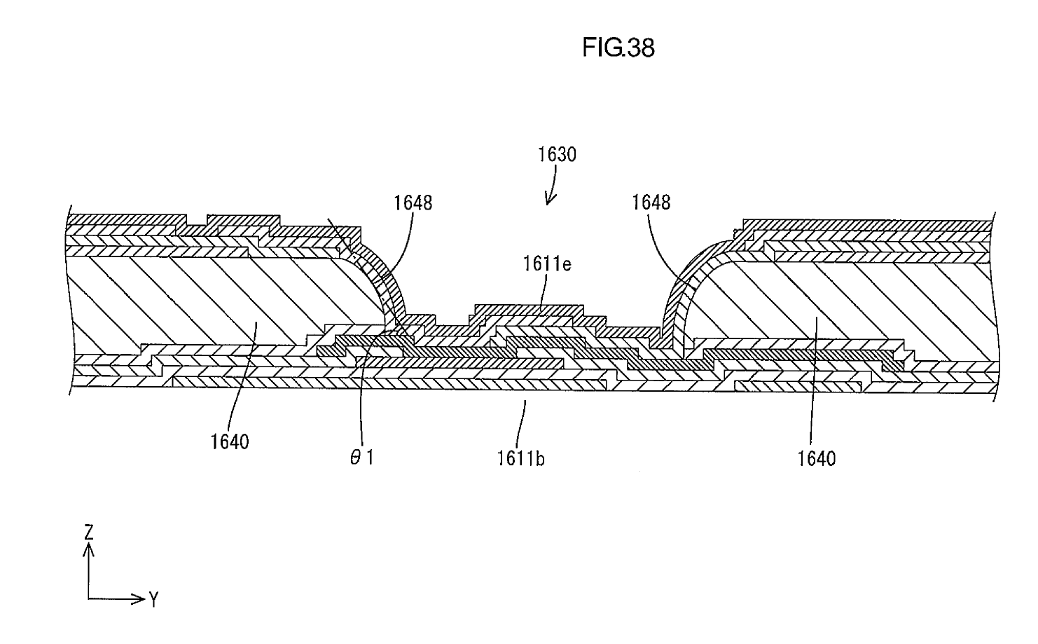

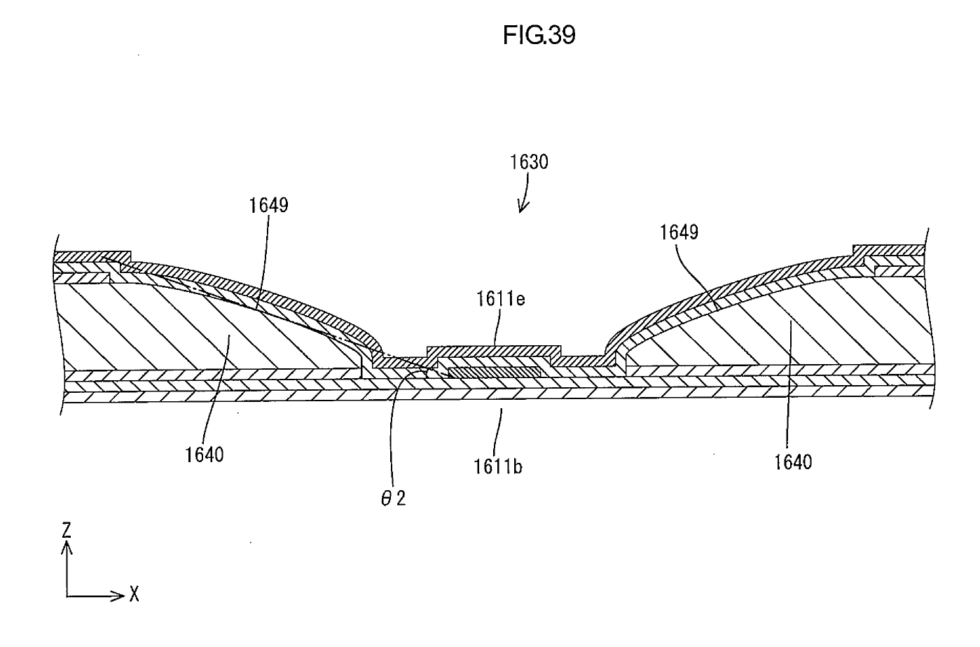

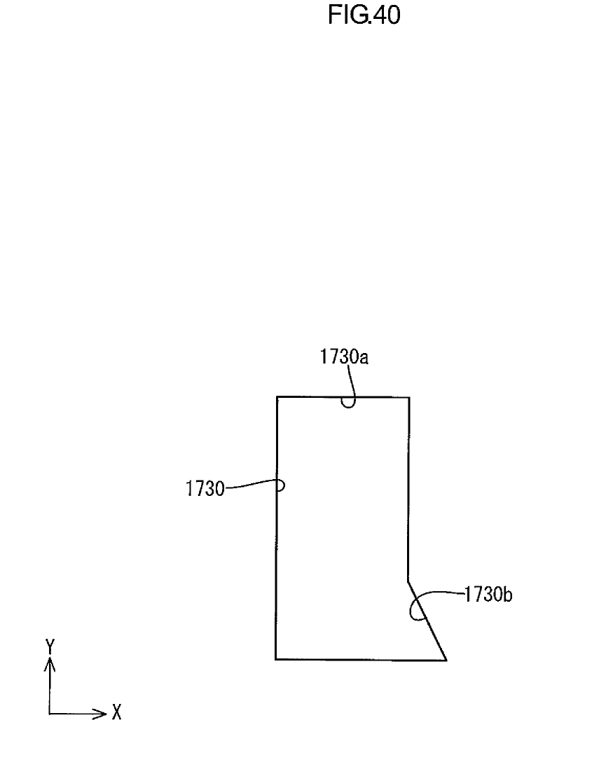

As illustrated in FIGS. 37 and 38, the first inclined portion 1648 is provided for each of a pair of edges (including second edges 1643b forming the bending portions 1643) on the short side of the edges of the expanded hole portion 1630b in addition to almost the entire range of the edges of the contact hole main portion 1630a of the lower contact hole 1630 (including first edges 1643a forming the bending portions 1643). The first inclined portion 1648 has a relatively sharp gradient with an inclination angle θ1 of approximately 41°. On the other hand, the second inclined portion 1649 is provided for just the edge on the long side among the edges of the expanded hole portion 1630b, i.e., the edge adjacent to the second edge 1643b forming the bending portion 1643 as illustrated in FIGS. 37 and 39. The second inclined portion 1649 has a relatively gentle gradient with an inclination angle θ2 of approximately 36°. Therefore, the difference in inclination angle between the first inclined portion 1648 and the second inclined portion 1649 is, for example, approximately 6°. Note that the inclination angle of each of the inclined portions 1648 and 1649 whose sectional shape is an approximately bow-like shape (approximately arc-like shape) corresponds to the angle formed by a tangential line at the center position of each of the inclined portions 1648 and 1649 (specifically at the position where the extension distance from the start end and the terminal end of the inclination is equal) relative to the Y-axis direction or the X-axis direction. In FIGS. 38 and 39, the tangential line is illustrated by a chain line. In this configuration, when the droplets of the solution for forming an alignment film 1611e having reached out of the lower contact hole 1630 spread to the inside of the lower contact hole 1630, the droplets easily flow into the second inclined portion 1649 with a less sharp gradient than the first inclined portion 1648 in the edge of the lower contact hole 1630, so that the flow (introduction) of the droplets into the lower contact hole 1630 is promoted. In addition, at the boundary between the first inclined portion 1648 and the second inclined portion 1649 with the different inclination angle in the edge of the lower contact hole 1630, i.e., at each two corners of the expanded hole portion 1630b, the fluidity of the droplets of the solution for forming the alignment film 1611e is increased because the inclination angle is different. As a result, the solution can flow into the lower contact hole 1630 more easily. Furthermore, the edge of the lower contact hole 1630 includes the bending portion 1643 curved to form a reflex angle on the inside in a plan view, and the first inclined portion 1648 is provided for each of the first edge 1643a and the second edge 1643b forming the bending portion 1643 and the second inclined portion 1649 is provided for the edge adjacent to the second edge 1643b. Due to the combination of the effect from the two inclined portions 1648 and 1649 and the effect from the bending portion 1643, the droplets of the solution for forming the alignment film can flow into the lower contact hole 1630 more easily. Therefore, defects are less likely to be developed in the alignment film 1611e and the moire is reduced or suppressed.

The two inclined portions 1648 and 1649 whose sectional shapes are inclined and whose inclination angles are different from each other are formed at the edges of the lower contact hole 1630, which are adjacent to each other, in the organic insulator 1640 provided with the lower contact hole 1630 according to this embodiment as described above. Here, in the case where the solution for forming the alignment film 1611e supplied on the outside of the lower contact hole 1630 spreads to the inside of the lower contact hole 1630, when the solution has reached the edge of the lower contact hole 1630, the solution is induced to flow into the lower contact hole 1630 by the second inclined portion 1649 with the less sharp slope and with the smaller inclination angle out of the two inclined portions 1648 and 1649 whose sectional shapes are inclined at the edge and whose inclination angles are different from each other. In addition, at the boundary between the inclined portions 1648 and 1649 with the different inclination angle in the edge of the lower contact hole 1630, the fluidity of the solution for forming the alignment film 1611e is increased because the inclination angle is different. As a result, the solution can flow into the lower contact hole 1630 more easily. Furthermore, at least a portion of the edge of the lower contact hole 1630 includes the bending portion 1643 curved to form a reflex angle on the inside in a plan view. Since the bending portion 1643 assures the easy flow of the solution for forming the alignment film 1611e into the lower contact hole 1630, the solution for forming the alignment film 1611 can flow into the lower contact hole 1630 more easily. In this case, the solution for forming the alignment film 1611e can flow into the lower contact hole 1630 sufficiently easily even though the difference in inclination angle is not set to be that large between at least two inclined portions 1648 and 1649. Therefore, the gradient of the second inclined portion 1649 with the smaller inclination angle is prevented from being too gentle and the extension distance thereof is sufficiently small. As a result, the area of the array board 1611b that does not contribute to the display is suppressed to make the display performance excellent.

### Eighteenth Embodiment

An eighteenth embodiment of the present invention will be described with reference to FIG. 40. In the eighteenth embodiment, each of lower contact holes 1730 has a shape different from the fifteenth embodiment in a plan view. Structures, functions, and effects similar to those of the fifteenth embodiment will not be described.

In the lower contact hole 1730 according to this embodiment, as illustrated in FIG. 40, one expanded hole portion 1730b is formed by extending one corner at the edge of a contact hole main portion 1730a and the planar shape of the expanded hole portion 1730b has an approximately triangular shape. Specifically, the expanded hole portion 1730b has an approximately right-angled triangular shape whose two adjacent sides have different lengths in a plan view, and has a shape tapering from the contact hole main portion 1730a in the X-axis direction, i.e., in a direction away from the contact hole main portion 1730a along an extension direction of the expanded hole portion 1730b. The apex of the expanded hole portion 1730b forming the right angle in a plan view coincides with the apex of the corner of the contact hole main portion 1730a, so that the long side and the short side that are adjacent to each other constitute a straight line with a long side and a short side of the contact hole main portion 1730, respectively. Of the edge of the expanded hole portion 1730b, the oblique side and the short side, which is included in the legs in a plan view, are opposite to each other. The distance between the oblique side and the short side is smaller along the X-axis direction as away from the contact hole main portion 1730a, and the ends of the oblique side and the short side opposite to the contact hole main portion 1730a connect to each other, thereby forming an apex of an acute angle. Therefore, when the droplets of the solution for forming the alignment film have reached both the oblique side and the short side in the edge of the expanded hole portion 1730b in the formation of the alignment film, the droplets connect to each other easily. This enables the solution for forming the alignment film to flow easily into the lower contact hole 1730. Note that the length of the short side forming one leg in the edge of the expanded hole portion 1730b is, for example, approximately 1.5 μm and the length of the long side forming the other leg is, for example, approximately 3 μm. In other words, the opening area of the expanded hole portion 1730b is set to be approximately a half of the opening area of the expanded hole portion 1430b described in the fifteenth embodiment, and the oblique side of the edge substantially coincides with the diagonal line of the expanded hole portion 1430b described in the fifteenth embodiment.

As described above, the first interlayer insulator and the organic insulator provided with the lower contact hole 1730 according to this embodiment are formed such that the expanded hole portion 1730b tapers in a direction away from the contact hole main portion 1730a in a plan view. This causes a pair of edges opposite to each other in the expanded hole portion 1730b to approach each other as away from the contact hole main portion 1730a. Therefore, when the solution for forming the alignment film has reached both the pair of openings in the formation of the alignment film, the solution connects more easily. This facilitates the flow of the solution for forming the alignment film into the lower contact hole 1730.

### Nineteenth Embodiment

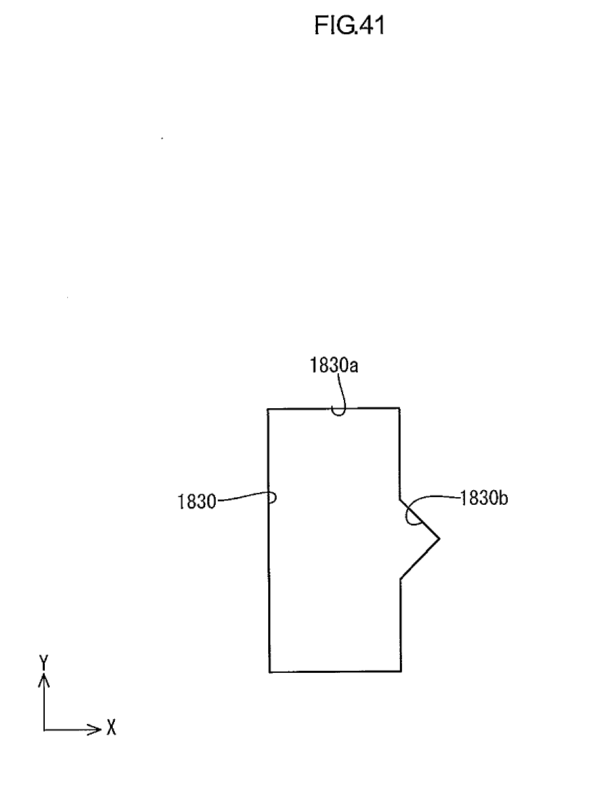

A nineteenth embodiment of the present invention will be described with reference to FIG. 41. In the nineteenth embodiment, each of lower contact holes 1830 has a shape different from the eighteenth embodiment in a plan view. Structures, functions, and effects similar to those of the eighteenth embodiment will not be described.

In the lower contact hole 1830 according to this embodiment, as illustrated in FIG. 41, one expanded hole portion 1830b is formed by extending a center portion of a long side of the edge of a contact hole main portion 1830a and the planar shape of the expanded hole portion 1830b has an approximately isosceles triangular shape. Specifically, the expanded hole portion 1830b is formed such that an apex where a pair of equal sides intersects in the edge in a plan view projects to the side opposite to the contact hole main portion 1830a side, and the contact hole main portion 1830a has a shape tapering in the X-axis direction away from the contact hole main portion 1830a. The bottom side of the edge of the expanded hole portion 1830b forms a straight line with a long side of the contact hole main portion 1830a. A pair of equal sides of the edge of the expanded hole portion 1830b is opposite to each other. The distance between the pair of equal sides is smaller as away from the contact hole main portion 1830a in the X-axis direction. The ends of the equal sides opposite to the contact hole main portion 1830a side connect to each other, thereby forming an apex with an acute angle. Therefore, when the droplets of the solution for forming the alignment film have reached both the equal sides of the edge of the expanded hole portion 1830b in the formation of the alignment film, the droplets are connected to each other more easily. This enables the solution for forming the alignment film to flow into the lower contact hole 1830 easily. Note that the length of a perpendicular line from an apex of the expanded hole portion 1830b is, for example, approximately 1.5 μm and the bottom line has a length of, for example, approximately 3 μm.

### Twentieth Embodiment

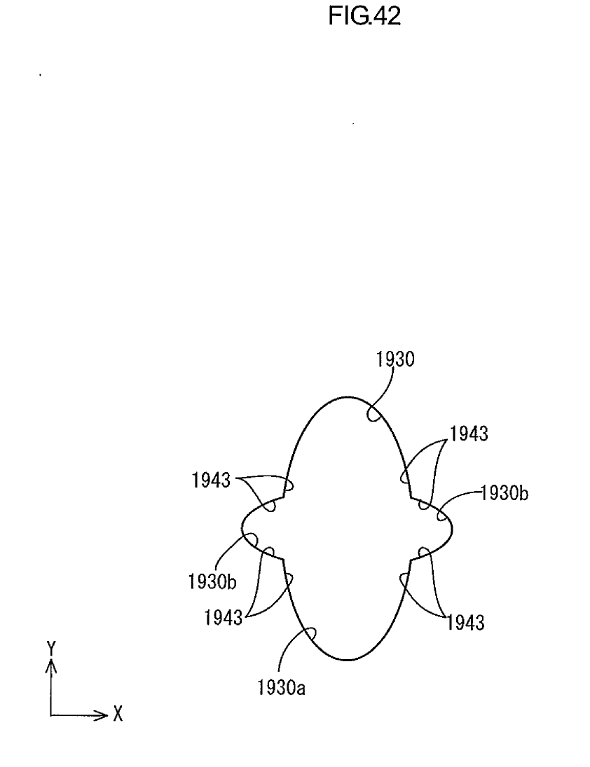

A twentieth embodiment of the present invention will be described with reference to FIG. 42. In the twentieth embodiment, each of lower contact holes 1930 has a shape different from the fifteenth embodiment in a plan view. Structures, functions, and effects similar to those of the fifteenth embodiment will not be described.

In the lower contact hole 1930 according to this embodiment, as illustrated in FIG. 42, a contact hole main portion 1930a has an approximately elliptical shape in a plan view and an expanded hole portion 1930b has an approximately elliptical bow-like shape in a plan view. Specifically, the contact hole main portion 1930a has a vertically-long approximately elliptical shape in a plan view, and has a minor-axis length of, for example, approximately 5 μm and a major-axis length of, for example, approximately 10 μm. A pair of expanded hole portions 1930b is formed by extending a center of the edge of the contact hole main portion 1930a in the major-axis direction (Y-axis direction) to both sides in the minor-axis direction (X-axis direction). In other words, the lower contact hole 1930 is formed such that the planar shape follows the external shape obtained by overlapping two ellipses with a different size with their major axes and minor axes orthogonal to each other. The expanded hole portion 1930b projects from the contact hole main portion 1930a by approximately 1.5 μm in the X-axis direction, and has an opening width of approximately 3 μm. In the configuration as above, two bending portions 1943 are formed by one expanded hole portion 1930b, which is similar to the eighth embodiment; therefore, the droplets of the solution for forming the alignment film flow into the lower contact hole 1930 more easily.

As described above, the first interlayer insulator and the organic insulator provided with the lower contact hole 1930 according to this embodiment are formed such that the planar shape of the contact hole main portion 1930a is elliptical. Since the sides intersecting with each other do not exist in the edge of the contact hole main portion 1930a with an elliptical planar shape, the solution for forming the alignment film having reached the edge of the contact hole main portion 1930a does not easily connect and does not easily flow into the lower contact hole 1930. In this regard, when the expanded hole portion 1930b is formed by extending a portion of the contact hole main portion 1930a, the solution for forming the alignment film can flow into the lower contact hole 1930 sufficiently easily.

### Twenty-First Embodiment

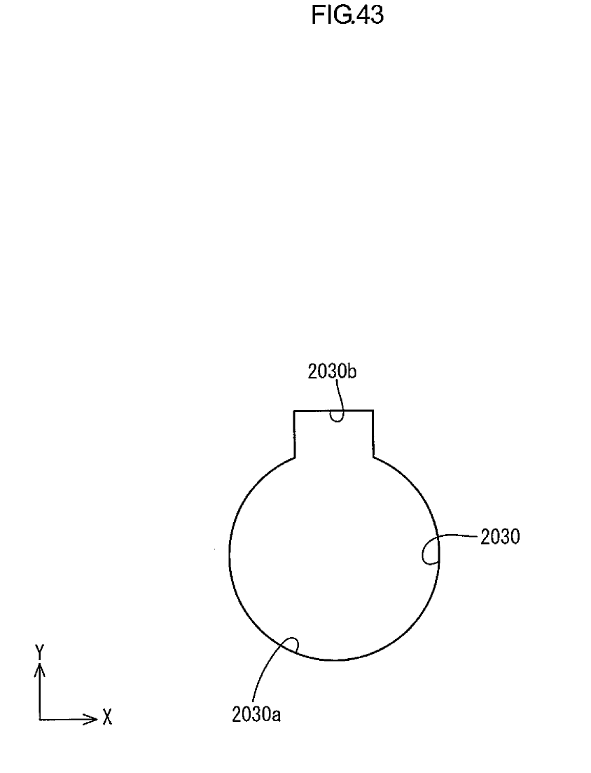

A twenty-first embodiment of the present invention will be described with reference to FIG. 43. In the twenty-first embodiment, each of lower contact holes 2030 has a shape different from that of the fifteenth embodiment in a plan view. Structures, functions, and effects similar to those of the fifteenth embodiment will not be described.

In the lower contact hole 2030 according to this embodiment, as illustrated in FIG. 43, a contact hole main portion 2030a has an approximately circular shape in a plan view and an expanded hole portion 2030b has a rectangular shape in a plan view. Specifically, the contact hole main portion 2030a has an approximately circular shape with a diameter of, for example, 8 μm in a plan view. The expanded hole portion 2030b has a horizontally-long rectangular shape in a plan view, and is formed by extending an upper part of the edge of the contact hole main portion 2030a in the Y-axis direction as illustrated in FIG. 43. The expanded hole portion 2030b has a short dimension (length of projection in the Y-axis direction from the contact hole main portion 2030a) of, for example, approximately 1.5 μm and a long dimension (opening width) of, for example, approximately 3 μm. In such a configuration, two bending portions 2043 are formed by one expanded hole portion 2030b, which is similar to the eighth embodiment, so that the droplets of the solution for forming the alignment film flow into the lower contact hole 2030 more easily in the formation of the alignment film.

The first interlayer insulator and the organic insulator provided with the lower contact hole 2030 according to this embodiment are formed such that the contact hole main portion 2030a has a circular planar shape. Since the sides intersecting with each other do not exist in the edge of the contact hole main portion 2030a with a circular planar shape, the solution for forming the alignment film having reached the edge of the contact hole main portion 2030a does not easily connect and does not easily flow into the lower contact hole 2030. In this regard, when the expanded hole portion 2030b is formed by extending a portion of the contact hole main portion 2030a, the solution for forming the alignment film can flow into the lower contact hole 2030 sufficiently easily.

### Twenty-Second Embodiment

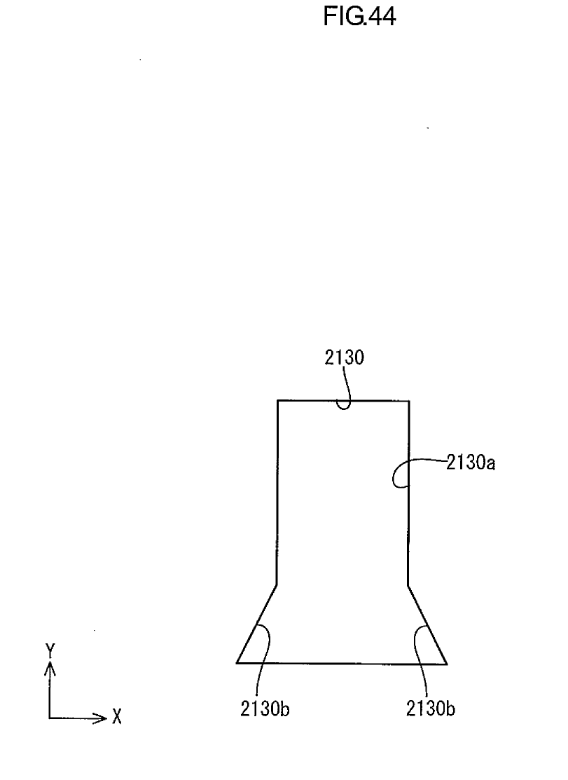

A twenty-second embodiment of the present invention will be described with reference to FIG. 44. In the twenty-second embodiment, each of lower contact holes 2130 includes the number of expanded hole portions 2130b different from the eighteenth embodiment. Structures, functions, and effects similar to those of the eighteenth embodiment will not be described.

The lower contact hole 2130 according to this embodiment is formed such that a pair of expanded hole portions 2130b is formed by extending a pair of corners sharing one short side of the edge of a contact hole main portion 2130a as illustrated in FIG. 44. The pair of expanded hole portions 2130b forms an approximately right-angled triangular shape in a plan view, and a linearly-symmetrical shape in a plan view. This causes the lower contact hole 2130 to form a linearly-symmetrical shape in a plan view.

### Twenty-Third Embodiment

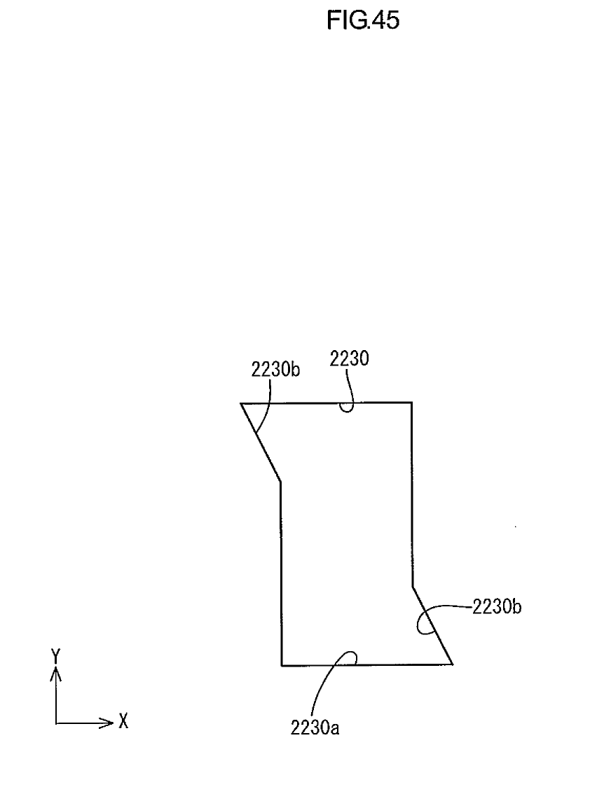

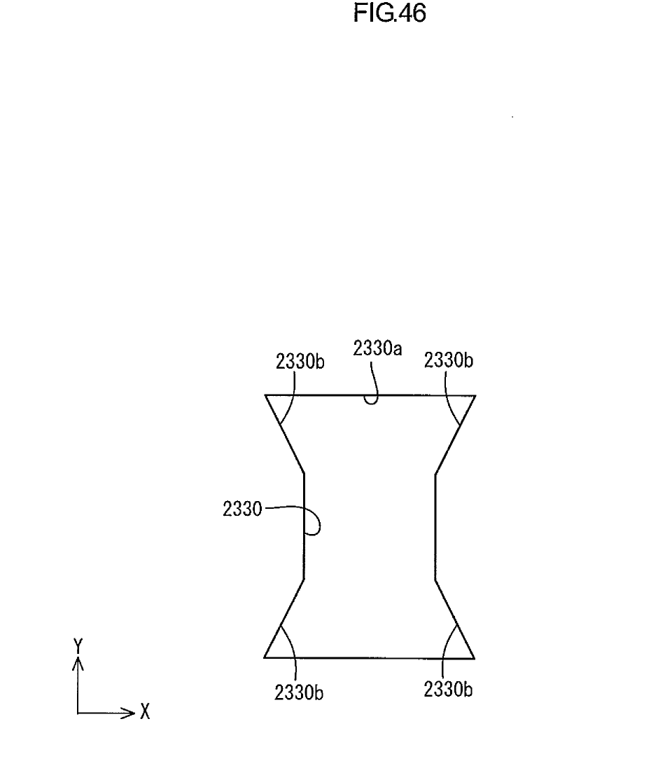

A twenty-third embodiment of the present invention will be described with reference to FIG. 45. In the twenty-third embodiment, each of lower contact holes 2230 includes expanded hole portions 2230b at positions different from the twenty-second embodiment. Structures, functions, and effects similar to those of the twenty-second embodiment will not be described.

In the lower contact hole 2230 according to this embodiment, a pair of expanded hole portions 2230b is formed by extending a pair of diagonal corners of the edge of a contact hole main portion 2230a as illustrated in FIG. 45. The pair of expanded hole portions 2230b forms an approximately right-angled triangular shape in a plan view and forms a point-symmetrical shape in a plan view. Thus, the lower contact hole 2230 has a point-symmetrical shape in a plan view.

### Twenty-Fourth Embodiment

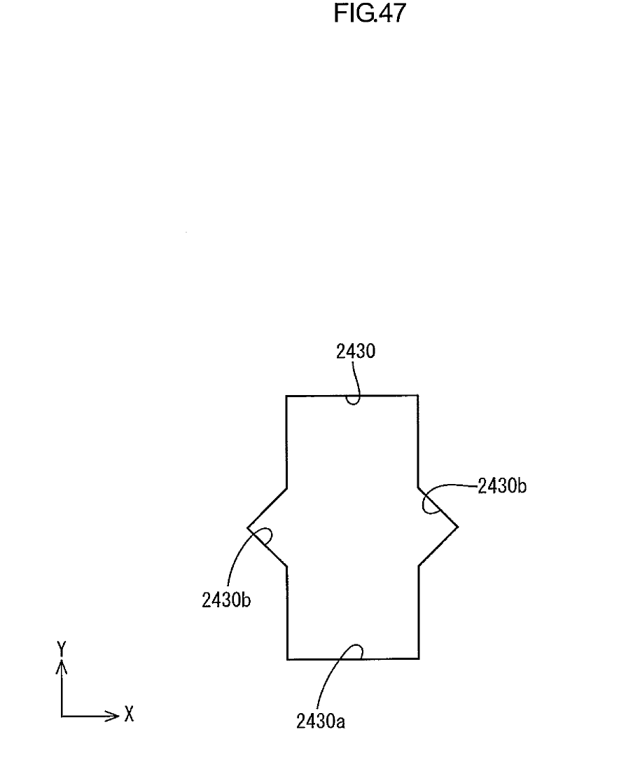

A twenty-fourth embodiment of the present invention will be described with reference to FIG. 46. In the twenty-fourth embodiment, each of lower contact holes 2330 includes the number of expanded hole portions 2330b different from the twenty-second embodiment. Structure, functions, and effects similar to those of the twenty-second embodiment will not be described.

In the lower contact hole 2330 according to this embodiment, four expanded hole portions 2330b are formed by extending four corners of the edge of a contact hole main portion 2330a as illustrated in FIG. 46. Each of the four expanded hole portions 2330b forms an approximately right-angled triangular shape in a plan view, and forms a line-symmetrical or point-symmetrical shape in a plan view. Thus, the lower contact hole 2330 has a linearly-symmetrical shape and a point-symmetrical shape in a plan view.

### Twenty-Fifth Embodiment

A twenty-fifth embodiment of the present invention will be described with reference to FIG. 47. In the twenty-fifth embodiment, each of lower contact holes 2430 includes the number of expanded hole portions 2430b different from the nineteenth embodiment. Structures, functions, and effects similar to those of the nineteenth embodiment will not be described.

In the lower contact hole 2430 according to this embodiment, a pair of expanded hole portions 2430b is formed by extending a center portion of each of a pair of long sides of the edge of a contact hole main portion 2430a as illustrated in FIG. 47. The pair of expanded hole portions 2430b forms an approximately isosceles triangular shape in a plan view and forms a line-symmetrical shape and a point-symmetrical shape in a plan view. Thus, the lower contact hole 2430 forms a line-symmetrical shape and a point-symmetrical shape in a plan view.

### Twenty-Sixth Embodiment

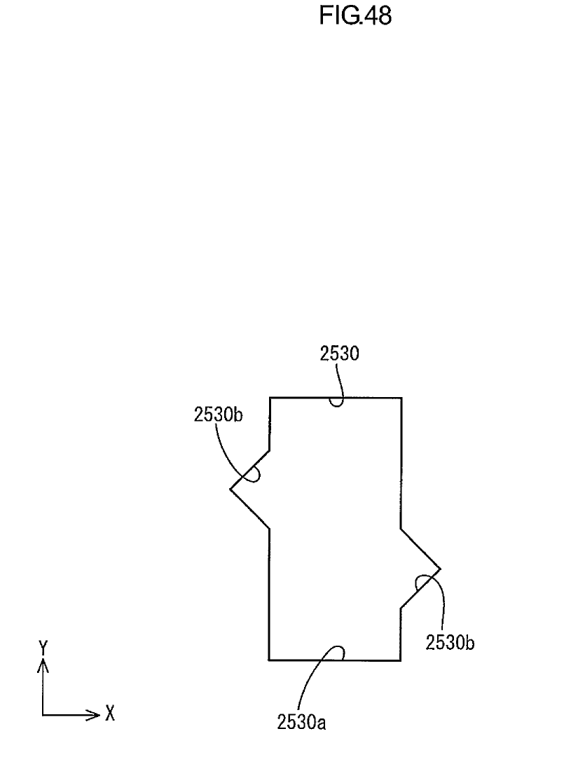

A twenty-sixth embodiment of the present invention will be described with reference to FIG. 48. In The twenty-sixth embodiment, each of lower contact holes 2530 include the number of expanded hole portions 2530b different from the twenty-fifth embodiment. Structures, functions, and effects similar to those of the twenty-fifth embodiment will not be described.

In the lower contact hole 2530 according to this embodiment, a pair of expanded hole portions 2530b is formed by extending a portion of a pair of long sides of the edge of a contact hole main portion 2530a closer to the end as illustrated in FIG. 48. The pair of expanded hole portions 2530b is disposed near a pair of diagonal corners in the edge of the contact hole main portion 2530a, and forms a point-symmetrical shape in a plan view. Thus, the lower contact hole 2530 forms a point-symmetrical shape in a plan view.

### Twenty-Seventh Embodiment

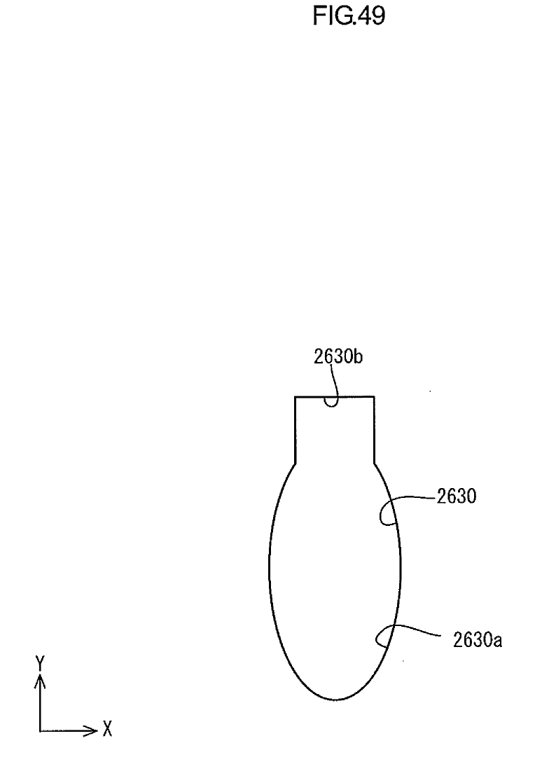

A twenty-seventh embodiment of the present invention will be described with reference to FIG. 49. In the twenty-seventh embodiment, lower contact holes 2630 include expanded hole portions 2630b, respectively. Each of the expanded hole portions 2630b has a shape different from the twentieth embodiment in a plan view. Structures, functions, and effects similar to those of the twentieth embodiment will not be described.

In the lower contact hole 2630 according to this embodiment, as illustrated in FIG. 49, one expanded hole portion 2630b is formed by extending a center of the edge of a contact hole main portion 2630a in regard to a minor-axis direction (X-axis direction) to one side along the major-axis direction (Y-axis direction). The expanded hole portion 2630b forms a horizontally-long rectangular shape in a plan view and has a short dimension of, for example, approximately 1.5 μm and a long dimension of, for example, approximately 3 μm.

### Twenty-Eighth Embodiment

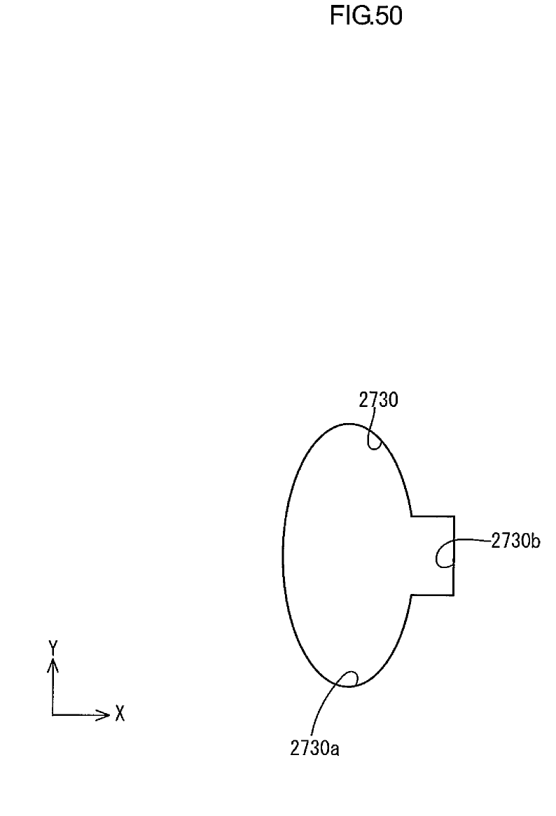

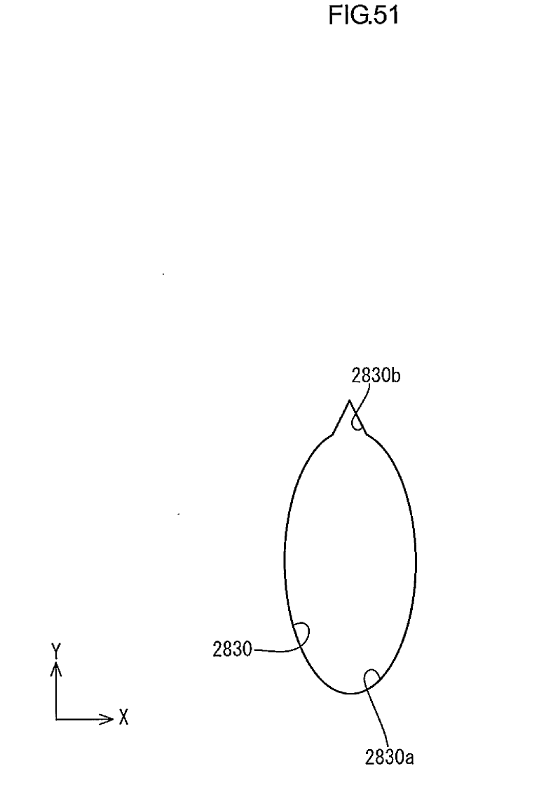

A twenty-eighth embodiment of the present invention will be described with reference to FIG. 50. In the twenty-eighth embodiment, lower contact holes 2730 include expanded hole portions 2730b at positions differently from the twenty-seventh embodiment. Structures, functions, and effects similar to those of the twenty-seventh embodiment will not be described.

In the lower contact hole 2730 according to this embodiment, as illustrated in FIG. 50, one expanded hole portion 2730b with a vertically-long rectangular shape in a plan view is formed by extending a center of the edge of a contact hole main portion 2730a in a major-axis direction (Y-axis direction) to one side along the minor-axis direction (X-axis direction).

### Twenty-Ninth Embodiment

A twenty-ninth embodiment of the present invention will be described with reference to FIG. 51. In the twenty-ninth embodiment, each of lower contact holes 2830 includes an expanded hole portion 2830b having a shape different from the twenty-seventh embodiment in a plan view. Structures, functions, and effects similar to those of the twenty-seventh embodiment will not be described.

In the lower contact hole 2830 according to this embodiment, as illustrated in FIG. 51, the expanded hole portion 2830b formed by extending an edge of a contact hole main portion 2830a with an approximately elliptical shape in a plan view has a planar shape that is an approximately isosceles triangular shape. The expanded hole portion 2830b is disposed such that an apex at which a pair of equal sides intersects with each other in the edge in a plan view projects to the side opposite to the contact hole main portion 2830a side, and has a shape tapering in a Y-axis direction away from the contact hole main portion 2830a. A pair of equal sides of the edge of the expanded hole portion 2830b is opposite to each other, and the distance between the equal sides is smaller as away from the contact hole main portion 2830a in the Y-axis direction. The ends of the equal sides opposite to the contact hole main portion 2830a connect to each other, thereby forming an apex with an acute angle. Thus, the droplets of the solution for forming the alignment film having reached both the equal sides in the edge of the expanded hole portion 2830b easily connect to each other. This enables the solution for forming the alignment film to flow into the lower contact hole 2830 more easily.

### Thirtieth Embodiment

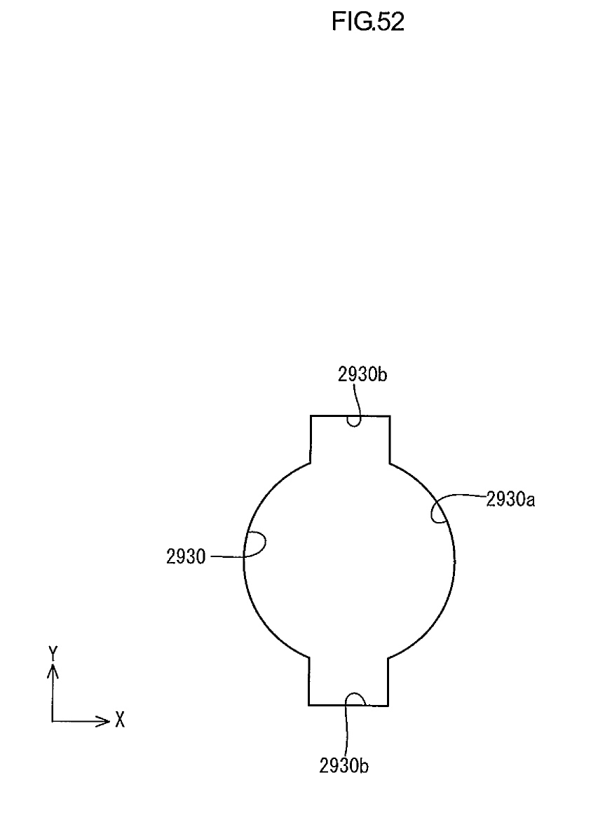

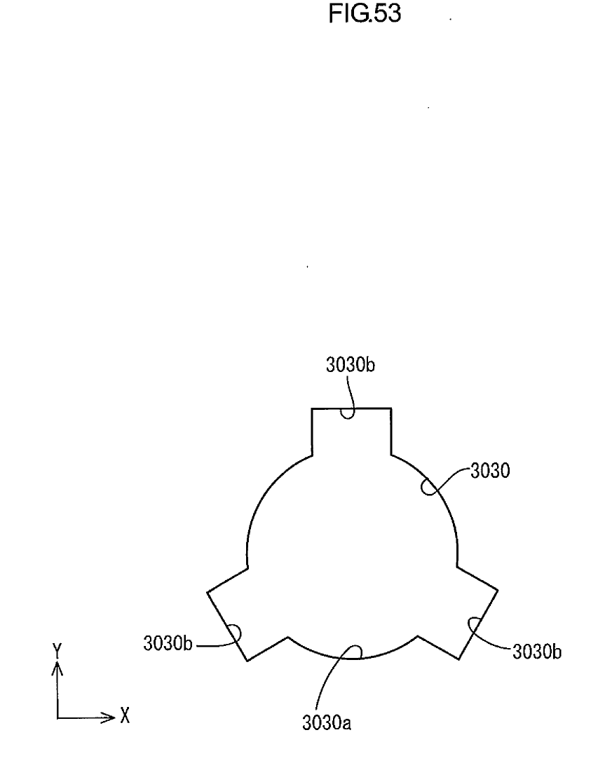

A thirtieth embodiment of the present invention will be described with reference to FIG. 52. In the twenty-eighth embodiment, each of lower contact holes 2930 includes the number of expanded hole portions 2930b different from the twenty-first embodiment. Structures, functions, and effects similar to those of the twenty-first embodiment will not be described.

In the lower contact hole 2930 according to this embodiment, a pair of expanded hole portions 2930b is formed at the positions spaced apart from each other by an angle of approximately 180° in the edge of a contact hole main portion 2930a with an approximately circular shape in a plan view as illustrated in FIG. 52. The pair of expanded hole portions 2930b forms a linearly-symmetrical shape and a point-symmetrical shape in a plan view. Thus, the lower contact hole 2930 forms a linearly-symmetrical shape and a point-symmetrical shape in a plan view.

### Thirty-First Embodiment

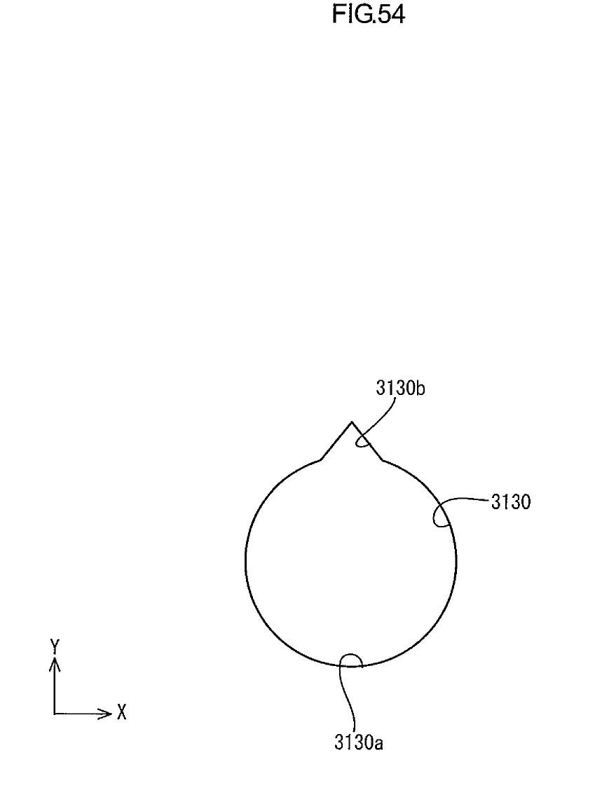

A thirty-first embodiment of the present invention will be described with reference to FIG. 53. In the thirty-first embodiment, each of lower contact holes 3030 includes the number of expanded hole portions 3030b different from the thirtieth embodiment. Structures, functions, and effects similar to those of the thirtieth embodiment will not be described.

In the lower contact hole 3030 according to this embodiment, three expanded hole portions 3030b are formed at the positions spaced apart from each other by an angle of approximately 120° in the edge of a contact hole main portion 3030a with an approximately circular shape in a plan view as illustrated in FIG. 53. The three expanded hole portions 3030b are disposed at the positions with the equal angular space therebetween at the edge of the contact hole main portion 3030a. Thus, the lower contact hole 3030 forms a point-symmetrical shape in a plan view.

### Thirty-Second Embodiment

A thirty-second embodiment of the present invention will be described with reference to FIG. 54. The thirty-second embodiment includes lower contact holes 3130 each including the different number of expanded hole portions 3130b from the twenty-first embodiment. Structures, functions, and effects similar to those of the twenty-first embodiment will not be described.

In the lower contact hole 3130 according to this embodiment, as illustrated in FIG. 54, the expanded hole portion 3130b formed by extending an edge of a contact hole main portion 3130a with an approximately circular shape in a plan view has a planar shape that is an approximately isosceles triangular shape. The expanded hole portion 3130b is disposed such that an apex at which a pair of equal sides intersects with each other in the edge in a plan view projects to the side opposite to the contact hole main portion 3130a, and has a shape tapering in a Y-axis direction away from the contact hole main portion 3130a. A pair of equal sides of the edge of the expanded hole portion 3130b is opposite to each other, and the distance between the equal sides is smaller as away from the contact hole main portion 3130a in the Y-axis direction. The ends of the equal sides opposite to the contact hole main portion 3130a connect to each other, thereby forming an apex with an acute angle. The droplets of the solution for forming the alignment film having reached both the equal sides in the edge of the expanded hole portion 3130b easily connect to each other easily. This enables the solution for forming the alignment film to flow into the lower contact hole 3130 more easily.

### Thirty-Third Embodiment

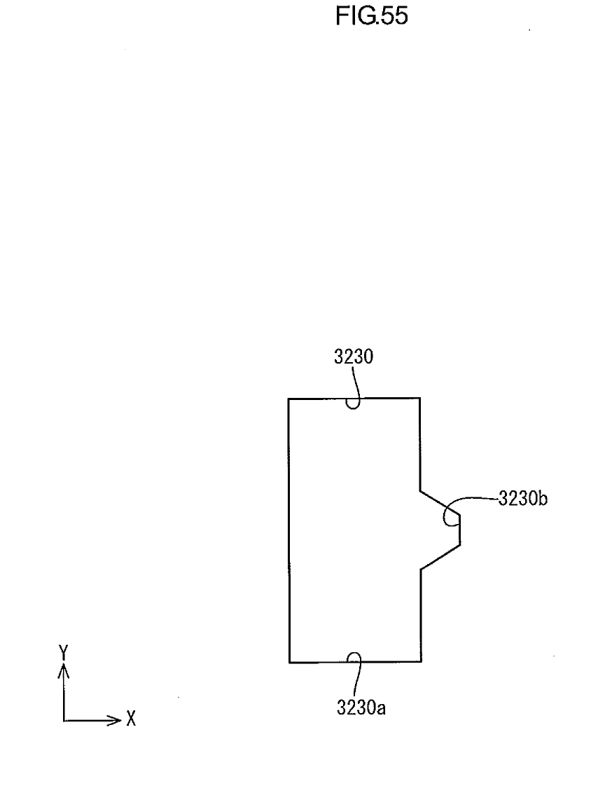

A thirty-third embodiment of the present invention will be described with reference to FIG. 55. In the thirty-third embodiment, each of lower contact holes 3230 has an expanded hole portion 3230b having a shape different from the nineteenth embodiment in a plan view. Structures, functions, and effects similar to those of the nineteenth embodiment will not be described.

In the lower contact hole 3230 according to this embodiment, as illustrated in FIG. 55, the expanded hole portion 3230b formed by extending one long side of the edge of a contact hole main portion 3230a with a vertically-long rectangular shape in a plan view has an approximately trapezoidal shape in a plan view. Specifically, the planar shape of the expanded hole portion 3230b is an approximately isosceles trapezoidal shape and an upper side of the edge is disposed projecting to the side opposite to the contact hole main portion 3230a, and has a shape tapering in the X-axis direction as away from the contact hole main portion 3230a. A lower side of the edge of the expanded hole portion 3230b forms a straight line with a long side of the contact hole main portion 3230a. A pair of opposite sides of the edge of the expanded hole portion 3230b, which is inclined relative to a pair of bottom sides, is opposite to each other, and the distance between the opposite sides is smaller as away from the contact hole main portion 3230a in the X-axis direction. The droplets of the solution for forming the alignment film having reached both the pair of opposite sides in the edge of the expanded hole portion 3230b easily connect to each other. This enables the solution for forming the alignment film to flow into the lower contact hole 3230 more easily. The distance between the pair of bottom sides of the expanded hole portion 3230b is, for example, 1.5 μm and the lower side has a length of, for example, approximately 3 μm.

### Other Embodiment

The present invention is not limited to the above embodiments described with reference to the drawings. The following embodiments may be included in the technical scope of the present invention.

(1) The specific angle formed on the inside by the first edge and the second edge in the bending portion can be changed as appropriate within the range of reflex angles and may be different from the angles described in the drawings in the above embodiments.

(2) Each of the first edge and the second edge forming the bending portion constitutes the straight line in a plan view in the above embodiments. However, each of the first edge and the second edge forming the bending portion may constitute a curved line alternatively.

(3) The planar shapes of the contact hole main portion and the expanded hole portion may be changed to be different from those described in the above embodiments. Specifically, the planar shapes of the contact hole main portion and the expanded hole portion may be, for example, a square shape, a triangular shape, a polygonal shape with five or more sides, a diamond-like shape, a parallelogram, a circular shape, an elliptical shape, or the like.

(4) The planar arrangement of the expanded hole portion relative to the contact hole main portion can be changed as appropriate, which may be different from the arrangements described in the above embodiments. The number of expanded hole portions and the size thereof in a plan view may also be changed as appropriate.

(5) The planar arrangement of the expanded hole portion of the upper contact hole relative to the pixel structure (gate electrode, drain electrode, channel, opening of the insulator, gate line, pixel electrode, common electrode, drain line, upper contact hole, or the like) can be changed as appropriate, which may be different from the arrangements described in the above embodiments.

(6) The planar arrangement, the planar shape, and the range of formation of the upper contact hole may be changed to be different from those of the above embodiments. For example, the upper contact hole may overlap the expanded hole portion of the lower contact hole in a plan view. The upper contact hole can overlap the lower contact hole in a plan view. In this case, the planar shape of the upper contact hole can be the same as that of the lower contact hole, and thus, the upper contact hole can be used as a mask in patterning the lower contact hole.

(7) Although the second and fourteenth embodiments have described the case in which the organic insulator is patterned using the gray tone mask, the organic insulator can alternatively be patterned using a halftone mask including a semitransmissive film.

(8) Although the alignment film is applied on the array board using the inkjet device or the screen printing device in the above embodiments, the alignment film may be applied on the array board by alternatively using an offset printing device, a relief printing device, an intaglio printing device, a lithographic printing device, or the like. Note that the device for applying the alignment film on the CF board side is preferably the same as that on the array board side.

(9) Although polyimide is used as the material of the alignment film in the above embodiments, other liquid crystal aligning materials than polyimide may be used for the alignment film.

(10) Although the above embodiments have described the case in which the light aligning material is used as the material of the alignment film and the light alignment film is subjected to the alignment process with the UV irradiation, the present invention is also applicable to the alignment film which is subjected to the alignment process with the rubbing.

(11) The display area side contact hole overlaps the drain electrode of the TFT in a plan view and the pixel electrode is directly connected to the drain electrode in the above embodiments. However, the display area side contact hole may be provided not overlapping the drain electrode in a plan view but overlapping the drain line (including capacitance formation portion) in a plan view and the pixel electrode may be connected to the drain line.

(12) Although the above embodiments have described that the TFT is disposed over the gate line, the TFT may be provided not overlapping the gate line in a plan view in the present invention. In this case, the gate electrode may be formed branched off the gate line.

(13) Although the above embodiments have described a portion of the TFT is disposed over the source line, the TFT may be provided not overlapping the source line in a plan view in the present invention. In this case, the source electrode may be formed branched off the source line.

(14) Although the above embodiments have described the gate line and the auxiliary capacitor line are disposed with the center of the pixel electrode sandwiched therebetween in a plan view, the auxiliary capacitor line may be disposed across the center of the pixel electrode in the length direction.

(15) In the above embodiments, the bending portion (at least two inclined portions) is provided for the edge of the non-display area side contact hole for connecting the row control circuit and the gate line. However, when the non-display area side contact hole is formed at the portion where the column control circuit and the source line are connected, the bending portion (at least two inclined portions) can be provided for the edge of the non-display area side contact hole. In addition, when the non-display area side contact hole is provided for connecting the line formed from the first metal film and the line formed from the second metal film in the non-display area, the bending portion (at least two inclined portions) can be included in the edge.

(16) The arrangement and the number of row control circuits on the array board can be changed to be different from those of the above embodiments. For example, in the present invention, the row control circuit may be disposed adjacent to the right side of the display area on the array board as illustrated in FIG. 4 or a pair of row control circuits may be disposed having the display area on the array board horizontally sandwiched therebetween.

(17) The specific materials of the gate insulator, the protection film, the first interlayer insulator, the organic insulator, and the second interlayer insulator can be changed as appropriate to be different from those of the above embodiments.

(18) In the above embodiments, the oxide semiconductor film is the oxide thin film containing indium (In), gallium (Ga), and zinc (Zn); however, another kind of oxide semiconductor material can be used. Specifically, an oxide containing indium (In), silicon (Si), and zinc (Zn), an oxide containing indium (In), aluminum (Al), and zinc (Zn), an oxide containing tin (Sn), silicon (Si), and zinc (Zn), an oxide containing tin (Sn), aluminum (Al), and zinc (Zn), an oxide containing tin (Sn), gallium (Ga), and zinc (Zn), an oxide containing gallium (Ga), silicon (Si), and zinc (Zn), an oxide containing gallium (Ga), aluminum (Al), and zinc (Zn), an oxide containing indium (In), copper (Cu), and zinc (Zn), an oxide containing tin (Sn), copper (Cu), and zinc (Zn), or the like can be used.

(19) The first metal film and the second metal film are formed from a multilayer film of titanium (Ti) and copper (Cu) in the above embodiments. However, titanium may be replaced by molybdenum (Mo), molybdenum nitride (MoN), titanium nitride (TiN), tungsten (W), niobium (Nb), molybdenum-titanium alloy (MoTi), molybdenum-tungsten alloy (MoW), or the like. Alternatively, a single-layer metal film of titanium, copper, aluminum, or the like can be used.

(20) The above embodiments have described the liquid crystal panel whose operation mode is the FFS mode. However, the present invention is also applicable to a liquid crystal panel whose operation mode is the IPS (In-Plane Switching) mode or the VA (Vertical Alignment) mode.

(21) The above embodiments have described that the display area on the liquid crystal panel is in the center in regard to the short dimension but is deviated to one end in regard to the long dimension. However, the present invention includes a liquid crystal panel whose display area is in the center in regard to the long dimension but is deviated to one end in regard to the short dimension. Furthermore, the present invention includes a liquid crystal panel whose display area is deviated to one end in regard to each of the long dimension and the short dimension. On the contrary, the present invention also includes a liquid crystal panel whose display area is in the center in regard to each of the long dimension and the short dimension.

(22) Although the driver is mounted by the COG method directly on the array board in the above embodiments, the driver may be mounted on the flexible board connected to the array board through ACF in the present invention.

(23) Although the row control circuit and column control circuit are provided in the non-display area of the array board in the above embodiments, one of or both the row control circuit and the column control circuit may be omitted and the function can be achieved by the driver. If the row control circuit will be omitted, the non-display area side contact hole will be also omitted.

(24) Although the embodiments exemplarily describe the liquid crystal panel with a vertically-long rectangular shape, the present invention is also applicable to the liquid crystal panel with a horizontally-long rectangular shape or a square shape.

(25) The present invention also includes the liquid crystal panel according to any of the above embodiments to which a functional panel such as a touch panel or a parallax barrier panel (switch liquid crystal panel) is attached. Moreover, the present invention includes a liquid crystal panel provided with a touch panel pattern directly.

(26) Although the backlight device of the liquid crystal display device is the edge-light type in the above embodiments, the device may be a direct backlight device in the present invention.

(27) Although the above embodiments exemplarily describe the transmissive type liquid crystal display device provided with the backlight device as an external light source, the present invention is also applicable to a reflective liquid crystal display device performing display with external light, in which case the backlight device can be omitted.

(28) Although the above embodiments employ the TFT as a switching component of the liquid crystal display device, other switching components than the TFT (such as a thin film diode (TFD)) can be applied and moreover the present invention can be applied to a liquid crystal display device performing monochromatic display in addition to the liquid crystal display device performing color display.

(29) Although the above embodiments exemplarily describe the liquid crystal panel with liquid crystal held between a pair of substrates and having the alignment film for controlling the alignment of the liquid crystal, the present invention is also applicable to the display panel having the alignment film for controlling the alignment of other functional organic molecules than the liquid crystal.

(30) The above embodiments include the liquid crystal panels that are classified as small sized or small to middle sized panels. Such liquid crystal panels are used in electronic devices including PDAs, mobile phones, laptop computers, digital photo frames, portable video games, and electronic ink papers. However, liquid crystal panels that are classified as middle sized or large sized (or supersized) panels having screen sizes from 20 inches to 90 inches are also included in the scope of the present invention. Such display panels may be used in electronic devices including television devices, electronic signboards (digital signage), and electronic blackboard.

(31) The bending portion, or the first inclined portion and the second inclined portions are provided for the edge of the lower contact hole included in the display area side contact hole in the second and sixth to fourteenth embodiments. However, the bending portion, or the first inclined portion and the second inclined portions, which are similar to those of the second and sixth to fourteenth embodiments, can be provided for the edge of the non-display area side contact hole.

(32) The same number of first inclined portions and second inclined portions (in pairs) are formed in the fourteenth embodiment; however, the number of first inclined portions and the number of second inclined portions may be different. Specifically, the first inclined portion or second inclined portion is provided for each of any three sides of the edges on the four sides in the lower contact hole (non-display area side contact hole), and the other one side is provided with the second inclined portion or the first inclined portion. The number of first inclined portions and the number of second inclined portions may be different similarly when the planar shape of the lower contact hole has changed to be other shape than the rectangular shape. The planar arrangement of the first inclined portions and the second inclined portions in the edge of the lower contact hole can be changed as appropriate.

(33) The two inclined portions (first inclined portion and second inclined portion) with the different inclination angles are formed at the edge of the lower contact hole in the fourteenth embodiment. However, in the present invention, three or more inclined portions with different inclination angles (specifically, at least the first inclined portion, the second inclined portion, and a third inclined portion with an inclination angle different from both the first inclined portion and the second inclined portion) may be provided for the edge of the lower contact hole (non-display area side contact hole).

(34) The configuration according to the fourteenth embodiment can be combined with the configuration according to any of the first to thirteenth embodiments. In this case, the bending portion, and the first inclined portion and the second inclined portion are provided for the edge of the lower contact hole (non-display area side contact hole).

(35) The specific dimensions of the contact hole main portions and the expanded hole portions described in the fifteenth to thirty-third embodiments can be changed as appropriate. Specifically, when the dimensions of the contact hole main portions and the expanded hole portions described in the fifteenth, seventeenth to twentieth, twenty-second to twenty-ninth, and thirty-third embodiments are changed, for example, the ratio between the long dimension and the short dimension in the contact hole main portion is preferably set to be equal to that in the expanded hole portion. Needless to say, the ratio between the long dimension and the short dimension in the contact hole main portion may be set not to be equal (be unequal) to that in the expanded hole portion. When the dimensions of the contact hole main portions and the expanded hole portions described in the sixteenth, twenty-first, and thirtieth to thirty-second embodiments are changed, the ratio among the dimensions can be changed as appropriate. The contact hole main portion and the expanded hole portion according to any of the fifteenth to thirty-third embodiments can have a shape with their short side (minor axis) and long side (major axis) inverted, and moreover, the expanded hole portion may have a planar shape without the long side and the short side, specifically a square or a semi-circular shape in the present invention. Furthermore, the configuration according to any of the fifteenth to thirty-third embodiments can be combined with the configuration according to any of the first to fourteenth embodiments.

(36) In the seventeenth embodiment, the second inclined portion is provided for just the edge of one side which is included in the expanded hole portion and which is adjacent to the second edge included in the bending portion in the edge of the lower contact hole in the organic insulator. However, the second inclined portion may be formed by being extended to the second edge, i.e., a portion of the bending portion or the second inclined portion can be formed by being extended to the first edge and the second edge, i.e., the entire region of the bending portion. Furthermore, the range and the position of forming the second inclined portion in the edge of the lower contact hole in the organic insulator can be changed as appropriate. In particular, it is preferable that the second inclined portion is formed in at least one of the first edge and the second edge included in the bending portion or the edge adjacent to at least one of the first edge and the second edge included in the bending portion because the effect obtained from the bending portion is obtained in addition to the effect obtained from the first inclined portion and the second inclined portion.

(37) The arrangement and the range of forming the first inclined portion and the second inclined portion in the edge of the lower contact hole in the organic insulator can be changed as appropriate to be different from those described in (36).

The present invention is not limited to the above embodiments explained in the above description. The following embodiments may be included in the technical scope of the present invention, for example.

### EXPLANATION OF SYMBOLS

11: Liquid crystal panel (display device)
11a: CF board (opposite board)
11b, 211b, 1311b, 1611b: Array board (display component)
11c: Liquid crystal layer (liquid crystal)
11e, 111e, 1311e, 1611e: Alignment film
17a, 317a, 417a: Gate electrode
17b: Source electrode
17c, 317c, 417c: Drain electrode
17d: Channel
18, 118, 318, 418, 1318: Pixel electrode
24, 1324: Second transparent electrode film (second conductive film)
25: Auxiliary capacitor line
30, 130, 330, 430, 530, 630, 730, 830, 930, 1030, 1130, 1230, 1330, 1430, 1530, 1630, 1730, 1830, 1930, 2030, 2130, 2230, 2330, 2430, 2530, 2630, 2730, 2830, 2930, 3030, 3130, 3230: Lower contact hole (contact hole)
30a, 530a, 630a, 730a, 830a, 930a, 1030a, 1130a, 1230a, 1430a, 1530a, 1630a, 1730a, 1830a, 1930a, 2030a, 2130a, 2230a, 2330a, 2430a, 2530a, 2630a, 2730a, 2830a, 2930a, 3030a, 3130a, 3230a: Contact hole main portion
30b, 330b, 430b, 530b, 630b, 730b, 830b, 930b, 1030b, 1130b, 1230b, 1430b, 1530b, 1630b, 1730b, 1830b, 1930b, 2030b, 2130b, 2230b, 2330b, 2430b, 2530b, 2630b, 2730b, 2830b, 2930b, 3030b, 3130b, 3230b: Expanded hole portion
33: Non-display area side contact hole (contact hole)
33a: Contact hole main portion
33b: Expanded hole portion
34: First metal film (first conductive film, third conductive film)
35: Gate insulator (insulator)
36: Semiconductor film
37: Protection film (insulator)
38, 1338: Second metal film (First metal film, second metal film)
39, 1339: First interlayer insulator (insulator)
40, 140, 1340, 1640: Organic insulator (insulator)
42: Inkjet device
42d: Nozzle
43, 143, 743, 843, 943, 1143, 1243, 1443, 1643, 1943: Bending portion
43a, 743a, 843a, 943a, 1443a, 1643a: First edge (edge)
43b, 743b, 843b, 943b, 1443b, 1643b, 1943b: Second edge (edge)
44: First inclined portion
45: Second inclined portion
46, 1346: Gray tone mask
46b1, 1346b1: Slit
47: Screen printing device (stencil printing device)
47a: Screen (stencil)
47a1: Hole
47c, 47d: Squeegee
48, 1648: First inclined portion (inclined portion)
49, 1649: Second inclined portion (inclined portion)
GS: Glass substrate (substrate)
HTA: Semitransmissive area

1-15. (canceled)

16. A display component comprising:
a first conductive film;
a second conductive film disposed above the first conductive film such that at least a portion of the second conductive film overlapping the first conductive film in a plan view;
an insulator held between the first conductive film and the second conductive film and including a contact hole for connecting the second conductive film to the first conductive film and, the contact hole being at a position overlapping the first conductive film and the second conductive film in a plan view; and
an alignment film disposed above the second conductive film and including a portion overlapping the contact hole in a plan view and a portion not overlapping the contact hole in a plan view,
wherein the contact hole includes an edge, at least a portion of which defines a bending portion of the insulator which bends toward an inner side of the contact hole such that an outer angle of the bending portion in a plan view is a reflex angle.

17. The display component according to claim 16, wherein
the contact hole of the insulator includes a contact hole main portion and an expanded hole portion,
the contact hole main portion overlaps at least a portion of the first conductive film and the second conductive film in a plan view,
the expanded hole portion is formed by expanding a portion of the contact hole main portion,
the bending portion is defined by the edge of the contact hole main portion and an edge of the expanded hole portion which continues from the edge of the contact hole main portion, and
the expanded hole portion has a smaller opening dimension than an opening dimension of the contact hole main portion.

18. The display component according to claim 17, wherein
the second conductive film defines a pixel electrode made of a transparent electrode material, and
the expanded hole portion is formed by expanding a portion of the contact hole main portion farther from a center of the pixel electrode in a plan view.

19. The display component according to claim 17, wherein, the expanded hole portion is formed by extending a corner of the contact hole main portion.

20. The display component according to claim 17, wherein:
the second conductive film defines a pixel electrode made of a transparent electrode material; and
the expanded hole portion is at a position not overlapping the pixel electrode in a plan view.

21. The display component according to claim 17, wherein, the expanded hole portion is at a position not overlapping the first conductive film in a plan view.

22. The display component according to claim 17, further comprising a third conductive film disposed below the first conductive film, at least a portion of the third conductive film overlapping the first conductive film in a plan view, wherein
at least a portion of the contact hole main portion overlaps the third conductive film in a plan view and the expanded hole portion is at a position not overlapping the third conductive film in a plan view.

23. The display component according to claim 22, wherein
the first conductive film defines at least a source electrode and a drain electrode;
the third conductive film defines a gate electrode that overlaps at least the source electrode and the drain electrode in a plan view and an auxiliary capacitor line disposed apart from the gate electrode in a plan view; and
at least a portion of the contact hole main portion of the insulator overlaps the drain electrode and the gate electrode in a plan view and the expanded hole portion is between the gate electrode and the auxiliary capacitor line in a plan view.

24. The display component according to claim 17, wherein the expanded hole portion of the insulator has an opening dimension of Wmax/2 or less, where Wmax is a maximum opening dimension of the contact hole main portion.

25. The display component according to claim 24, wherein the edge the expanded hole portion of the insulator which also defines the bending portion has a dimension of Wmax/2 or less.

26. The display component according to claim 17, wherein the expanded hole portion of the insulator has a tapered shape that narrows in a plan view as a distance from the contact hole main portion increases.

27. The display component according to claim 16, wherein
the insulator includes at least an organic insulator made of an organic resin material
at least the edge of the contact hole in the bending portion has a sectional shape gradually inclined,
the edge includes a first inclined portion and a second inclined portion,
the first inclined portion is on a lower layer side and steeply inclined, and
the second inclined portion is on an upper layer side and gently inclined.

28. The display component according to claim 16, further comprising:
a third conductive film disposed below the first conductive film, at least a portion of the third conductive film overlapping the first conductive film in a plan view; and
a semiconductor film held between the third conductive film and the first conductive film, wherein
the first conductive film forms at least a source electrode and a drain electrode,
the third conductive film forms a gate electrode overlapping at least the source electrode and the drain electrode in a plan view, and
the semiconductor film defines a channel connected to each of the source electrode and the drain electrode and is formed of an oxide semiconductor.

29. The display component according to claim 28, wherein the oxide semiconductor contains indium (In), gallium (Ga), zinc (Zn), and oxygen (O).

30. The display component according to claim 29, wherein the oxide semiconductor is crystalline.

31. The display component according to claim 16, wherein
edges of the contact hole of the insulator adjacent to each other have at least two inclined portions,
the inclined portions have sectional shapes that are inclined at angles different from each other.

32. A display device comprising:
the display component according to claim 16;
an opposite board disposed opposite the display component; and
a liquid crystal disposed between the display component and the opposite board.
